(19) United States
(12) Patent Application Publication
(10) Pub. No.: US 2025/0329724 A1
(43) Pub. Date: Oct. 23, 2025

(54) LITHIUM-ION SECONDARY BATTERY

(71) Applicant: SEMICONDUCTOR ENERGY LABORATORY CO., LTD., Atsugi-shi, Kanagawa-ken (JP)

(72) Inventors: Masayuki KIMURA, Atsugi, Kanagawa (JP); Kenji ARAI, Isehara, Kanagawa (JP); Taisuke NAKAO, Atsugi, Kanagawa (JP); Naoto OKUZAWA, Atsugi, Kanagawa (JP)

(21) Appl. No.: 18/873,393

(22) PCT Filed: Jun. 5, 2023
(86) PCT No.: PCT/IB2023/055746

§ 371 Date: Dec. 10, 2024

(30) Foreign Application Priority Data
Jun. 17, 2022 (JP) 2022-097880

(51) Int. Cl. H01M 4/525; H01M 4/02; H01M 4/38; H01M 4/583; H01M 4/60; H01M 10/0525; H01M 10/0569

(52) U.S. Cl. CPC H01M 4/525; H01M 4/386; H01M 4/583; H01M 4/602; H01M 10/0525; H01M 10/0569; H01M 2004/021; H01M 2004/027; H01M 2004/028

(57) ABSTRACT

A lithium-ion secondary battery having excellent discharge characteristics even in a low-temperature environment is provided. The lithium-ion secondary battery includes a positive electrode, a negative electrode, and an electrolyte solution. The positive electrode includes lithium cobalt oxide with a median diameter (D50) of greater than or equal to 1 μm and less than or equal to 12 μm. The lithium cobalt oxide contains magnesium in its surface portion. The negative electrode includes a graphite particle, a silicon particle, and a polymer including a carboxy group. The electrolyte solution contains a mixed solvent of a fluorinated cyclic carbonate and a fluorinated chain carbonate.

### TECHNICAL FIELD

One embodiment of the present invention relates to a lithium-ion secondary battery. One embodiment of the present invention is not limited to the above field and relates to a semiconductor device, a display device, a light-emitting device, a power storage device, a lighting device, an electronic device, a vehicle, and manufacturing methods thereof. The lithium-ion secondary battery of one embodiment of the present invention can be used as a power supply necessary for the above semiconductor device, display device, light-emitting device, power storage device, lighting device, electronic device, and vehicle. Examples of the above electronic device include an information terminal device provided with the lithium-ion secondary battery. Furthermore, examples of the above power storage device include a stationary power storage device.

### BACKGROUND ART

In recent years, a variety of storage batteries such as lithium-ion secondary batteries, lithium-ion capacitors, air batteries, and all-solid-state batteries have been actively developed. In particular, demand for lithium-ion secondary batteries with high output and a high capacity has rapidly grown with the development of the semiconductor industry. The lithium-ion secondary batteries are essential as rechargeable energy supply sources for today's information society. For example, it is known that the discharge capacity of a lithium-ion secondary battery changes depending on a discharge temperature. Thus, a lithium-ion secondary battery having excellent battery characteristics even in a low-temperature environment is required (e.g., see Patent Document 1).

In order to increase the capacities of lithium-ion secondary batteries and improve their charge-discharge cycle performance at room temperature, various researches and developments have been conducted on both a positive electrode and a negative electrode. As a positive electrode active material, lithium cobalt oxide having a stable crystal structure has been studied (e.g., see Patent Document 2).

A fluoride such as fluorite (calcium fluoride) has been used as flux in iron manufacture or the like for a very long time, and the physical properties have been studied (e.g., Non-Patent Document 1).

As for a negative electrode active material, it is known that a silicon-based material has higher capacity than a graphite-based material, and a negative electrode using a silicon-based material has been studied (e.g., see Patent Document 3).

### REFERENCES

### Patent Documents

[Patent Document 1] Japanese Published Patent Application No. 2015-026608
[Patent Document 2] International Publication WO 2020/026078 Pamphlet
[Patent Document 3] Japanese Published Patent Application No. 2019-165005

### Non-Patent Document

[Non-Patent Document 1] W. E. Counts, R. Roy, and E. F. Osborn, “Fluoride Model Systems: II, The Binary Systems CaF₂—BeF₂, MgF₂—BeF₂, and LiF—MgF₂”, Journal of the American Ceramic Society, 36 [1] 12-17 (1953).

### SUMMARY OF THE INVENTION

### Problems to be Solved by the Invention

Patent Document 1 describes that a lithium-ion secondary battery capable of operating even in a low-temperature environment (e.g., lower than or equal to 0° C.) can be obtained with the use of the electrolyte solution described in Patent Document 1. However, even the lithium-ion secondary battery described in Patent Document 1 does not have high discharge capacity in discharging in a low-temperature environment at the time of this application, and further improvement is desired.

In order to achieve a lithium-ion secondary battery having excellent discharge characteristics even in a low-temperature environment, it is required to develop not only an electrolyte solution but also a positive electrode and a negative electrode suitable for a lithium-ion secondary battery capable of operating even in a low-temperature environment.

In view of this, an object of one embodiment of the present invention is to provide a lithium-ion secondary battery having excellent discharge characteristics even in a low-temperature environment. Specifically, an object is to provide a positive electrode, a negative electrode, an electrolyte solution, and the like that can be used for a lithium-ion secondary battery with high discharge capacity even when discharging is performed in a low-temperature environment.

Note that the description of these objects does not preclude the existence of other objects. One embodiment of the present invention does not need to achieve all these objects. Other objects can be derived from the descriptions of the specification, the drawings, the claims, and the like.

### Means for Solving the Problems

One embodiment of the present invention is a lithium-ion secondary battery including a positive electrode, a negative electrode, and an electrolyte solution. The positive electrode includes lithium cobalt oxide with a median diameter (D50) of greater than or equal to 1 μm and less than or equal to 12 μm. The lithium cobalt oxide contains magnesium in its surface portion. The negative electrode includes graphite particles, silicon particles, and a polymer including a carboxy group. The electrolyte solution includes a mixed solvent of a fluorinated cyclic carbonate and a fluorinated chain carbonate.

In one embodiment of the present invention, the average particle diameter of the silicon particles is preferably less than 1 μm.

In one embodiment of the present invention, the average particle diameter of the graphite particles is preferably greater than or equal to 5 μm.

In one embodiment of the present invention, the average particle diameter of the silicon particles is preferably less than the average particle diameter of the graphite particles.

In one embodiment of the present invention, a weight ratio of the silicon particles is preferably lower than a weight ratio of the graphite particles.

In one embodiment of the present invention, the polymer including a carboxy group is preferably polyglutamic acid.

In one embodiment of the present invention, the lithium cobalt oxide preferably has a layered rock-salt crystal structure belonging to a space group R-3m. The surface portion preferably includes a basal region including a surface parallel to a (00l) plane of the crystal structure and an edge region including a surface parallel to a plane other than the (00l) plane. When EDX line analysis in a depth direction is performed on the lithium cobalt oxide, magnesium in the basal region is preferably detected at a higher concentration than magnesium in the edge region.

Another embodiment of the present invention is a lithium-ion secondary battery including a positive electrode, a negative electrode, and an electrolyte solution. The positive electrode includes lithium cobalt oxide with a median diameter (D50) of greater than or equal to 1 μm and less than or equal to 12 μm. The lithium cobalt oxide contains magnesium and nickel in its surface portion. The negative electrode includes graphite particles, silicon particles, and a polymer including a carboxy group. The average particle diameter of the silicon particles is greater than the average particle diameter of the graphite particles. The electrolyte solution includes a mixed solvent of a fluorinated cyclic carbonate and a fluorinated chain carbonate.

Another embodiment of the present invention is a lithium-ion secondary battery including a positive electrode, a negative electrode, and an electrolyte solution. The positive electrode includes lithium cobalt oxide with a median diameter (D50) of greater than or equal to 1 μm and less than or equal to 12 μm. The lithium cobalt oxide contains magnesium and nickel in its surface portion. The negative electrode includes graphite particles, silicon particles, and a polymer including a carboxy group. The average particle diameter of the silicon particles is greater than the average particle diameter of the graphite particles. The electrolyte solution includes fluoroethylene carbonate and methyl trifluoropropionate. With a total content of the fluoroethylene carbonate and the methyl trifluoropropionate of 100 vol %, a volume ratio of the fluoroethylene carbonate to the methyl trifluoropropionate is x: 100−x (note that 5≤x≤30).

In another embodiment of the present invention, the lithium cobalt oxide preferably has a layered rock-salt crystal structure belonging to a space group R-3m. The surface portion preferably includes a basal region including a surface parallel to a (00l) plane of the crystal structure and an edge region including a surface intersecting with the (00l) plane. When STEM-EDX line analysis, i.e., EDX analysis in a depth direction is performed, the lithium cobalt oxide preferably includes a region where distribution of the magnesium and distribution of the nickel overlap with each other in the edge region.

In another embodiment of the present invention, the lithium cobalt oxide preferably has a layered rock-salt crystal structure belonging to a space group R-3m. The surface portion preferably includes a basal region including a surface parallel to a (00l) plane of the crystal structure and an edge region including a surface intersecting with the (00l) plane. When STEM-EDX line analysis, i.e., EDX analysis in a depth direction is performed on the lithium cobalt oxide, it is preferable that the nickel be substantially absent in the basal region.

### Effect of the Invention

One embodiment of the present invention can provide a lithium-ion secondary battery having excellent discharge characteristics even in a low-temperature environment. Specifically, a positive electrode, a negative electrode, an electrolyte solution, and the like that can be used for a lithium-ion secondary battery with high discharge capacity and/or high discharge energy density even when discharging is performed in a low-temperature environment can be provided.

### BRIEF DESCRIPTION OF THE DRAWINGS

FIG. 1A is a cross-sectional view illustrating an internal structure of a lithium-ion secondary battery, and FIG. 1B is a cross-sectional view illustrating a positive electrode active material, an electrolyte solution, and the like of the lithium-ion secondary battery.

FIG. 2A and FIG. 2B are cross-sectional views illustrating a positive electrode active material.

FIG. 3A1 to FIG. 3B3 are cross-sectional views illustrating a positive electrode active material.

FIG. 4 is a diagram illustrating crystal structures of a positive electrode active material.

FIG. 5 is a diagram illustrating crystal structures of a conventional positive electrode active material.

FIG. 6 is a diagram showing XRD patterns calculated from crystal structures.

FIG. 7 is a diagram showing XRD patterns calculated from crystal structures.

FIG. 8A to FIG. 8D are diagrams showing methods for forming a positive electrode active material.

FIG. 9 is a diagram showing a method for forming a positive electrode active material.

FIG. 10A to FIG. 10C are diagrams showing methods for forming a positive electrode active material.

FIG. 11 is a phase diagram showing a relationship between temperature and compositions of lithium fluoride and magnesium fluoride.

FIG. 12 is a diagram showing results of DSC analysis.

FIG. 13 is a diagram showing a method for forming a negative electrode active material.

FIG. 14A is an exploded perspective view of a coin-type secondary battery, FIG. 14B is a perspective view of the coin-type secondary battery, and FIG. 14C is a cross-sectional perspective view thereof.

FIG. 15A illustrates an example of a cylindrical secondary battery. FIG. 15B illustrates the example of the cylindrical secondary battery. FIG. 15C illustrates an example of a plurality of cylindrical secondary batteries. FIG. 15D illustrates an example of a power storage system including a plurality of cylindrical secondary batteries.

FIG. 16A and FIG. 16B illustrate examples of a secondary battery, and FIG. 16C is a diagram illustrating the internal state of a secondary battery.

FIG. 17A to FIG. 17C are diagrams illustrating an example of a secondary battery.

FIG. 18A and FIG. 18B are diagrams each illustrating the appearance of a secondary battery.

FIG. 19A to FIG. 19C are diagrams illustrating a method for manufacturing a secondary battery.

FIG. 20A is a perspective view of a battery pack of one embodiment of the present invention, FIG. 20B is a block diagram of the battery pack, and FIG. 20C is a block diagram of a vehicle including the battery pack.

FIG. 21A to FIG. 21D are diagrams illustrating examples of transport vehicles. FIG. 21E is a diagram illustrating an example of an artificial satellite.

FIG. 22A and FIG. 22B are diagrams illustrating a power storage device of one embodiment of the present invention.

FIG. 23A is a diagram illustrating an electric bicycle, FIG. 23B is a diagram illustrating a secondary battery of an electric bicycle, and FIG. 23C is a diagram illustrating an electric motorcycle.

FIG. 24A to FIG. 24D are diagrams illustrating examples of electronic devices.

FIG. 25A illustrates examples of wearable devices, FIG. 25B is a perspective view of a watch-type device, and FIG. 25C is a diagram illustrating a side surface of the watch-type device.

FIG. 26A is a SEM image of Sample 1, and FIG. 26B is a schematic view thereof.

FIG. 27A and FIG. 27B are graphs showing cycle test results at low temperatures described in Example.

FIG. 28A to FIG. 28C are graphs showing XRD analysis in a high-voltage charged state described in Example.

FIG. 29A and FIG. 29B are graphs showing STEM-EDX analysis described in Example.

FIG. 30A to FIG. 30C are graphs showing STEM-EDX analysis described in Example.

FIG. 31A to FIG. 31C are graphs showing STEM-EDX analysis described in Example.

FIG. 32 is a graph showing cycle test results at low temperatures described in Example.

FIG. 33 is a SEM image of Sample 2.

### MODE FOR CARRYING OUT THE INVENTION

Embodiments of the present invention will be described in detail with reference to the drawings as appropriate. Note that the present invention is not limited to the following description, and it will be readily understood by those skilled in the art that modes and details of the present invention can be modified in various ways without departing from the spirit and scope of the present invention. Therefore, in the embodiments of the present invention described below, reference numerals denoting the same portions are used in common in different drawings. Furthermore, the embodiments and examples described below can be implemented by being combined with any of the embodiments, examples, and the like described in this specification and the like unless otherwise specified.

In this specification and the like, a low-temperature environment refers to a temperature lower than or equal to 0° C., and a temperature lower than or equal to 0° C. is sometimes referred to as a “temperature below freezing”. In the case where a “low-temperature environment” is stated in this specification and the like, a given temperature lower than or equal to 0° C. can be selected. For example, in the case where a “low-temperature environment” is stated in this specification and the like, any one of temperatures lower than or equal to 0° C., lower than or equal to −10° C., lower than or equal to −20° C., lower than or equal to −30° C., lower than or equal to −40° C., lower than or equal to −50° C., lower than or equal to −60° C., lower than or equal to −80° C., and lower than or equal to −100° C. can be selected.

In this specification and the like, a space group is represented using the short notation of the international notation (or the Hermann-Mauguin notation). In addition, the Miller index is used for the expression of crystal planes and crystal orientations. An individual plane that shows a crystal plane is denoted with “( )”. In the crystallography, a bar is placed over a number in the expression of space groups, crystal planes, and crystal orientations; in this specification and the like, because of format limitations, space groups, crystal planes, and crystal orientations are sometimes expressed by placing “−” (a minus sign) in front of the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”. A trigonal system represented by the space group R-3m is generally represented by a composite hexagonal lattice for easy understanding of the structure and, in some cases, not only (hkl) but also (hkil) is used as the Miller index. Here, i is −(h+k).

In addition, a given integer of 1 or more is represented by a character such as h, k, i, or l in some cases. Examples of (00l) include (001), (003), and (006).

The space group of a crystal structure is identified by XRD, electron diffraction, neutron diffraction, or the like. Thus, in this specification and the like, belonging to a space group, being attributed to a space group, or being a space group can be rephrased as being identified as the space group.

In this specification and the like, the theoretical capacity of a positive electrode active material refers to the amount of electricity for the case where all the lithium that can be inserted into and extracted from the positive electrode active material is extracted. For example, the theoretical capacity per weight of LiCoO₂ is 274 mAh/g, the theoretical capacity of LiNiO₂ is 275 mAh/g, and the theoretical capacity of LiMn₂O₄ is 148 mAh/g.

The remaining amount of lithium that can be inserted into and extracted from a positive electrode active material can be represented by x (the occupancy rate of Li in lithium sites) in a compositional formula, e.g., LiₓCoO₂. In the case of a positive electrode active material included in a lithium-ion secondary battery, x=(theoretical capacity-charge capacity)/theoretical capacity can be satisfied. For example, in the case where a lithium-ion secondary battery using LiCoO₂ as a positive electrode active material is charged to 219.2 mAh/g per weight of the positive electrode active material, it can be said that the positive electrode active material is represented by Li_{0.2}CoO₂ or x=0.2. Note that “x in LiₓCoO₂ is small” means, for example, x≤0.24, and means, for example, 0.1<x≤0.24 in consideration of the practical range of using LiₓCoO₂ for the lithium-ion secondary battery.

In the case where lithium cobalt oxide almost satisfies the stoichiometric proportion, lithium cobalt oxide is LiCoO₂ and x=1. For a lithium-ion secondary battery after its discharge ends, it can be said that lithium cobalt oxide is LiCoO₂ and x=1. In general, in a lithium-ion secondary battery using LiCoO₂, the discharge voltage rapidly decreases before discharge voltage reaches 2.5 V. For this reason, in this specification and the like, for example, a state in which voltage becomes 2.5 V (counter electrode is lithium) at a current of 100 mA/g or lower per weight of the positive electrode active material is regarded as a state in which discharging ends with x of 1. Accordingly, for example, in order to obtain lithium cobalt oxide with x of 0.2, charging may be performed at 219.2 mAh/g per weight of the positive electrode active material in a state in which discharging ends.

Charge capacity and/or discharge capacity used for calculation of x in LiₓCoO₂ is preferably measured under the condition of no influence or small influence of a short circuit and/or decomposition of an electrolyte solution. For example, it is not preferable to use data of a lithium-ion secondary battery, containing a sudden voltage change that seems to result from a short circuit, for calculation of x.

In this specification and the like, “carbonate” refers to a compound containing at least one carbonic ester in its molecular structure and includes “cyclic carbonate” and “chain carbonate” in its category unless otherwise specified. “Chain” includes both straight-chain and branched-chain.

In this specification and the like, the expression “including A and/or B” means including A, including B, or including A and B.

In this specification and the like, a full cell means a battery cell assembled such that different electrodes are positioned as in a unit cell of a positive electrode/a negative electrode. In this specification and the like, a half cell means a battery cell assembled using lithium metal as a negative electrode (a counter electrode).

In this specification and the like, a lithium-ion secondary battery is sometimes called a lithium-ion battery and refers to a battery in which lithium ions are used as carrier ions; however, carrier ions in the present invention are not limited to lithium ions. For example, as the carrier ion in the present invention, alkali metal ions or alkaline earth metal ions (specifically, sodium ions or the like) can be used. In that case, the present invention can be understood by replacing lithium ions with sodium ions or the like. In the case of describing a structure where there is no limitation on carrier ions, a simple term “secondary battery” is sometimes used.

### Embodiment 1

In this embodiment, a lithium-ion secondary battery having excellent discharge characteristics even in a low-temperature environment is described.

### [Lithium-Ion Secondary Battery]

A lithium-ion secondary battery of one embodiment of the present invention includes a positive electrode, a negative electrode, and an electrolyte solution. In addition, a separator is included between the positive electrode and the negative electrode. The separator is unnecessary in the case where a solid electrolyte or a semi-solid electrolyte is used instead of the electrolyte solution. Furthermore, an exterior body for storing the positive electrode, the negative electrode, the electrolyte solution, and the like may be included.

In this embodiment, description is made focusing on a structure of a lithium-ion secondary battery which is needed to achieve a lithium-ion secondary battery having excellent discharge characteristics even in a low-temperature environment (e.g., lower than or equal to 0° C., lower than or equal to −20° C., preferably lower than or equal to −30° C., further preferably lower than or equal to −40° C., still further preferably lower than or equal to −50° C., most preferably lower than or equal to −60° C.). Specifically, a positive electrode active material that is included in a positive electrode, a negative electrode active material layer, and an electrolyte solution are mainly described.

In this specification and the like, the excellent discharge characteristics in a low-temperature environment sometimes mean that the discharge capacity in a low-temperature environment (e.g., lower than or equal to 0° C., lower than or equal to −20° C., preferably lower than or equal to −30° C., further preferably lower than or equal to −40° C., still further preferably lower than or equal to −50° C., most preferably lower than or equal to −60° C.) has a lower decrease rate than the discharge capacity at 25° C.

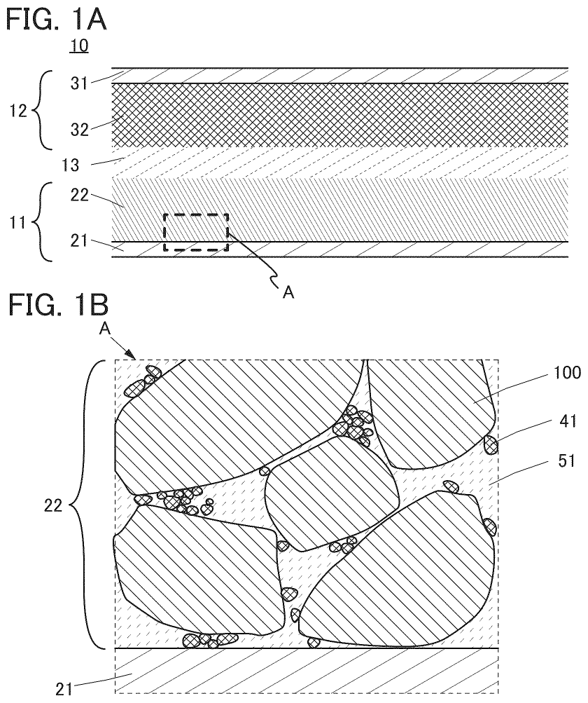

FIG. 1A is a schematic cross-sectional view illustrating an inner structure of a lithium-ion secondary battery 10. The lithium-ion secondary battery 10 includes a positive electrode 11, a negative electrode 12, and a separator 13. The positive electrode 11 includes a positive electrode current collector 21 and a positive electrode active material layer 22 over the positive electrode current collector 21, and the negative electrode 12 includes a negative electrode current collector 31 and a negative electrode active material layer 32. As illustrated, the positive electrode active material layer 22 and the negative electrode active material layer 32 are provided to face each other with the separator 13 therebetween. Although not illustrated in FIG. 1A, a space included in the positive electrode active material layer 22, a space included in the separator 13, and a space included in the negative electrode active material layer 32 are impregnated with the electrolyte solution.

FIG. 1B is an enlarged view of a portion A surrounded by a dashed line in FIG. 1A. The positive electrode active material layer 22 contains a positive electrode active material 100 and a conductive material 41. Although not illustrated, the positive electrode active material layer 22 may contain a binder in addition to the positive electrode active material 100 and the conductive material 41.

The space included in the positive electrode active material layer 22 is preferably filled with an electrolyte solution 51 as illustrated. For example, the proportion of the space included in the positive electrode active material layer 22 filled with the electrolyte solution 51 is preferably higher than or equal to 60%, further preferably higher than or equal to 70%, still further preferably higher than or equal to 70%, yet further preferably higher than or equal to 80%, yet still further preferably higher than or equal to 90%, yet still further preferably higher than or equal to 95%, most preferably higher than or equal to 99%. Note that the space included in the positive electrode active material layer 22 refers to a region other than a solid component (e.g., a positive electrode active material or a conductive material) in the positive electrode active material layer 22.

Although detailed descriptions are omitted, the space included in the negative electrode active material layer 32 is preferably filled with the electrolyte solution 51 as in the above description of the positive electrode active material layer 22. For example, the proportion of the space included in the negative electrode active material layer 32 filled with the electrolyte solution 51 is preferably higher than or equal to 60%, further preferably higher than or equal to 70%, still further preferably higher than or equal to 80%, yet further preferably higher than or equal to 90%, yet still further preferably higher than or equal to 95%, most preferably higher than or equal to 99%. Note that the space included in the negative electrode active material layer 32 refers to a region other than a solid component (e.g., a negative electrode active material or a conductive material) in the negative electrode active material layer 32.

When the positive electrode active material layer 22 and the negative electrode active material layer 32 are entirely filled with the electrolyte solution 51 in this manner, a region where the electrolyte solution and each of the positive electrode active material and a negative electrode active material are in contact with each other can be increased. That is, a lithium-ion secondary battery can have excellent charge characteristics and discharge characteristics in a low-temperature environment.

In charging in a low-temperature environment, an energy barrier at the time of extracting lithium ions from a positive electrode active material tends to become high. That is, it can be said that overvoltage required for extracting lithium ions from the positive electrode active material becomes larger as the temperature of charging environment becomes lower. That is, the positive electrode active material might be exposed to high voltage (a potential higher than a lithium potential) in charging in a low-temperature environment. In other words, in charging in a low-temperature environment, charge capacity might be decreased when the positive electrode active material is not exposed to high voltage.

Thus, a positive electrode active material that can withstand high voltage and obtain high charge capacity in charging in a low-temperature environment is preferably used as a positive electrode active material contained in a lithium-ion secondary battery having excellent charge characteristics and discharge characteristics even in a low-temperature environment.

For an electrolyte contained in a lithium-ion secondary battery having excellent charge characteristics and discharge characteristics even in a low-temperature environment, it is preferable to use a material having high lithium ion conductivity even in charging and/or discharging (charging and discharging) in a low-temperature environment (e.g., 0° C., preferably −20° C., further preferably −30° C., still further preferably −40° C.).

A positive electrode active material and an electrolyte that are preferable for a lithium-ion secondary battery having excellent charge characteristics and discharge characteristics even in a low-temperature environment are described in detail below.

### [Positive Electrode]

A positive electrode includes a positive electrode active material layer and a positive electrode current collector. The positive electrode active material layer contains a positive electrode active material and may further contain at least one of a conductive material and a binder.

### <Positive Electrode Active Material>

The positive electrode active material has functions of taking and releasing lithium ions in accordance with charging and discharging. As a positive electrode active material used as one embodiment of the present invention, a material with less deterioration (or a material with a slight increase in resistance) due to charging and/or discharging (hereinafter, also called “charging and discharging”) in a low-temperature environment even at high charging voltage (which is a voltage value with reference to a lithium metal unless otherwise specified, and hereinafter also referred to as “high charge voltage”) can be used. Specifically, it is preferable that a positive electrode active material (composite oxide) with a particle diameter (strictly, median diameter (D50)) of less than or equal to 12 μm (preferably less than or equal to 10.5 μm, further preferably less than or equal to 8 μm) obtained by a formation method described in Embodiment 2 can be used. Needless to say, a positive electrode active material with a particle diameter greater than or equal to 12 μm and less than or equal to 20 μm may be used. This positive electrode active material contains any one or more of an additive element X, an additive element Y, and an additive element Z. Details of the additive element X, the additive element Y, and the additive element Z are described in <Contained element>.

The particle diameter can be measured with a particle size distribution analyzer or the like using a laser diffraction and scattering method. The median diameter (D50) is a particle diameter when the accumulated amount of particles accounts for 50% of an accumulated particle amount curve which is the result of the particle size distribution measurement. The measurement of the size of a particle is not limited to laser diffraction particle size distribution measurement; the major axis of a particle cross section may be measured by analysis with a scanning electron microscope (hereinafter referred to as SEM), a transmission electron microscope (hereinafter referred to as TEM), or the like. Note that an example of a method for measuring the median diameter (D50) with a SEM, TEM, or the like includes a method for measuring 20 or more particles to make a particle size distribution curve, and setting a particle diameter when the accumulation of particles accounts for 50% as the median diameter (D50).

As an index for evaluating low temperature characteristics, a discharge capacity value in a low-temperature environment (e.g., 0° C., −20° C., preferably −30° C., further preferably −40° C.) is preferably higher than or equal to 50% (preferably higher than or equal to 60%, further preferably higher than or equal to 70%, still further preferably higher than or equal to 80%, most preferably higher than or equal to 90%) of a discharge capacity value at 20° C. Note that the above-described values are preferably obtained under the same measurement conditions except for the ambient temperature.

Alternatively, a material with less deterioration (or a material with a slight increase in resistance) due to charging and discharging even at high charging voltage is preferably used as the positive electrode active material to obtain high discharge capacity even in a low-temperature environment (e.g., 0° C., −20° C., preferably −30° C., further preferably −40° C.).

Specifically, the discharge capacity when charging and discharging are performed at −40° C. is preferably higher than or equal to 60%, further preferably higher than or equal to 65%, still further preferably higher than or equal to 70%, yet further preferably higher than or equal to 75% of the discharge capacity when charging and discharging are performed at 25° C. Although the temperature employed here is −40° C., the temperature only needs to be low temperature and can be replaced with another low temperature such as −20° C. or −30° C. As the above discharge condition, for example, discharging may be performed at a current rate of 0.1 C (1 C=200 mA/g (per weight of the positive electrode active material)). In the evaluation of the low temperature characteristics described above, the evaluation may be performed at a low rate as long as the measurement conditions except for the ambient temperature are the same.

As another index for evaluating low temperature characteristics, a discharge energy density value in a low-temperature environment (e.g., 0° C., −20° C., preferably −30° C., further preferably −40° C.) is preferably higher than or equal to 50% (preferably higher than or equal to 60%, further preferably higher than or equal to 70%, still further preferably higher than or equal to 80%, most preferably higher than or equal to 90%) of a discharge energy density value at 25° C.

The ambient temperature described in this specification and the like refers to the temperature of a lithium-ion secondary battery. In the measurement of the battery characteristics using a thermostatic bath, the ambient temperature can be regarded as the set temperature of the thermostatic bath. Thus, after a battery to be measured (e.g., a test battery or a half cell) is provided in the thermostatic bath, a sufficient time (e.g., an hour or longer) break is preferably provided before the start of the measurement until the temperature of the test cell becomes substantially the same as the temperature in the thermostatic bath; however, the measurement method is not necessarily limited to this.

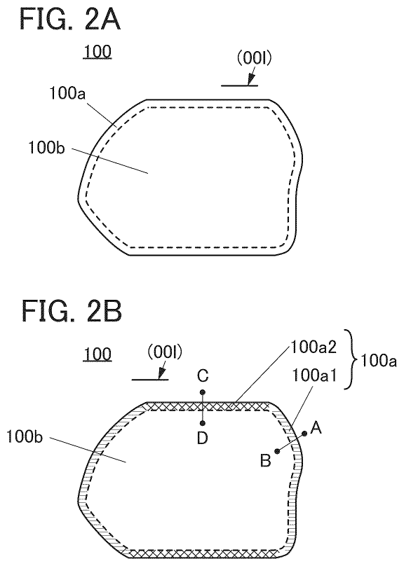

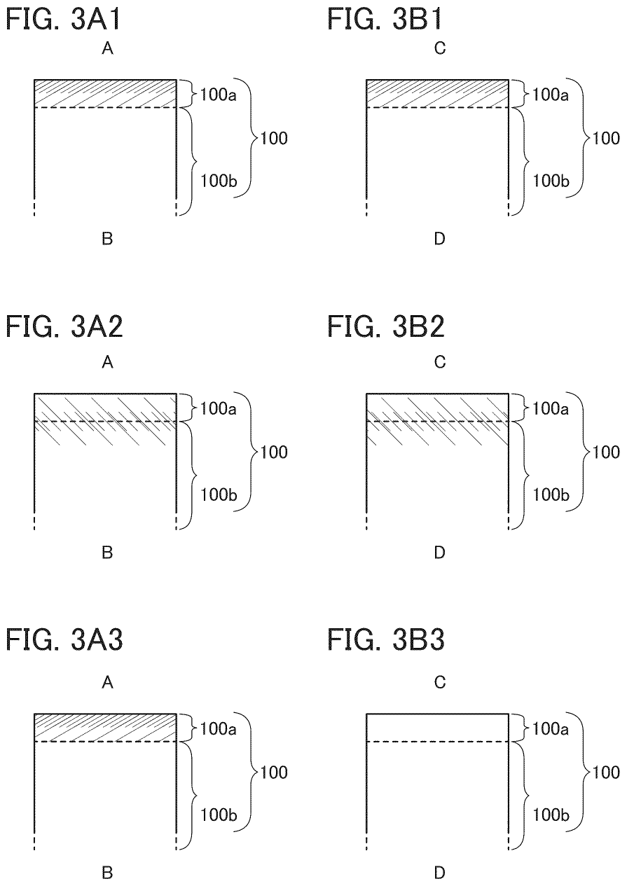

The positive electrode active material 100 of one embodiment of the present invention is described with reference to FIG. 2 and FIG. 3. The positive electrode active material 100 hardly deteriorates due to repeated charging at high voltage with reference to a lithium metal and discharging; thus, sufficient battery characteristics can be provided even in a low-temperature environment. In this embodiment, high voltage is 4.6 V, preferably 4.65 V, further preferably 4.7 V with reference to a lithium metal.

FIG. 2A and FIG. 2B are each a cross-sectional view of the positive electrode active material 100 of one embodiment of the present invention. FIG. 3A1 to FIG. 3A3 are enlarged views of a portion near A-B in FIG. 2B. FIG. 3B1 to FIG. 3B3 are enlarged views of a portion near C-D in FIG. 2B.

As illustrated in FIG. 2A, the positive electrode active material 100 includes a surface portion 100a and an inner portion 100b. Although a dashed line denotes a boundary between the surface portion 100a and the inner portion 100b in the diagrams, a clear boundary does not exist.

The surface portion 100a of the positive electrode active material 100 refers to a region ranging from the surface to a depth of 50 nm or less, preferably 35 nm or less, further preferably 20 nm or less toward the inner portion, and most preferably a region ranging from the surface to a depth of 10 nm or less toward the inner portion in a perpendicular or substantially perpendicular direction. A region with a narrow width, specifically a width of 20 nm or less, ranging from the surface to the inner portion is referred to as a shell. Note that being “substantially perpendicular” includes being perpendicular, specifically being greater than or equal to 80° and less than or equal to 100°. A plane generated by a split and/or a crack can also be referred to as a surface. The surface portion 100a can be rephrased as the vicinity of a surface or a region in the vicinity of a surface.

The inner portion 100b refers to a region in a deeper position than the surface portion 100a of the positive electrode active material. The inner portion 100b can be rephrased as an inner region or a core.

In the case where the positive electrode active material 100 has a layered rock-salt crystal structure of a space group R-3m, the surface portion 100a includes an edge region 100a1 and a basal region 100a2 as illustrated in FIG. 2B.

Note that in FIG. 2A and FIG. 2B, a straight line denoted by (00l) represents a (00l) plane. The basal region 100a2 has a plane parallel or substantially parallel to the (00l) plane. The (00l) plane is referred to as a basal plane, and a region having the (00l) plane is referred to as the basal region 100a2. In the case where lithium cobalt oxide is used as the positive electrode active material 100, lithium ions can be inserted and extracted through the basal plane. A plane other than the (00l) plane is referred to as an edge plane, and a region having a plane other than the (00l) plane is referred to as the edge region 100a1.

The surface of the positive electrode active material 100 refers to a surface of a composite oxide including the surface portion 100a and the inner portion 100b. Thus, the positive electrode active material 100 does not contain a material to which a metal oxide that does not include a lithium site contributing to charging and discharging, such as aluminum oxide (Al₂O₃), is attached, or a carbonate, a hydroxy group, or the like which is chemically adsorbed after formation of the positive electrode active material. Note that the attached metal oxide refers to, for example, a metal oxide having a crystal orientation different from that of the inner portion 100b.

The orientations of crystals in two regions being substantially aligned with each other can be judged, for example, from a TEM (Transmission Electron Microscope) image, a STEM (Scanning Transmission Electron Microscope) image, a HAADF-STEM (High-Angle Annular Dark Field Scanning TEM) image, an ABF-STEM (Annular Bright-Field Scanning Transmission Electron Microscope) image, or the like. It can be judged also from an FFT pattern of a TEM image or an FFT pattern of a STEM image or the like. Furthermore, XRD (X-ray Diffraction), neutron diffraction, and the like can also be used for judging.

An electrolyte solution, a decomposition product of an electrolyte, an organic solvent, a binder, a conductive material, and a compound originating from any of these which are attached to the positive electrode active material 100 are not included in the positive electrode active material either. That is, the electrolyte solution, the decomposition product of the electrolyte, the organic solvent, the binder, the conductive material, and the compound originating from any of these which are attached to the positive electrode active material 100 are removed from the surface of the positive electrode active material.

Since the positive electrode active material 100 is a compound containing oxygen and a transition metal into and from which lithium can be inserted and extracted, an interface between a region where oxygen and the transition metal M (e.g., Co, Ni, Mn, or Fe) that is oxidized or reduced due to insertion and extraction of lithium exist and a region where oxygen and the transition metal M do not exist may be considered as the surface of the positive electrode active material. Thus, a plane generated by slipping, split, and/or a crack is also included as the surface of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

### <Contained Element>

The positive electrode active material 100 contains lithium, cobalt, oxygen, and an additive element. Alternatively, the positive electrode active material 100 can contain lithium cobalt oxide (LiCoO₂) to which an added element is added. Note that the positive electrode active material 100 has a crystal structure to be described later. Thus, the composition of the lithium cobalt oxide is not strictly limited to Li:Co:O=1:1:2.

As the additive element contained in the positive electrode active material 100, one or two or more selected from magnesium, fluorine, nickel, aluminum, titanium, zirconium, vanadium, iron, manganese, chromium, niobium, arsenic, zinc, silicon, sulfur, phosphorus, boron, barium, bromine, and beryllium is preferably used.

The additive element is preferably dissolved in the positive electrode active material 100. As described later, such an additive element further stabilizes the crystal structure of the positive electrode active material 100.

Note that as the additive element, magnesium, fluorine, nickel, aluminum, titanium, zirconium, vanadium, iron, manganese, chromium, niobium, arsenic, zinc, silicon, sulfur, phosphorus, boron, barium, bromine, or beryllium is not necessarily contained.

When manganese is substantially absent in the positive electrode active material 100, for example, the above advantages such as relatively easy synthesis, easy handling, and excellent cycle performance are enhanced. The weight of manganese contained in the positive electrode active material 100 is preferably less than or equal to 600 ppm, further preferably less than or equal to 100 ppm, for example.

The surface portion 100a, particularly the edge region having the edge plane, is a region from which lithium ions are extracted first in charging, and is a region that tends to have a lower concentration of lithium than the inner portion 100b. It can also be said that some bonds of atoms are partly cut on the surface of the particle of the positive electrode active material 100 in the surface portion 100a, particularly in the edge region, from which lithium ions are extracted. Thus, the surface portion 100a is regarded as a region that tends to be unstable and easily starts deterioration of the crystal structure. Meanwhile, when the surface portion 100a, particularly the edge portion, can be made sufficiently stable, the layered structure, which is formed of octahedrons of cobalt and oxygen, of the inner portion 100b is less likely to be broken even with small x in LiₓCoO₂, e.g., with x of less than or equal to 0.24. Moreover, when the surface portion 100a, particularly the edge region, can be sufficiently stable, a shift in layers formed of octahedrons of cobalt and oxygen in the inner portion 100b can be inhibited.

In order that the surface portion 100a can have a stable composition and a stable crystal structure, the surface portion 100a preferably contains the above-described additive element, further preferably contains a plurality of additive elements. The surface portion 100a preferably has a higher concentration of one or more selected from the additive elements than the inner portion 100b. The edge region 100a1 preferably has a higher concentration of one or more selected from the additive elements than the basal region 100a2.

The additive element distribution is described. FIG. 3A1 to FIG. 3A3 are enlarged views of a portion near the line A-B in FIG. 2B and are diagrams illustrating the edge region 100a1 of the positive electrode active material 100. FIG. 3B1 to FIG. 3B3 are enlarged views of a portion near the line C-D in FIG. 2B and are diagrams illustrating the basal region 100a2 of the positive electrode active material 100.

For example, some of the additive elements such as magnesium, fluorine, and titanium preferably have a concentration gradient in which the concentration increases from the inner portion 100b toward the surface. In FIG. 3A1 and FIG. 3B1, the image of the concentration gradient is expressed by hatching density. An additive element having such a concentration gradient is referred to as the additive element X. Note that the concentration of magnesium, fluorine, titanium, or the like may be higher in the edge region 100a1 than in the basal region 100a2.

It is preferable that another additive element, such as aluminum, have a concentration gradient and have a concentration peak in a region deeper than that of the additive element X shown in FIG. 3A2 and FIG. 3B2. In FIG. 3A2 and FIG. 3B2, the concentration gradient and the peak region are expressed by hatching density. The position of the concentration peak may be in the surface portion 100a or may be deeper than the surface portion 100a. For example, the concentration peak preferably exists in a region ranging from a depth of 5 nm to a depth of 30 nm inclusive from the surface toward the inner portion. An additive element having such a concentration gradient is referred to as the additive element Y. Note that the concentration of aluminum or the like may be higher in the edge region 100a1 than in the basal region 100a2.

As shown by presence or absence of hatching and the density of hatching in FIG. 3A3 and FIG. 3B3, another additive element such as nickel clearly exists in the edge region 100a1 but is substantially absent in the basal region 100a2 in some cases. The concentration of nickel or the like is preferably higher in the edge region 100a1 than in the basal region 100a2. Note that here, “clearly exist” means a case where the energy spectrum of characteristic X-ray of the element is detected in cross-sectional STEM-EDX analysis of the positive electrode active material 100. An additive element having such distribution is referred to as the additive element Z.

Note that “substantially absent” means a case where the energy spectrum of characteristic X-ray of the element is not detected in cross-sectional STEM-EDX analysis of the positive electrode active material 100. It can also be said that the amount of the element is below the lower detection limit in STEM-EDX analysis. In this case, it can also be said that the amount of the element is below the lower detection limit in STEM-EDX analysis.

A magnesium ion, which is one of the additive elements X, for example, is divalent, and the magnesium is more stable in lithium sites than in cobalt sites in the layered rock-salt crystal structure and thus is likely to enter the lithium sites. An appropriate concentration of magnesium in the lithium sites of the surface portion 100a can facilitate maintenance of the layered rock-salt crystal structure. This is probably because magnesium in the lithium sites serves as a column supporting the CoO₂ layers. Moreover, magnesium can inhibit extraction of oxygen around the magnesium in a state where x in LiₓCoO₂ is, for example, 0.24 or less.

An appropriate concentration of magnesium does not have an adverse effect on insertion and extraction of lithium in charging and discharging, and the above-described advantages can be obtained. However, excess magnesium might adversely affect insertion and extraction of lithium. Furthermore, the effect of stabilizing the crystal structure might be reduced. This is probably because magnesium enters the cobalt sites in addition to the lithium sites. Moreover, an excess magnesium compound (e.g., an oxide or a fluoride) which is substituted for neither the lithium site nor the cobalt site might segregate at the surface of the positive electrode active material or the like to serve as a resistance component of a lithium-ion secondary battery. As the concentration of magnesium in the positive electrode active material increases, the discharge capacity of the positive electrode active material decreases in some cases. This is probably because excess magnesium enters the lithium sites and the amount of lithium contributing to charging and discharging decreases.

Thus, the entire positive electrode active material 100 preferably contains an appropriate amount of magnesium. For example, the number of magnesium atoms is preferably greater than or equal to 0.001 times and less than or equal to 0.1 times, further preferably greater than 0.01 times and less than 0.04 times, still further preferably approximately 0.02 times the number of cobalt atoms. The amount of magnesium contained in the entire positive electrode active material 100 here may be a value obtained by element analysis performed on the entire positive electrode active material 100 using GD-MS, ICP-MS, or the like, or may be a value based on the ratio of the raw materials mixed in the formation process of the positive electrode active material 100, for example.

Aluminum, which is one of additive elements Y, can exist in the cobalt site in a layered rock-salt crystal structure. Since aluminum is a trivalent representative element and its valence does not change, lithium around aluminum is unlikely to move even in charging and discharging. Thus, aluminum and lithium therearound can serve as columns to inhibit a change in the crystal structure. Furthermore, aluminum has effects of inhibiting elution of cobalt around aluminum and improving continuous charge tolerance. Moreover, an Al—O bond is stronger than a Co—O bond; thus, extraction of oxygen around aluminum can be inhibited. These effects improve thermal stability. Thus, a lithium-ion secondary battery that includes the positive electrode active material 100 containing aluminum as the additive element can have higher level of safety. Furthermore, the positive electrode active material 100 can have a crystal structure that is less likely to be broken by repeated charging and discharging. Meanwhile, excess aluminum might adversely affect insertion and extraction of lithium.

Thus, the entire positive electrode active material 100 preferably contains an appropriate amount of aluminum. For example, in the entire positive electrode active material 100, the number of aluminum atoms is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, it is preferably greater than or equal to 0.05% and less than or equal to 2%. Alternatively, it is preferably greater than or equal to 0.1% and less than or equal to 4%. The amount of aluminum contained in the entire positive electrode active material 100 here may be a value obtained by element analysis performed on the entire positive electrode active material 100 using GD-MS, ICP-MS, or the like or may be a value based on the ratio of the raw materials mixed in the formation process of the positive electrode active material 100, for example.

Nickel, which is one of the additive elements Z, can exist in both the cobalt site and the lithium site. Nickel preferably exists in the cobalt site because an oxidation-reduction potential is lower than the case of cobalt, leading to an increase in discharge capacity.

In addition, when nickel exists in lithium sites, a shift in the layered structure formed of octahedrons of cobalt and oxygen can be inhibited. Moreover, a change in volume in charging and discharging is inhibited. Furthermore, an elastic modulus becomes large, i.e., hardness increases. This is probably because nickel in the lithium sites serves as a column supporting the CoO₂ layers. Thus, in particular, the crystal structure is expected to be more stable in a charged state at high temperatures, e.g., 45° C. or higher, which is preferable.

Meanwhile, excess nickel increases the influence of distortion due to the Jahn-Teller effect, which is not preferable. Moreover, excess nickel might adversely affect insertion and extraction of lithium.

Thus, the entire positive electrode active material 100 preferably contains an appropriate amount of nickel. For example, the number of nickel atoms contained in the positive electrode active material 100 is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, it is preferably greater than 0% and less than or equal to 4%. Alternatively, it is preferably greater than 0% and less than or equal to 2%. Alternatively, it is preferably greater than or equal to 0.05% and less than or equal to 7.5%. Alternatively, it is preferably greater than or equal to 0.05% and less than or equal to 2%. Alternatively, it is preferably greater than or equal to 0.1% and less than or equal to 7.5%. Alternatively, it is preferably greater than or equal to 0.1% and less than or equal to 4%. The amount of nickel described here may be a value obtained by element analysis performed on the entire positive electrode active material using GD-MS, ICP-MS, or the like, or may be a value based on the ratio of the raw materials mixed in the formation process of the positive electrode active material, for example.

Fluorine, which is one of the additive elements X, is a monovalent anion; when fluorine is substituted for part of oxygen in the surface portion 100a, the lithium extraction energy is lowered. This is because the change in valence of cobalt ions associated with lithium extraction is from trivalent to tetravalent in the case of not containing fluorine and is from divalent to trivalent in the case of containing fluorine, and the oxidation-reduction potentials in these cases differ from each other. It can thus be said that when fluorine is substitute for part of oxygen in the surface portion 100a of the positive electrode active material 100, lithium ions in the vicinity of fluorine are likely to be extracted and inserted smoothly. Thus, a lithium-ion secondary battery including such a positive electrode active material 100 can have improved charge and discharge characteristics, improved large current characteristics, or the like. When fluorine exists in the surface portion 100a, which has a surface in contact with the electrolyte solution, the corrosion resistance to hydrofluoric acid can be effectively increased. As will be described in the following embodiment, a fluoride such as lithium fluoride that has a lower melting point than another additive element source can serve as a fusing agent (also referred to as a flux agent) for lowering the melting point of the another additive element source.

An oxide of titanium, which is one of the additive elements X, is known to have superhydrophilicity. Accordingly, the positive electrode active material 100 containing titanium oxide in the surface portion 100a presumably has good wettability with respect to a high-polarity solvent. In a secondary battery formed using this positive electrode active material 100, the positive electrode active material 100 and a high-polarity electrolyte solution can have favorable contact at the interface therebetween, which may inhibit an internal resistance increase.

In the case where the surface portion 100a illustrated in FIG. 3A1 contains magnesium and the surface portion 100a illustrated in FIG. 3A3 contains nickel, i.e., the case where the surface portion 100a contains both magnesium and nickel, there is a possibility that divalent nickel can exist more stably near divalent magnesium. Thus, elution of magnesium might be inhibited even when x in LiₓCoO₂ is small. This can contribute to stabilization of the surface portion 100a.

A large number of additive elements Z are preferably contained in the edge region 100al (also referred to as preferentially contained, selectively contained, or the like) as illustrated in FIG. 3A3 and FIG. 3B3, in which case the stability of the crystal structure of the edge region 100a1 for insertion and extraction of lithium ions into/from the positive electrode active material 100 in charging and discharging of a lithium-ion secondary battery is increased. In the case where the additive element Z has such distribution, for example, in the case where the positive electrode active material 100 is lithium cobalt oxide, an influence of adding the additive element Z, such as a decrease in discharge voltage or a decrease in discharge capacity, can be kept to the minimum, which is preferable.

When a plurality of the additive elements are contained as described above, the effects of the additive elements contribute synergistically to further stabilization of the surface portion 100a. In particular, magnesium, nickel, and aluminum are preferably contained, in which case a high effect of stabilizing the composition and the crystal structure can be obtained. In particular, the surface portion 100a of the positive electrode active material 100 preferably includes a region where distribution of magnesium is closer to the surface than distribution of aluminum. Furthermore, in addition to the above-described region where magnesium and aluminum are distributed, a region where the distribution of nickel and the distribution of magnesium overlap with each other is most preferably included in the edge region 100a1 in the surface portion 100a of the positive electrode active material 100.

### <Crystal Structure>

One embodiment of the present invention provides a lithium-ion secondary battery with improved battery characteristics in a low-temperature environment, and XRD measurement and the like for specifying a crystal structure and the like are performed at room temperature.

<x in LiₓCoO₂ being 1>

The positive electrode active material 100 of one embodiment of the present invention preferably has a layered rock-salt crystal structure belonging to the space group R-3m in a discharged state, i.e., a state where x in LiₓCoO₂ is 1. A composite oxide having a layered rock-salt structure excels as a positive electrode active material of a lithium-ion secondary battery because it has high discharge capacity and a two-dimensional diffusion path for lithium ions and is thus suitable for an insertion/extraction reaction of lithium ions. For this reason, it is particularly preferable that the inner portion 100b, which accounts for the majority of the volume of the positive electrode active material 100, have a layered rock-salt crystal structure.

Meanwhile, the surface portion 100a of the positive electrode active material 100 of one embodiment of the present invention preferably has a function of reinforcing the layered structure, which is formed of octahedrons of cobalt and oxygen, of the inner portion 100b so that the layered structure does not break even when lithium is extracted from the positive electrode active material 100 by charging. Alternatively, the surface portion 100a preferably functions as a barrier film of the positive electrode active material 100. Alternatively, the surface portion 100a, which is the outer portion of the positive electrode active material 100, preferably reinforces the positive electrode active material 100. The term “reinforce” here means inhibition of a change in the structures of the surface portion 100a and the inner portion 100b of the positive electrode active material 100 such as extraction of oxygen and/or inhibition of oxidative decomposition of an electrolyte solution on the surface of the positive electrode active material 100.

For the reinforcing function, the surface portion 100a may have a crystal structure different from that of the inner portion 100b. For example, the surface portion 100a preferably has a more stable composition and a more stable crystal structure than those of the inner portion 100b at room temperature (25° C.). For example, at least part of the surface portion 100a of the positive electrode active material 100 of one embodiment of the present invention may have the rock-salt crystal structure. Alternatively, the surface portion 100a preferably may have both a layered rock-salt crystal structure and a rock-salt crystal structure. Alternatively, the surface portion 100a may have features of both a layered rock-salt crystal structure and a rock-salt crystal structure.

Having features of both a layered rock-salt crystal structure and a rock-salt crystal structure can be determined by electron diffraction, a TEM image, a cross-sectional STEM image, and the like.

It is preferable that some of additive elements, particularly magnesium, have higher concentrations in the surface portion 100a than in the inner portion 100b and exist randomly also in the inner portion 100b to have low concentrations. When aluminum exists in the lithium site of the inner portion 100b at an appropriate concentration, an effect of facilitating maintenance of the layered rock-salt crystal structure can be obtained in a manner similar to the above. When nickel exists in the inner portion 100b at an appropriate concentration, a shift in the layered structure formed of octahedrons of cobalt and oxygen can be inhibited in a manner similar to the above. Also in the case where both magnesium and nickel are contained, a synergistic effect of inhibiting elution of magnesium can be expected since divalent magnesium can exist more stably near divalent nickel.

It is preferable that the crystal structure continuously change from the inner portion 100b toward the surface owing to the above-described concentration gradient of magnesium. Alternatively, the crystal orientations of the surface portion 100a and the inner portion 100b are preferably substantially aligned with each other.

In this specification and the like, a layered rock-salt crystal structure, which belongs to the space group R-3m, of a composite oxide containing lithium and the transition metal such as cobalt refers to a crystal structure in which a rock-salt ion arrangement where cations and anions are alternately arranged is included and lithium and the transition metal are regularly arranged to form a two-dimensional plane, so that lithium can be diffused two-dimensionally. Note that a defect such as a cation or anion vacancy may exist. Moreover, in the layered rock-salt crystal structure, strictly, a lattice of the rock-salt crystal structure is distorted and crystal orientations are substantially aligned with each other in some cases.

A rock-salt crystal structure refers to a structure in which a cubic crystal structure with the space group Fm-3m or the like is included and cations and anions are alternately arranged. Note that a cation or anion vacancy may be included.

There is no distinction among cation sites in a rock-salt crystal structure. Meanwhile, a layered rock-salt crystal structure has two types of cation sites: one type is mostly occupied by lithium, and the other is occupied by the transition metal M. A stacked-layer structure where two-dimensional planes of cations and two-dimensional planes of anions are alternately arranged is the same in a rock-salt crystal structure and a layered rock-salt crystal structure.

Anions of a layered rock-salt crystal structure and anions of a rock-salt crystal structure each form a cubic close-packed structure (face-centered cubic lattice structure). Anions of an O3′ crystal described later are presumed to form a cubic close-packed structure. Thus, when a layered rock-salt crystal structure and a rock-salt crystal structure are in contact with each other, there is a crystal plane at which orientations of cubic close-packed structures composed of anions are aligned with each other.

The description can also be made as follows. Anions on the {111} plane of a cubic crystal structure have a triangle lattice. A layered rock-salt structure, which belongs to the space group R-3m and is a rhombohedral structure, is generally represented by a composite hexagonal lattice for easy understanding of the structure, and the (0001) plane of the layered rock-salt structure has a hexagonal lattice. The triangle lattice on the {111} plane of the cubic crystal has atomic arrangement similar to that of the hexagonal lattice on the (0001) plane of the layered rock-salt structure. These lattices being consistent with each other can be expressed as “orientations of the cubic close-packed structures are aligned with each other”.

Note that the space groups of the layered rock-salt crystal structure and the O3′ type crystal structure described later are R-3m, which is different from the space group Fm-3m of the rock-salt crystal structure (the space group of a general rock-salt crystal); thus, the Miller index of the crystal plane satisfying the above conditions in the layered rock-salt crystal structure and the O3′ type crystal structure is different from that in the rock-salt crystal structure. In this specification, a state where the orientations of the cubic close-packed structures composed of anions in the layered rock-salt crystal structure, the O3′ type crystal structure, and the rock-salt crystal structure are aligned with each other is sometimes referred to as a state where crystal orientations are substantially aligned with each other.

<State where x in LiₓCoO₂ is Small>

The crystal structure in a discharged state (a state where x in LiₓCoO₂ is small) of the positive electrode active material 100 of one embodiment of the present invention is different from that of a conventional positive electrode active material because the positive electrode active material 100 has the above-described magnesium distribution and/or crystal structure. Here, “x is small” means 0.1<x≤0.24.

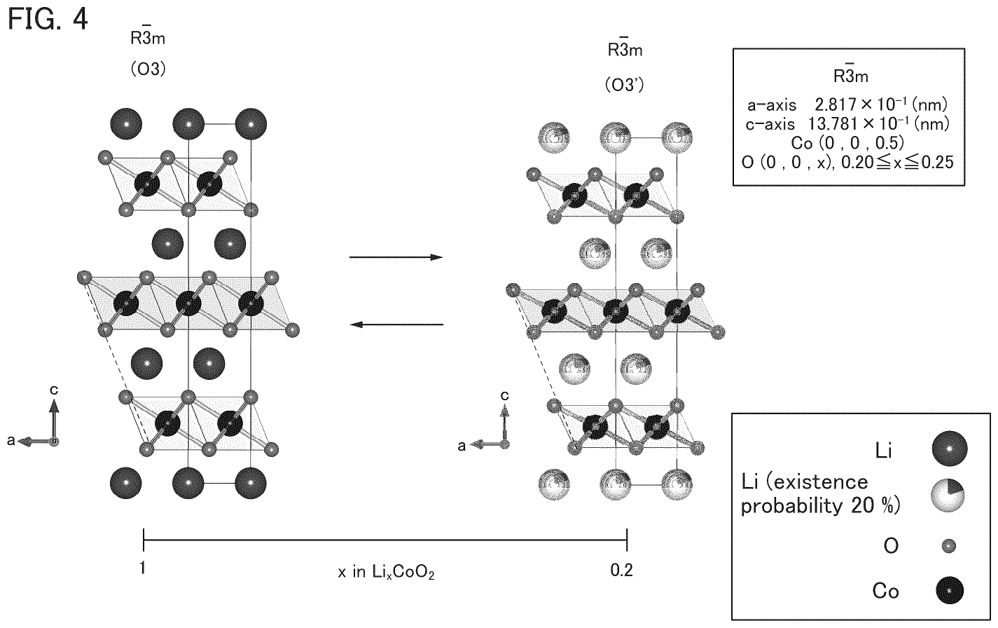

A conventional positive electrode active material and the positive electrode active material 100 of one embodiment of the present invention are compared and changes in crystal structures owing to a change in x in LiₓCoO₂ will be described with reference to FIG. 4 to FIG. 7.

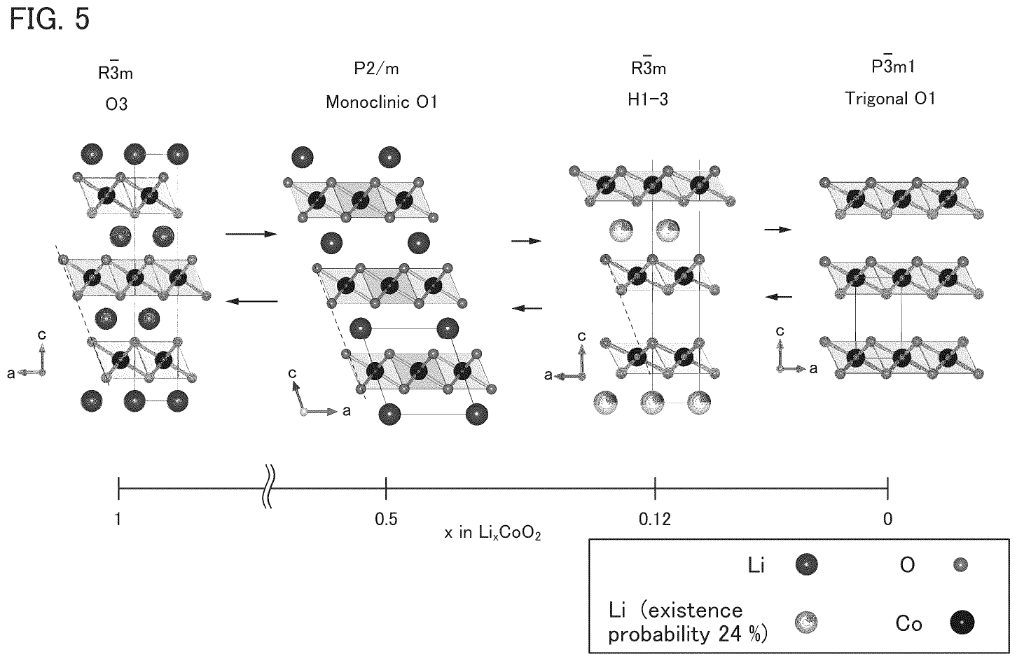

A change in the crystal structure of the conventional positive electrode active material is illustrated in FIG. 5. The conventional positive electrode active material illustrated in FIG. 5 is lithium cobalt oxide (LiCoO₂) without magnesium in particular.

In FIG. 5, the crystal structure of lithium cobalt oxide with x in LiₓCoO₂ of 1 is denoted by R-3m O3. In this crystal structure, lithium occupies octahedral sites and a unit cell includes three CoO₂ layers. Thus, this crystal structure is referred to as an 03 type crystal structure in some cases. Note that the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen.

Conventional lithium cobalt oxide with x of approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

A positive electrode active material with x of 0 has the trigonal crystal structure belonging to the space group P-3 ml and includes one CoO₂ layer in a unit cell. Thus, this crystal structure is referred to as an O1 type structure or a trigonal O1 type structure in some cases. Moreover, in some cases, this crystal structure is referred to as a hexagonal O1 type structure when the trigonal crystal is converted into a composite hexagonal lattice.

Conventional lithium cobalt oxide with x of approximately 0.12 has the crystal structure belonging to the space group R-3m. This structure can also be regarded as a structure in which CoO₂ structures such as trigonal O1 type structures and LiCoO₂ structures such as R-3m O3 are alternately stacked. Thus, this crystal structure is referred to as an H1-3 type crystal structure in some cases. Note that the number of cobalt atoms per unit cell in the actual H1-3 type crystal structure is twice that in other structures. However, in this specification, FIG. 5, and other drawings, the c-axis of the H1-3 type crystal structure is half that of the unit cell for easy comparison with the other crystal structures.

For the H1-3 type crystal structure, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). O1 and O2 are each an oxygen atom. A unit cell that should be used for representing a crystal structure in a positive electrode active material can be judged by the Rietveld analysis of XRD patterns, for example. In this case, a unit cell is selected such that the value of GOF (goodness of fit) is small, specifically, close to 1.

When charging that makes x in LiₓCoO₂ be 0.24 or less and discharging are repeated, the crystal structure of conventional lithium cobalt oxide repeatedly changes between the R-3m O3 type crystal structure in a discharged state and the H1-3 type crystal structure (i.e., an unbalanced phase change).

However, there is a large shift in the CoO₂ layers between these two crystal structures. As indicated by a dotted line and an arrow in FIG. 5, the CoO₂ layer in the H1-3 type crystal structure largely shifts from that in R-3m O3 in the discharged state. Such a dynamic structural change can adversely affect the stability of the crystal structure.

A difference in volume between these two crystal structures is also large. The difference in volume per the same number of cobalt atoms between the R-3m O3 type crystal structure in a discharged state and the H1-3 type crystal structure is greater than 3.5%, typically greater than or equal to 3.9%.

In addition, a structure in which CoO₂ layers are arranged continuously, such as the trigonal O1 type structure, included in the H1-3 type crystal structure is highly likely to be unstable.

Accordingly, when charging that makes x be 0.24 or less and discharging are repeated, the crystal structure of conventional lithium cobalt oxide is gradually broken. The broken crystal structure triggers degradation of the cycle performance. This is because the broken crystal structure has a smaller number of sites where lithium can exist stably and makes it difficult to insert and extract lithium.

On the other hand, in the positive electrode active material 100 of one embodiment of the present invention illustrated in FIG. 4, a change in the crystal structure between a discharged state with x in LiₓCoO₂ of 1 and a state with x of 0.24 or less, specifically with x of 0.2 (this is sometimes referred to as Li existence probability of 0%) is smaller than that in a conventional positive electrode active material. More specifically, a shift in the CoO₂ layers between the state with x of 1 and the state with x of 0.24 or less can be small. Furthermore, a change in the volume can be small in the case where the positive electrode active materials have the same number of cobalt atoms. Thus, the positive electrode active material 100 of one embodiment of the present invention can have a crystal structure that is difficult to break even when charging that makes x be 0.24 or less and discharging are repeated, and enables excellent cycle performance. In addition, the positive electrode active material 100 of one embodiment of the present invention with x in LiₓCoO₂ of 0.24 or less can have a more stable crystal structure than a conventional positive electrode active material. Thus, the positive electrode active material 100 of one embodiment of the present invention with x in LiₓCoO₂ being kept at 0.24 or less inhibits a short circuit. This is preferable because the safety of the lithium-ion secondary battery is improved.

FIG. 4 illustrates crystal structures of the inner portion 100b of the positive electrode active material 100 in a state where x in LiₓCoO₂ is 1 and in a state where x in LixCoO₂ is approximately 0.2. The inner portion 100b, accounting for the majority of the volume of the positive electrode active material 100, greatly contributes to charging and discharging and is accordingly a portion where a shift in CoO₂ layers and a volume change matter most.

The positive electrode active material 100 with x of 1 has the R-3m O3 type crystal structure, which is the same as that of conventional lithium cobalt oxide.

However, the positive electrode active material 100 has a crystal structure different from the H1-3 type crystal structure in a state where x is 0.24 or less, e.g., approximately 0.2 or approximately 0.12, with which conventional lithium cobalt oxide has the H1-3 type crystal structure.

The positive electrode active material 100 of one embodiment of the present invention with x of approximately 0.2 has a trigonal crystal structure belonging to the space group R-3m. The symmetry of the CoO₂ layers of this structure is the same as that of O3. Thus, this crystal structure is referred to as an O3′ type crystal structure. Although the positive electrode active material 100 of one embodiment of the present invention with x of approximately 0.2 does not have a spinel structure, an XRD pattern similar to that of the spinel structure appears in some cases, and this crystal structure is referred to as a pseudo-spinel structure in some cases. In FIG. 4, this crystal structure is denoted by R-3m O3′.

In the unit cell of the O3′ type crystal structure, the coordinates of cobalt and oxygen can be represented by Co (0, 0, 0.5) and O (0, 0, x) within the range of 0.20≤x≤0.25. In the unit cell, the lattice constant of the a-axis is preferably 2.797≤a≤2.837 (×10⁻¹ nm), further preferably 2.807≤a≤2.827 (×10⁻¹ nm), typically a=2.817 (×10⁻¹ nm). The lattice constant of the c-axis is preferably 13.681≤c≤13.881 (×10⁻¹ nm), further preferably 13.751≤c≤13.811, typically c=13.781 (×10⁻¹ nm).

Note that in the O3′ type crystal structure, an ion of cobalt, magnesium, or the like occupies a site coordinated to six oxygen atoms. Note that a light element such as lithium sometimes occupies a site coordinated to four oxygen atoms.

As indicated by the dotted lines in FIG. 4, the CoO₂ layers hardly shift between the R-3m (O3) in a discharged state and the O3′ type crystal structure.

The R-3m (O3) type crystal structure in a discharged state and the O3′ type crystal structure which contain the same number of cobalt atoms have a difference in volume of 2.5% or less, specifically 2.2% or less, typically 1.8%.

As described above, in the positive electrode active material 100 of one embodiment of the present invention, a change in the crystal structure caused when x in LiₓCoO₂ is small, i.e., when a large amount of lithium is extracted, is smaller than that in a conventional positive electrode active material. In addition, a change in the volume per the same number of cobalt atoms is inhibited. Thus, the crystal structure of the positive electrode active material 100 is less likely to be broken even when charging that makes x be 0.24 or less and discharging are repeated. Therefore, the positive electrode active material 100 inhibits a decrease in charge and discharge capacity in charge and discharge cycles. Furthermore, the positive electrode active material 100 can stably use a larger amount of lithium than a conventional positive electrode active material and thus enables high discharge capacity per weight and per volume. Thus, with use of the positive electrode active material 100, a lithium-ion secondary battery with high discharge capacity per weight and per volume can be fabricated.

Note that the positive electrode active material 100 is confirmed to have the O3′ type crystal structure in some cases when x in LiₓCoO₂ is greater than or equal to 0.15 and less than or equal to 0.24, and is assumed to have the O3′ type crystal structure even when x is greater than 0.24 and less than or equal to 0.27. However, the crystal structure is influenced by not only x in LiₓCoO₂ but also the number of charge and discharge cycles, a charge current and a discharge current, temperature, an electrolyte solution, and the like, so that the range of x is not limited to the above.

Hence, when x in LiₓCoO₂ in the positive electrode active material 100 is greater than 0.1 and less than or equal to 0.24, not the whole inner portion 100b of the positive electrode active material 100 necessarily has the O3′ type crystal structure. Another crystal structure may be included or an amorphous structure may be partly included.

In order to obtain a state where x in LiₓCoO₂ is small, charging at high charge voltage is necessary in general. Thus, the state where x in LiₓCoO₂ is small can be rephrased as a state where charging at high charge voltage has been performed.

Thus, the positive electrode active material 100 of one embodiment of the present invention is preferable because the crystal structure with the symmetry of R-3m O3 can be maintained even when charging at a high charge voltage of 4.6 V or higher is performed at 25° C., for example. Moreover, the positive electrode active material 100 of one embodiment of the present invention is preferable because the O3′ type crystal structure can be obtained when charging at a higher charge voltage, e.g., a voltage higher than or equal to 4.65 V and lower than or equal to 4.7 V is performed at 25° C.

In the positive electrode active material 100, when the charge voltage is increased, the H1-3 type crystal is eventually observed in some cases. As described above, the crystal structure is influenced by the number of charge and discharge cycles, a charge current and a discharge current, an electrolyte solution, and the like, so that the positive electrode active material 100 of one embodiment of the present invention sometimes has the O3′ type crystal structure even at a lower charge voltage, e.g., a charge voltage of higher than or equal to 4.5 V and lower than 4.6 V at 25° C.

Note that in the case where graphite is used as a negative electrode active material in a lithium-ion secondary battery, for example, the voltage of the lithium-ion secondary battery is lower than the above-mentioned voltage by the potential of graphite. The potential of graphite is approximately 0.05 V to 0.2 V with reference to the potential of a lithium metal. Thus, for a lithium-ion secondary battery using graphite as a negative electrode active material, a similar crystal structure is obtained at a voltage obtained by subtracting the potential of the graphite from the above-mentioned voltage.

Although the lithium existence probability is the same in all lithium sites in O3′ in FIG. 4, one embodiment of the present invention is not limited thereto. Lithium may exist unevenly in only some of the lithium sites; for example, lithium may symmetrically exist as in the monoclinic O1 (Li_{0.5}CoO₂) illustrated in FIG. 5. Distribution of lithium can be analyzed by neutron diffraction, for example.

To obtain the O3′ type structure, a plurality of portions of the surface portion 100a of the positive electrode active material 100 preferably have similar concentration gradients of magnesium. In other words, it is preferable that the reinforcement derived from magnesium uniformly occurs in the surface portion 100a. When the surface portion 100a partly has reinforcement, stress might be concentrated on parts that do not have reinforcement. The concentration of stress on part of the positive electrode active material 100 might cause defects such as cracks from that part, leading to breakage of the positive electrode active material and a decrease in discharge capacity. Note that magnesium does not necessarily have similar concentration gradients throughout the surface portion 100a of the positive electrode active material 100.

In a layered rock-salt crystal structure belonging to R-3m, cations are arranged parallel to the (001) plane. In other words, CoO₂ layers and lithium layers are alternately stacked parallel to the (001) plane. Accordingly, a diffusion path of lithium ions also exists parallel to the (001) plane. As already described above, the (001) plane is referred to as a basal plane, and a plane, where a diffusion path of lithium ions is exposed, other than the (001) plane is referred to as an edge plane.

Since a CoO₂ layer is relatively stable, the (001) plane where the CoO₂ layer exists in a surface is relatively stable. A main diffusion path of lithium ions in charging and discharging is not exposed at the (001) plane.

By contrast, a diffusion path of lithium ions is exposed at a plane other than the (001) plane. Thus, the plane other than the (001) plane and the surface portion 100a including the plane easily lose stability because they are regions where extraction of lithium ions starts as well as important regions for maintaining a diffusion path of lithium ions. It is thus extremely important to reinforce the surface other than the (001) plane and the surface portion 100a including the plane so that the crystal structure of the whole positive electrode active material 100 is maintained.

### <Analysis Method>

Whether or not a given positive electrode active material is the positive electrode active material 100 of one embodiment of the present invention, which has the O3′ type crystal structure when x in LiₓCoO₂ is small, can be judged by analyzing a positive electrode including the positive electrode active material with small x in LiₓCoO₂ by XRD, electron diffraction, neutron diffraction, electron spin resonance (ESR), nuclear magnetic resonance (NMR), or the like. XRD, in particular, powder XRD is preferable because a diffraction peak reflecting the crystal structure of the inner portion 100b of the positive electrode active material 100, which accounts for the majority of the volume of the positive electrode active material 100, can be obtained.

In addition, in the case where x is too small, e.g., 0.1 or less, or under the condition where charge voltage is higher than 4.9 V, the positive electrode active material 100 of one embodiment of the present invention sometimes has the H1-3 type crystal structure or the trigonal O1 type crystal structure. Thus, determining whether or not a positive electrode active material is the positive electrode active material 100 of one embodiment of the present invention requires analysis of the crystal structure by XRD and other methods and data such as charge capacity or charge voltage.

A positive electrode active material with small x sometimes causes a change in the crystal structure when exposed to the air. For example, the O3′ type crystal structure changes into the H1-3 type crystal structure in some cases. For that reason, all samples subjected to analysis of crystal structures are preferably handled in an inert atmosphere such as an argon atmosphere.

Whether the distribution of the additive element contained in a positive electrode active material is in the above-described state can be judged by, for example, analysis using XPS, energy dispersive X-ray spectroscopy (EDX), EPMA (electron probe microanalysis), or the like.

The crystal structure of the surface portion 100a, the crystal grain boundary, or the like can be analyzed by electron diffraction of a cross section of the positive electrode active material 100, for example.

### <<Charge Method>>

High-voltage charge for determining whether or not a composite oxide is the positive electrode active material 100 of one embodiment of the present invention can be performed on a coin cell (CR2032 type with a diameter of 20 mm and a height of 3.2 mm) with a lithium counter electrode, for example.

More specifically, a positive electrode can be formed by application of slurry in which the positive electrode active material, a conductive material, and a binder are mixed to a positive electrode current collector made of aluminum foil.

A lithium metal can be used for a counter electrode.

As a lithium salt, 1 mol/L lithium hexafluorophosphate (LiPF₆) can be used, as an electrolyte, a mixed solvent in which ethylene carbonate (EC) and diethyl carbonate (DEC) are mixed at EC:DEC=3:7 (volume ratio) can be used, and as an additive agent, vinylene carbonate (VC) mixed in the mixed solvent at 2 wt % can be used.

As a separator, a 25-μm-thick polypropylene porous film can be used.

Stainless steel (SUS) can be used for a positive electrode can and a negative electrode can.

The coin cell fabricated with the above conditions is charged with a given voltage (e.g., 4.5 V, 4.55 V, 4.6 V, 4.65 V, 4.7 V, 4.75 V, or 4.8 V). The charging method is not particularly limited as long as charging with a given voltage can be performed for sufficient time. In the case of CCCV charging, for example, the CC charging can be performed with a current higher than or equal to 20 mA/g and lower than or equal to 100 mA/g per weight of the positive electrode active material. The CV charging can be terminated at a current higher than or equal to 2 mA/g and lower than or equal to 10 mA/g per weight of the positive electrode active material. To observe a phase change of the positive electrode active material, charging with such a small current value is desirably performed. The temperature is set to 25° C. After charging is performed in this manner, the coin cell is disassembled in a glove box with an argon atmosphere to take out the positive electrode, whereby the positive electrode active material with a given charge capacity can be obtained. In order to inhibit a reaction with components in the external environment, the positive electrode is preferably enclosed in an argon atmosphere in performing various analyses later. For example, XRD can be performed on the positive electrode enclosed in an airtight container with an argon atmosphere. After charging is completed, the positive electrode is preferably taken out and subjected to the analysis immediately. Specifically, the positive electrode is preferably subjected to analysis within an hour, further preferably within 30 minutes after the completion of charging.

In the case where the crystal structure in a charged state after charging and discharging are performed multiple times is analyzed, the conditions of the charging and discharging performed multiple times may be different from the above-described charge conditions. For example, the charging can be performed by constant current charging with a current value greater than or equal to 20 mA/g and less than or equal to 100 mA/g per weight of the positive electrode active material to a given voltage (e.g., 4.6 V, 4.65 V, 4.7 V, 4.75 V, or 4.8 V) and then constant voltage charging until the current value becomes greater than or equal to 2 mA/g and less than or equal to 10 mA/g per weight of the positive electrode active material. The discharging can be performed by constant current discharging with greater than or equal to 20 mA/g and less than or equal to 100 mA/g per weight of the positive electrode active material to 2.5 V.

Also in the case where the crystal structure in a discharged state after the charging and discharging are performed multiple times is analyzed, constant current discharging can be performed with a current value greater than or equal to 20 mA/g and less than or equal to 100 mA/g per weight of the positive electrode active material to 2.5 V, for example.

### <XRD>

The apparatus and conditions for the XRD measurement are not particularly limited as long as appropriate adjustment and calibration are performed. For example, the measurement can be performed using the following apparatus and conditions.
XRD apparatus: D8 ADVANCE produced by Bruker AXS
X-ray source: Cu
Output: 40 kV, 40 mA
Angle of divergence: Div. Slit, 0.5°
Detector: LynxEye
Scanning method: 2θ/θ continuous scan
Measurement range (2θ): from 15° to 90°
Step width (2θ): 0.01°
Counting time: 1 second/step
Rotation of sample stage: 15 rpm

As a standard sample used for the adjustment and calibration, a standard sintered alumina plate SRM 1976 from National Institute of Standards and Technology (NIST) can be used, for example.

In the case where the measurement sample is a powder, the sample can be set by, for example, being put on a glass sample holder or being sprinkled on a reflection-free silicon plate to which grease is applied. In the case where the measurement sample is a positive electrode, the sample can be set in such a manner that the positive electrode is attached to a substrate with a double-sided adhesive tape so that the position of the positive electrode active material layer can be adjusted to the measurement plane required by the apparatus.

Characteristic X-rays may be monochromatized with the use of a filter or the like or may be monochromatized with XRD data analysis software after an XRD diffraction pattern is obtained. For example, a peak due to CuKα2 radiation can be eliminated and only a peak due to CuKα1 radiation can be extracted by using DEFFRAC.EVA (XRD data analysis software produced by Bruker Corporation). This software can also be used to eliminate the background, for example.

In this specification and the like, a 2θ value of a diffraction peak refers to a value at 2θ where a peak top of the diffraction peak appears in the XRD pattern after fitting of the calculation model. There is no particular limitation on the crystal structure analysis software used for the fitting; for example, it is possible to use TOPAS ver. 3 (crystal structure analysis software produced by Bruker Corporation).

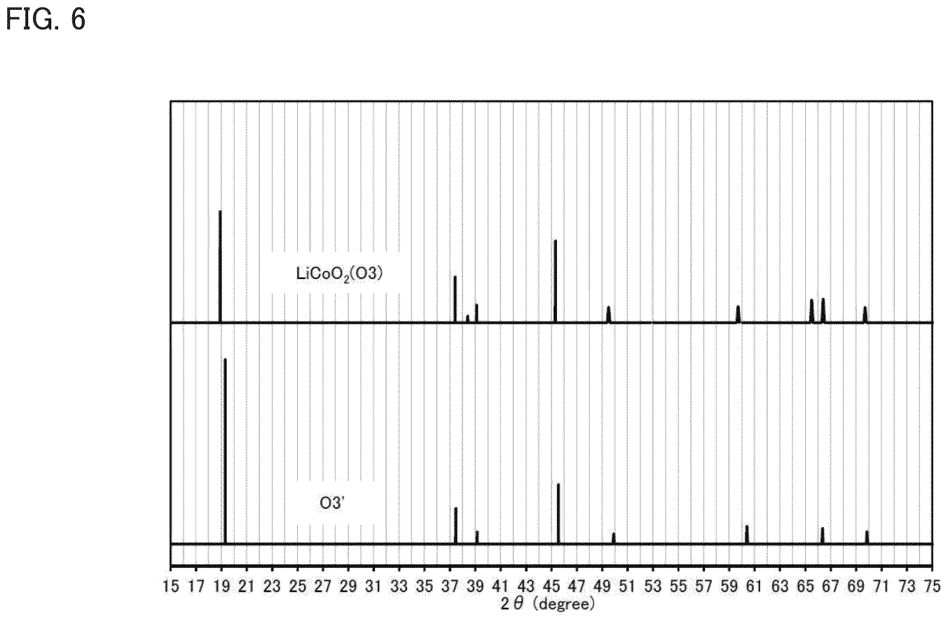

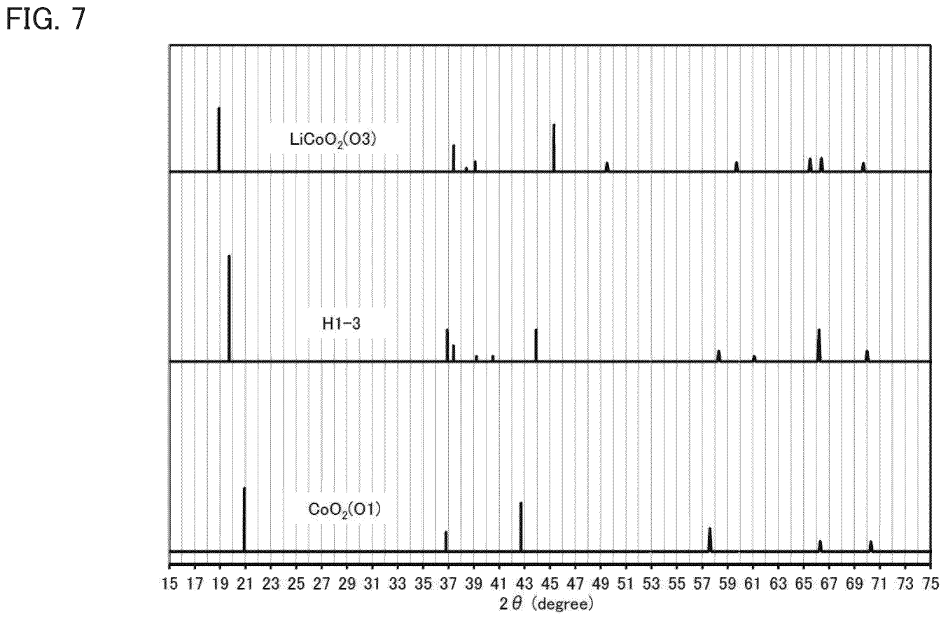

FIG. 6 and FIG. 7 show ideal powder XRD patterns with CuKα1 radiation that are calculated from models of the O3′ type crystal structure and the H1-3 type crystal structure. For comparison, ideal XRD patterns calculated from the crystal structure of LiCoO₂ O3 with x=1 in LiₓCoO₂ and the crystal structure of the trigonal O1 with x=0 are also shown. Note that the patterns of LiCoO₂ (O3) and CoO₂ (O1) are made from crystal structure data obtained from ICSD (Inorganic Crystal Structure Database) using Reflex Powder Diffraction, which is a module of Materials Studio (BIOVIA). The 2θ range is from 15° to 75°, the step size is 0.01, the wavelength λ1 is 1.540562× 10⁻¹⁰ m, the wavelength λ2 is not set, and a single monochromator is used. XRD patterns of the H1-3 type crystal structure are made from crystal structure data of the H1-3 type crystal structure shown in FIG. 7 in a manner similar to the above-described method. The O3′ type crystal structure is estimated from the XRD pattern of the positive electrode active material of one embodiment of the present invention, the crystal structure is fitted with TOPAS Ver. 3 (crystal structure analysis software produced by Bruker Corporation), and the XRD pattern of the O3′ type crystal structure is made in a manner similar to that for other structures.

As shown in FIG. 6, the O3′ type crystal structure exhibits diffraction peaks at 2θ of 19.25±0.12° (greater than or equal to 19.13° and less than or equal to) 19.37° and 20 of 45.47±0.10° (greater than or equal to 45.37° and less than or equal to 45.57°).

However, as shown in FIG. 7, the H1-3 type crystal structure and trigonal O1 do not exhibit peaks at these positions. Thus, it can be said that the diffraction peaks at 2θ of 19.25±0.12° (greater than or equal to 19.13° and less than or equal to) 19.37° and 2θ of 45.47±0.10° (greater than or equal to 45.37° and less than or equal to 45.57°) in a state where x in LiₓCoO₂ is small are the features of the positive electrode active material 100 of one embodiment of the present invention.

It can also be said that the positions of the XRD diffraction peaks exhibited by the crystal structure with x=1 and the crystal structure with x≤0.24 are close to each other. More specifically, it can be said that a difference in 2θ between the main diffraction peak exhibited by the crystal structure with x=1 and the main diffraction peak exhibited by the crystal structure with x≤0.24, which are exhibited at 2θ of greater than or equal to 42° and less than or equal to 46°, is 0.7° or less, preferably 0.5° or less.

Although the positive electrode active material 100 of one embodiment of the present invention has the O3′ type crystal structure when x in LiₓCoO₂ is small, not all structures are necessarily the O3′ type crystal structures. Another crystal structure may be included or an amorphous structure may be partly included. Note that when the XRD patterns are subjected to the Rietveld analysis, the O3′ type crystal structure preferably accounts for greater than or equal to 50%, further preferably greater than or equal to 60%, still further preferably greater than or equal to 66%. When the O3′ type crystal structure accounts for greater than or equal to 50%, preferably greater than or equal to 60%, further preferably greater than or equal to 66%, the positive electrode active material achieves sufficiently good cycle performance.

Sharpness of a diffraction peak in an XRD pattern indicates the degree of crystallinity. It is thus preferable that the diffraction peaks after charging be sharp, in other words, have a small half width. Even peaks that are derived from the same crystal phase have different half widths depending on the XRD measurement conditions or the 2θ value. In the case of the above-described measurement conditions, the peak observed at 2θ of greater than or equal to 43° and less than or equal to 46° preferably has a half width of less than or equal to 0.2°, further preferably less than or equal to 0.15°, still further preferably less than or equal to 0.12°. A narrow half width and high crystallinity contribute to stabilization of the crystal structure after charging. By contrast, conventional LiCoO₂ has a small crystallite size and a broad and small peak even when it can have a structure part of which is similar to the O3′ type crystal structure.

### <XPS>

In an inorganic oxide, a region ranging from a surface to a depth of approximately 2 to 8 nm (usually, less than or equal to 5 nm) can be analyzed by X-ray photoelectron spectroscopy (XPS) using monochromatic aluminum Kα radiation as an X-ray source; thus, the concentrations of elements in a region within approximately half the depth of the surface portion 100a can be quantitatively analyzed. The bonding states of the elements can be analyzed by narrow scanning. Note that in many cases, the quantitative accuracy of XPS is approximately ±1 atomic %, and the lower detection limit is approximately 1 atomic % but depends on the element.

The concentration of the additive element may be compared using the ratio of the additive element to cobalt. The use of the ratio of the additive element to cobalt is preferable because it enables comparison while reducing the influence of a carbonate or the like which is chemically adsorbed after formation of the positive electrode active material. For example, the atomic ratio of magnesium to cobalt (Mg/Co) in the XPS analysis is preferably greater than or equal to 0.400, further preferably greater than or equal to 0.500, still further preferably greater than or equal to 0.600, yet still further preferably greater than or equal to 0.700, yet still further preferably greater than or equal to 0.800, yet still further preferably greater than or equal to 0.900, yet still further preferably greater than or equal to 1.000. Mg/Co is preferably less than or equal to 2.000, further preferably less than or equal to 1.500, still further preferably less than or equal to 1.400, yet still further preferably less than or equal to 1.300, yet still further preferably less than or equal to 1.200.

For example, the atomic ratio of nickel to cobalt (Ni/Co) in the XPS analysis is preferably greater than or equal to 0.05, further preferably greater than or equal to 0.06, still further preferably greater than or equal to 0.07, yet still further preferably greater than or equal to 0.08, yet still further preferably greater than or equal to 0.09. Ni/Co is preferably less than or equal to 0.200, further preferably less than or equal to 0.150, still further preferably less than or equal to 0.140, yet still further preferably less than or equal to 0.130, yet still further preferably less than or equal to 0.120, yet still further preferably less than or equal to 0.110.

For example, the atomic ratio of fluorine to cobalt (F/Co) in the XPS analysis is preferably greater than or equal to 0.100, further preferably greater than or equal to 0.200, still further preferably greater than or equal to 0.300, yet still further preferably greater than or equal to 0.400, yet still further preferably greater than or equal to 0.500, yet still further preferably greater than or equal to 0.600, yet still further preferably greater than or equal to 0.700. F/Co is preferably less than or equal to 1.500, further preferably less than or equal to 1.200, still further preferably less than or equal to 1.100, yet still further preferably less than or equal to 1.000, yet still further preferably less than or equal to 0.900.

When the ratio is within the above range, it can be said that the additive element is not attached to the surface of the positive electrode active material 100 in a narrow range but widely distributed at a preferable concentration in the surface portion 100a of the positive electrode active material 100. That is, when the ratios are within the above ranges in the XPS analysis results of the positive electrode active material 100, the crystal structure is less likely to be broken even when charging that makes x be 0.24 or less and discharging are repeated, so that excellent cycle performance can be achieved.

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. The above value is different from 685 eV, which is the bonding energy of lithium fluoride, and 686 eV, which is the bonding energy of magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably at approximately 1303 eV. The above value is different from 1305 eV, which is the bonding energy of magnesium fluoride, and is close to the bonding energy of magnesium oxide.

### <EDX>

One or two or more selected from the additive elements contained in the positive electrode active material 100 preferably have a concentration gradient. It is further preferable that the additive elements contained in the positive electrode active material 100 exhibit concentration peaks at different depths from the surface. The concentration gradient of the additive element can be evaluated by, for example, exposing a cross section of the positive electrode active material 100 using FIB (Focused Ion Beam) or the like and analyzing the cross section using energy dispersive X-ray spectroscopy (EDX), EPMA (electron probe microanalysis), or the like.

In the EDX measurement, to measure a region while scanning is performed and evaluate the region two-dimensionally is referred to as EDX area analysis. The measurement for evaluation of the atomic concentration distribution in a positive electrode active material by line scanning is referred to as line analysis. Furthermore, extracting data of a linear region from EDX area analysis is referred to as line analysis in some cases. Measurement of a region without scanning is referred to as point analysis.

By EDX area analysis (e.g., element mapping), the concentrations of the additive element in the surface portion 100a, the inner portion 100b, the vicinity of a crystal grain boundary, and the like of the positive electrode active material 100 can be quantitatively analyzed. By EDX line analysis, the concentration distribution and the highest concentration of the additive element can be analyzed. Analysis after a sample is thinned by FIB or the like is preferable because it makes it possible to analyze the concentration distribution in the depth direction from the surface toward the center in a specific region of the positive electrode active material regardless of the distribution in the front-back direction.

EDX area analysis or EDX point analysis of the positive electrode active material 100 of one embodiment of the present invention preferably reveals that the concentration of each additive element, in particular, the additive element X in the surface portion 100a is higher than that in the inner portion 100b.

In STEM-EDX line analysis or the like, it is sometimes difficult to precisely determine the surface because a steep change in a profile of an element is not seen in principle or due to a measurement error. Thus, when the depth direction in STEM-EDX linear analysis or the like is mentioned, a reference point is a point where the value of the amount of the detected transition metal M is equal to 50% of the sum of an average value M_{AVE} of the amount of the detected transition metal M in the inner portion and an average value M_{BG} of the amount of the background transition metal M or a point where a value of the amount of the detected oxygen is equal to 50% of the sum of an average value O_{AVE} of the amount of detected oxygen in the inner portion and an average value O_{BG} of the amount of background oxygen. Note that in the case where the positions of the points of 50% of the sum of the detected amount in the inner portion and the background amount differ between the transition metal M and oxygen, the difference is probably due to the influence of a carbonate, a metal oxide containing oxygen, or the like, which is attached to the surface. Thus, the point that is equal to 50% of the sum of the average value M_{AVE} of the amount of the detected transition metal M in the inner portion and the average value M_{BG} of the amount of the background transition metal M can be used. In the case of a positive electrode active material containing a plurality of transition metals M, the reference point can be determined using M_{AVE} and M_{BG} of an element whose count number is the largest in the inner portion 100b.

The average value M_{BG} of the amount of background cobalt can be calculated by averaging the amounts of detected cobalt in the range greater than or equal to 2 nm, preferably greater than or equal to 3 nm, which is outside the vicinity of a portion where the amount of detected cobalt begins to increase, for example. The average value M_{AVE} of the amount of detected cobalt in the inner portion can be calculated by averaging the amount in the range greater than or equal to 2 nm, preferably greater than or equal to 3 nm in a region where the counts of cobalt and oxygen are saturated and stabilized, e.g., a region that is at a depth of greater than or equal to 30 nm, preferably greater than or equal to 50 nm from a portion where the amount of detected cobalt begins to increase, for example. The average value O_{BG} of the amount of background oxygen and the average value O_{AVE} of the amount of detected oxygen in the inner portion can be calculated in a similar manner.

The surface of the positive electrode active material 100 in, for example, a cross-sectional STEM (scanning transmission electron microscope) image is a boundary between a region where an image derived from the crystal structure of the positive electrode active material is observed and a region where the image is not observed, and is determined as the outermost surface of a region where an atomic column derived from an atomic nucleus of a metal element that has a greater atomic number than lithium among the metal elements constituting the positive electrode active material is confirmed. Alternatively, the surface refers to an intersection of a tangent drawn at a luminance profile from the surface toward the bulk and an axis in the depth direction in a STEM image. The surface in a STEM image or the like may be determined in combination with analysis with higher spatial resolution.

A peak in STEM-EDX line analysis refers to the maximum value of the detection intensity in each element profile or the maximum value of the characteristic X-ray of each element. As a noise in STEM-EDX line analysis, a measured value having a half width smaller than or equal to spatial resolution (R), for example, smaller than or equal to R/2 can be given.

For example, EDX area analysis or EDX point analysis of the positive electrode active material 100 containing magnesium as the additive element preferably reveals that the concentration of magnesium in the surface portion 100a is higher than that in the inner portion 100b. In the EDX line analysis, a peak of the concentration of magnesium in the surface portion 100a preferably exists within a depth of 3 nm, further preferably 1 nm, still further preferably 0.5 nm from the surface of the positive electrode active material 100 toward the center. Alternatively, the depth is preferably within +1 nm from the surface. In addition, the concentration of magnesium preferably attenuates, at a depth of 1 nm from the point where the concentration reaches the peak, to less than or equal to 60% of the peak concentration. In addition, the concentration of magnesium preferably attenuates, at a depth of 2 nm from the point where the concentration reaches the peak, to less than or equal to 30% of the peak concentration. Here, a “peak of concentration” refers to the local maximum value of concentration. Note that due to the influence of spatial resolution in the EDX line analysis, the position where the peak of the magnesium concentration exists sometimes has a negative value as a depth from the surface toward the inner portion.

When the positive electrode active material 100 contains magnesium and fluorine as the additive elements, the distribution of fluorine preferably overlaps with the distribution of magnesium. For example, a difference in the depth direction between a peak of the concentration of fluorine and a peak of the concentration of magnesium is preferably within 10 nm, further preferably within 3 nm, still further preferably within 1 nm.

In the EDX line analysis, a peak of the concentration of fluorine in the surface portion 100a preferably exists within a depth of 3 nm, further preferably 1 nm, still further preferably 0.5 nm from the surface of the positive electrode active material 100 toward the center. Alternatively, the depth is preferably within ±1 nm from the surface. It is further preferable that a peak of the concentration of fluorine be exhibited slightly closer to the surface than the peak concentration of magnesium is, which increases resistance to hydrofluoric acid. For example, it is preferable that a peak of the concentration of fluorine be exhibited slightly closer to the surface side than a peak of the concentration of magnesium is by 0.5 nm or more, further preferably 1.5 nm or more.

In the positive electrode active material 100 containing nickel as the additive element, a peak of the concentration of nickel in the surface portion 100a preferably exists within a depth of 3 nm, further preferably 1 nm, still further preferably 0.5 nm from the surface of the positive electrode active material 100 toward the center. Alternatively, the depth is preferably within +1 nm from the surface. When the positive electrode active material 100 contains magnesium and nickel, the distribution of nickel preferably overlaps with the distribution of magnesium. For example, a difference in the depth direction between a peak of the concentration of nickel and a peak of the concentration of magnesium is preferably within 10 nm, further preferably within 3 nm, still further preferably within 1 nm.

In the case where the positive electrode active material 100 contains aluminum as the additive element, a peak of the concentration of magnesium, nickel, or fluorine is preferably closer to the surface than a peak of the concentration of aluminum is in the surface portion 100a in the EDX line analysis. For example, a peak of the concentration of aluminum preferably exists within a range from a depth of 0.5 nm to a depth of 50 nm inclusive, further preferably from a depth of 3 nm to a depth of 30 nm inclusive from the surface of the positive electrode active material 100 toward the center.

When EDX line, area, or point analysis is performed on the positive electrode active material 100, the atomic ratio of magnesium Mg to cobalt Co (Mg/Co) at a peak of the concentration of magnesium is preferably greater than or equal to 0.05 and less than or equal to 0.6, further preferably greater than or equal to 0.1 and less than or equal to 0.4. The atomic ratio of aluminum Al to cobalt Co (Al/Co) at a peak of the concentration of aluminum is preferably greater than or equal to 0.01 and less than or equal to 0.6, further preferably greater than or equal to 0.05 and less than or equal to 0.45. The atomic ratio of nickel Ni to cobalt Co (Ni/Co) at a peak of the concentration of nickel is preferably greater than or equal to 0 and less than or equal to 0.2, further preferably greater than or equal to 0.01 and less than or equal to 0.1, still further preferably greater than or equal to 0.05 and less than or equal to 0.1. The atomic ratio of fluorine F to cobalt Co (F/Co) at a peak of the concentration of fluorine is preferably greater than or equal to 0 and less than or equal to 1.6, further preferably greater than or equal to 0.1 and less than or equal to 1.4.

### <Washing>

Although various kinds of analyses are described above, before analysis, a sample of a positive electrode active material, a positive electrode active material layer, or the like may be washed to eliminate an electrolyte solution, a binder, a conductive material, or a compound originating from any of these that are attached to the surface of the positive electrode active material. Although lithium might be dissolved into a solvent or the like used in the washing at this time, the additive element is not easily dissolved even in that case; thus, the atomic ratio of the additive element is not affected.

### <Electrolyte Solution>

As one mode of the electrolyte solution, an electrolyte solution containing a solvent and an electrolyte dissolved in the solvent can be used. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio. In the case where two or more kinds of them are included, the solvent is referred to as a mixed solvent in some cases.

As another mode of the electrolyte solution, one or more ionic liquids (room temperature molten salts) that are unlikely to burn and volatize can be used as the solvent. In this case, a power storage device can be prevented from exploding or catching fire even when the power storage device internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte (also referred to as lithium salt) dissolved in the above-described solvent, one kind of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, and lithium bis(oxalate) borate (Li(C₂O₄)₂, LiBOB) can be used, or two or more kinds of these lithium salts can be used in an appropriate combination at an appropriate ratio.

An additive agent may be mixed in a mixed solvent in which a lithium salt is dissolved. Example of the additive agent include vinylene carbonate, propane sultone (PS), tert-butylbenzene (TBB), fluoroethylene carbonate (FEC), lithium bis(oxalate) borate (LiBOB), and a dinitrile compound such as succinonitrile or adiponitrile. The concentration of such an additive agent in the mixed solvent in which the lithium salt is dissolved is, for example, higher than or equal to 0.1 wt % and lower than or equal to 5 wt %.

### Example 1 of Electrolyte Solution

For the mixed solution used as one embodiment of the present invention, a material having high lithium ion conductivity even in charging and/or discharging (charging and discharging) in a low-temperature environment (e.g., 0° C., −20° C., preferably −30° C., further preferably −40° C. can be used.

An example of an electrolyte solution is described below. Note that the electrolyte solution described in this embodiment is a solution in which a lithium salt is dissolved in a mixed solvent, and the mixed solvent is a liquid at room temperature. Note that the mixed solvent is not limited to being a liquid at room temperature, and a solid electrolyte that becomes a solid at room temperature can also be used. Alternatively, a semi-solid electrolyte containing both a liquid and a solid at room temperature can be used. A semi-solid electrolyte includes a gelled electrolyte.

A mixed solvent of the electrolyte solution of one embodiment of the present invention preferably contains two or more selected from a fluorinated cyclic carbonate and a fluorinated chain carbonate.

As a fluorinated cyclic carbonate, fluoroethylene carbonate (fluorinated ethylene carbonate, FEC, or FIEC), difluoroethylene carbonate (DFEC or F2EC), trifluoroethylene carbonate (F3EC), or tetrafluoroethylene carbonate (F4EC) or the like can be used. Note that DFEC has isomers such as a cis-4,5 isomer and a trans-4,5 isomer. Each of these fluorinated cyclic carbonates includes a substituent with an electron-withdrawing property and is thus presumed to have a low solvation energy of a lithium ion.

Structural Formula (H10) below is a structure formula of FEC. The substituent with an electron-withdrawing property in FEC is an F group.

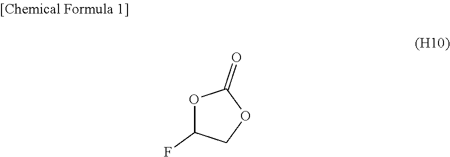

An example of the fluorinated chain carbonate is methyl 3,3,3-trifluoropropionate. Structural Formula (H22) below is a structure formula of methyl 3,3,3-trifluoropropionate. An abbreviation of methyl 3,3,3-trifluoropropionate is “MTFP”. The substituent with an electron-withdrawing property in MTFP is a CF₃ group.

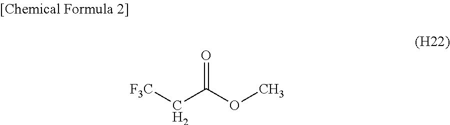

An example of the fluorinated chain carbonate is trifluoromethyl 3,3,3-trifluoropropionate. Structural Formula (H23) below is a structure formula of trifluoromethyl 3,3,3-trifluoropropionate. The substituent with an electron-withdrawing property is a CF₃ group.

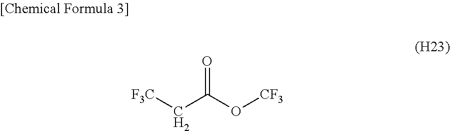 [SMILES: O=C(CC(F)(F)F)OC(F)(F)F]

An example of the fluorinated chain carbonate is trifluoromethyl propionate. Structural Formula (H24) below is a structural formula of trifluoromethyl propionate. The substituent with an electron-withdrawing property is a CF₃ group.

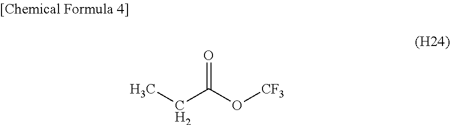

An example of the fluorinated chain carbonate is methyl 2,2-difluoropropionate. Structural Formula (H25) below is a structure formula of methyl 2,2-difluoropropionate. The substituent with an electron-withdrawing property is a CF₂ group.

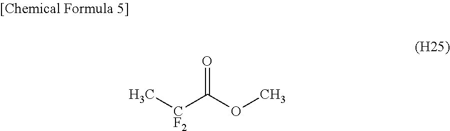

### <FEC and MTFP>

For example, the mixed solvent described in this embodiment preferably contains FEC and MTFP. The reason is as follows.

FEC is a cyclic carbonate and has a high dielectric constant, and thus has an effect of promoting dissociation of a lithium salt when used in a mixed solvent. Moreover, because of including the substituent with an electron-withdrawing property, FEC is readily bonded to a lithium ion by the Coulomb force or the like. Specifically, FEC has a lower solvation energy than ethylene carbonate (abbreviated as “EC”), which does not include a substituent with an electron-withdrawing property; thus, it can be said that a bond between a lithium ion and the solvent is easily cut, that is, desolvation is facilitated. In addition, FEC is presumed to have a deep highest occupied molecular orbital (HOMO) level and is thus not easily oxidized, meaning high oxidation resistance. On the other hand, FEC has a high viscosity and is difficult to use alone as a solvent at a temperature below freezing. Then, the mixed solvent specifically described as one embodiment of the present invention contains not only FEC but also MTFP. MTFP, which is a chain carbonate, has an effect of reducing or maintaining the viscosity of the electrolyte solution. Needless to say, MTFP also has a lower solvation energy than methyl propionate (abbreviated as “MP”), which does not include a substituent with an electron-withdrawing property, and thus may solvate a lithium ion.

The HOMO levels, the solvation energy, the measured melting points, and the like are collectively shown in the table below.

TABLE 1

| Name of organic compound | | | | |
|---|---|---|---|---|
| (abbreviation) | FEC | MTFP | EC | MP |
| Structural Formula | 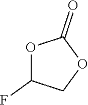 | 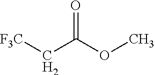 | 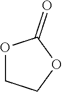 | 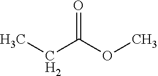 |
| HOMO level [eV] | −8.71 | −8.15 | −8.23 | −7.56 |
| Solvation energy [eV] | 5.39 | 4.33 to 5.38 | 5.79 | 4.45 to 5.22 |
| Measured value of melting point [° C.] | 17 | Unknown | 38 | −87.5 |

FEC and MTFP having the above-described physical properties are preferably used as a mixture in a volume ratio of x: 100-x (where 5≤x≤30, preferably 10≤x≤20) when the total content of these two mixed solvents is 100 vol %. That is, MTFP and FEC are preferably mixed such that the amount of MTFP is larger than that of FEC in the mixed solvent. Note that the above volume ratio may be a volume ratio measured before mixing for the mixed solvent, and the outside temperature at the time of mixing for the mixed solvent may be room temperature (typically 25° C.). The mixed solvent where FEC and MTFP are mixed is preferable because it exhibits a viscosity at which a lithium-ion secondary battery can operate and maintains an appropriate viscosity even in a low-temperature environment.

A general solvent used for a lithium-ion secondary battery solidifies at approximately −20° C.; thus, it is difficult to fabricate a lithium-ion secondary battery that can be charged and discharged at −30° C., preferably −40° C. Meanwhile, the mixed solvent described in this embodiment as an example can have a freezing point lower than or equal to −30° C., preferably lower than or equal to −40° C., and enables a lithium-ion secondary battery to be charged and discharged even in a low-temperature environment. As a result, it is possible to obtain a lithium-ion secondary battery capable of being charged and discharged in a wide temperature range including at least a low-temperature environment.

Although FEC is described above as a typical example, it can be said that any of the organic compounds given as the fluorinated cyclic carbonate has an effect of promoting dissociation of a lithium salt, easily cuts a bond between the lithium ion and the solvent owing to its low solvation energy, and is difficult to use alone at a temperature below freezing owing to its high viscosity.

Although MTFP is described above as a typical example, it can be said that any of the organic compounds given as the fluorinated chain carbonate has an effect of reducing or maintaining the viscosity of the electrolyte solution of one embodiment of the present invention. Thus, when the mixed solvent of one embodiment of the present invention contains the fluorinated cyclic carbonate and the fluorinated chain carbonate, a lithium-ion secondary battery capable of being charged and discharged in a low-temperature environment can be provided.

### Example 2 of Electrolyte Solution

As a mixed solvent of an electrolyte solution of another embodiment of the present invention, it is possible to use a solvent containing ethylene carbonate (EC), ethyl methyl carbonate (EMC), and dimethyl carbonate (DMC), in which the volume ratio of the ethylene carbonate, the ethyl methyl carbonate, and the dimethyl carbonate is x.y:100−x−y (note that 5≤x≤35 and 0<y<65) with a total content of the ethylene carbonate, the ethyl methyl carbonate, and the dimethyl carbonate of 100 vol %. More specifically, a mixed solvent containing EC, EMC, and DMC at EC:EMC:DMC=30:35:35 (volume ratio) can be used. Note that the volume ratio may be a volume ratio before mixing for the mixed solvent, and mixing for the mixed solvent may be performed at room temperature (typically 25° C.).

EC is a cyclic carbonate and has high dielectric constant, and thus has an effect of promoting dissociation of a lithium salt. Meanwhile, EC has high viscosity and has a high freezing point (melting point) of 38° C.; thus, it is difficult to use EC alone as the solvent in a low-temperature environment. Then, the solvent specifically described in one embodiment of the present invention contain not only EC but also EMC and DMC. EMC is a chain carbonate and has an effect of decreasing the viscosity of the electrolyte solution, and the freezing point is −54° C. In addition, DMC is also a chain carbonate and has an effect of decreasing the viscosity of the electrolyte solution, and the freezing point is −43° C. An electrolyte solution formed using a mixed solvent where EC, EMC, and DMC having such physical properties are mixed in a volume ratio of x:y: 100−x−y (note that 5≤x≤35 and 0<y>65) with the total content of these three solvents of 100 vol % has a characteristic in which the freezing point is lower than or equal to −40° C.

The lowest temperature at which a general electrolyte solution used for a lithium-ion secondary battery is solidified is approximately −20° C.; thus, it is difficult to fabricate a battery that can be charged and discharged at −40° C. Since the electrolyte solution described as an example in this embodiment has a freezing point lower than or equal to −40° C., a lithium-ion secondary battery that can be charged and discharged even in an extremely low-temperature environment such as at −40° C. can be obtained.

As the lithium salt dissolved in the solvent, a lithium salt can be used. For example, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, and lithium bis(oxalate) borate (LiBOB) can be used, or two or more of these lithium salts can be used in an appropriate combination at an appropriate ratio. The lithium salt dissolved in the solvent is preferably more than or equal to 0.5 mol/L and less than or equal to 1.5 mol/L, further preferably more than or equal to 0.7 mol/L and less than or equal to 1.3 mol/L, still further preferably more than or equal to 0.8 mol/L and less than or equal to 1.2 mol/L with respect to the volume of the solvent. A specific usage example is that LiPF₆ is preferably more than or equal to 0.5 mol/L and less than or equal to 1.5 mol/L, further preferably more than or equal to 0.7 mol/L and less than or equal to 1.3 mol/L, still further preferably more than or equal to 0.8 mol/L and less than or equal to 1.2 mol/L with respect to the volume of the solvent.

The mixed solvent is preferably highly purified and contains a small amount of dust particles and elements other than the constituent elements of the electrolyte solution (hereinafter, also simply referred to as “impurities”). Specifically, the weight ratio of impurities to the electrolyte solution is preferably less than or equal to 1%, further preferably less than or equal to 0.1%, still further preferably less than or equal to 0.01%.

In order to form a coating film (Solid Electrolyte Interphase Film) at the interface between an electrode (active material layer) and the electrolyte solution for the purpose of improvement of the safety or the like, an additive agent such as vinylene carbonate (VC), propane sultone (PS), tert-butylbenzene (TBB), fluoroethylene carbonate (FEC), lithium bis(oxalate) borate (LiBOB), or a dinitrile compound such as succinonitrile or adiponitrile may be added to the electrolyte solution. The concentration of such an additive agent in the solvent is, for example, higher than or equal to 0.1 wt % and lower than or equal to 5 wt %.

In Example 2 of electrolyte solution, the material described in Example 1 of electrolyte solution can be used for the lithium salt. Also for the additive agent, the material described in Example 1 of electrolyte solution can be used.

Although an example of the electrolyte solution that can be used for the lithium-ion secondary battery of one embodiment of the present invention is described above, the electrolyte solution that can be used for the lithium-ion secondary battery of one embodiment of the present invention should not be interpreted as being limited to the example. Another material can be used as long as it has high lithium ion conductivity even when charging and discharging are performed in a low-temperature environment.

### [Negative Electrode]

A negative electrode includes a negative electrode active material layer and a negative electrode current collector, and the negative electrode active material layer includes a negative electrode active material.

### <Binder>

As a binder of the negative electrode of one embodiment of the present invention, a polymer including a carboxy group is preferably used. It can be said that the carboxy group includes two basic oxygen atoms, one acidic hydrogen atom, and one electrophilic carbon atom. It can also be said that the carboxy group includes OH, which is a hydroxy group, and C—O, which is a carbonyl group, and is a group having a polarity. When the binder includes a group having a polarity, such as a carboxy group, interaction with a lithium ion serving as a carrier ion is expected, and lithium ions are drawn, for example; thus, insertion of lithium ions in the negative electrode active material might be aided. Note that the carboxy group can be specified by FT-IR or the like.

Examples of a polymer including a carboxy group include polyglutamic acid (sometimes referred to as PGA), poly(acrylic acid) (sometimes referred to as PAA), and alginic acid (sometimes referred to as polysaccharide). Alternatively, polyamino acid may be used as the polymer including a carboxy group; specifically, polyornithine or polysarcosine may be used for the binder. Furthermore, as a polymer including a ketone group, polyaspartic acid may be used for the binder. Alternatively, a binary copolymer (copolymer) may be used as the polymer including a ketone group; a copolymer of acrylic acid and maleic acid or a copolymer of acrylic acid and sulfonic acid may be used for the binder. Use of such materials for a binder of a negative electrode also brings an effect of reducing the amount of the binder mixed in the negative electrode.

Among the above-described polymers, polyglutamic acid or poly(acrylic acid) is particularly preferable as the binder used for the negative electrode. The structural formula of polyglutamic acid is shown below.

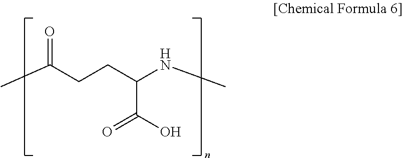

Polyglutamic acid contains nitrogen in addition to the carboxy group as is apparent from the structural formula. The nitrogen includes an unshared electron pair and thus is expected to interact with a lithium ion serving as a carrier ion. For example, the unshared electron pair possibly draws lithium ions to aid insertion of lithium ions into the negative electrode active material.

As is apparent from the structural formula, the polyglutamic acid includes C═O, which is a carbonyl group, in addition to a carbonyl group. When the binder includes a group having a polarity, such as a carbonyl group, interaction with a lithium ion serving as a carrier ion is expected, and insertion and extraction of lithium ions in the negative electrode active material might be aided.

As the polyglutamic acid, either straight-chain γ-polyglutamic acid or cross-linked γ-polyglutamic acid may be used for the binder, and these acids are collectively referred to as a structure including γ-polyglutamic acid as a main component. Note that the cross-linked γ-polyglutamic acid is more suitable for the binder because it has a net-like structure. Furthermore, the molecular weight of the polyglutamic acid is preferably greater than or equal to 1 million, further preferably greater than or equal to 3 million, still further preferably greater than or equal to 10 million and less than or equal to 50 million.

Depending on the formation method, polyglutamic acid can be referred to as γ-polyglutamic acid containing another element (e.g., Ca, Al, Na, Mg, Fe, Si, or S) as a main component. That is, polyglutamic acid may be neutralized with an alkali metal ion, for example, a lithium ion or a sodium ion.

Such polyglutamic acid has hydrophilicity and thus deionized water can be used as the solvent, which is suitable for formation of a slurry.

Next, the structural formula of poly(acrylic acid) is shown below.

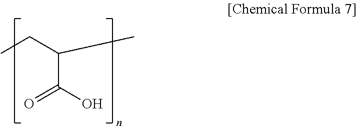

As is apparent from the structural formula, poly(acrylic acid) includes a carboxy group.

A material in which poly(acrylic acid) is cross-linked may be used. A cross-link structure, i.e., a net-like structure, can be formed, which is preferable because the function of the binder can be enhanced.

### <Negative Electrode Active Material>

The negative electrode of one embodiment of the present invention contains both a carbon particle and a silicon particle as the negative electrode active material. As the carbon particle, graphite, carbon having a layered structure like graphite, amorphous carbon, hard carbon, or a carbon fiber is used. As the carbon particle used in this specification, specifically, a graphite particle is preferably used.

The average particle diameter of graphite particles of one embodiment of the present invention is preferably greater than or equal to 1 μm, further preferably greater than or equal to 5 μm, still further preferably greater than or equal to 10 μm, yet still further preferably greater than or equal to 20 μm. The graphite particle is preferably mixed with the silicon particle to be used for the negative electrode.

The average particle diameter of graphite particles can be measured with a particle size distribution analyzer or the like using a laser diffraction and scattering method. In this specification and the like, the average particle diameter of graphite particles can be calculated as the median diameter (D50). The median diameter (D50) is a particle diameter when the accumulated amount of particles accounts for 50% of an accumulated particle amount curve which is the result of the particle size distribution measurement. The measurement of the size of a particle is not limited to laser diffraction particle size distribution measurement; the major axis of a particle cross section may be measured by analysis with a SEM, a TEM, or the like. Note that an example of a method for measuring the median diameter (D50) with a SEM, TEM, or the like includes a method for measuring 20 or more particles to make a particle size distribution curve, and setting a particle diameter when the accumulation of particles accounts for 50% as the median diameter (D50).

The specific surface area of the graphite particle is preferably greater than or equal to 0.5 m²/g and less than or equal to 3 m²/g. The specific surface area can be measured by a BET method. The specific surface area obtained by a BET method is a value measured by a nitrogen gas adsorption one-point BET method, and a micromeritics automatic surface area and porosimetry analyzer Tristar II3020 (produced by SHIMADZU CORPORATION) can be used as a measuring instrument.

As the silicon particle, it is preferable to use a silicon particle with an average particle diameter of 100 nm or in the vicinity thereof, which is referred to as a nanosilicon particle in some cases. The capacity of silicon per weight is 4200 mAh/g, which is greater than or equal to ten times the capacity of graphite, 372 mAh/g (per active material weight). In the case of using silicon, there is a problem of drastic cycle deterioration caused by expansion and contraction in charging and discharging. Thus, in order to inhibit cycle degradation, nanosilicon particles, i.e., silicon miniaturized to have the above-described average particle diameter, is suitable.

The average particle diameter of silicon particles can be measured with a particle size distribution analyzer or the like using a laser diffraction and scattering method. In this specification and the like, the average particle diameter of silicon particles can be calculated as the median diameter (D50). The median diameter (D50) is a particle diameter when the accumulated amount of particles accounts for 50% of an accumulated particle amount curve which is the result of the particle size distribution measurement. The measurement of the size of a particle is not limited to laser diffraction particle size distribution measurement; the major axis of a particle cross section may be measured by analysis with a SEM, a TEM, or the like. Note that an example of a method for measuring the median diameter (D50) with a SEM, TEM, or the like includes a method for measuring 20 or more particles to make a particle size distribution curve, and setting a particle diameter when the accumulation of particles accounts for 50% as the median diameter (D50).

In order to obtain silicon particles to be used, it is preferable that a silicon source material be ground and particle diameters be adjusted to be uniform. Through the adjustment, silicon particles with an average particle diameter of less than 1 μm can be obtained. Note that the average particle diameter is preferably less than 1 μm because the negative electrode active material layer might be thick in the case where the average particle diameter is large. The silicon particle is formed using a silicon-based material; specifically, the silicon particle contains at least one of silicon, silicon oxide, and a silicon alloy.

The specific surface area of the silicon particle is preferably greater than or equal to 10 m²/g and less than or equal to 35 m²/g, further preferably greater than or equal to 10 m²/g and less than or equal to 15 m²/g. The specific surface area can be measured by a BET method. The specific surface area obtained by a BET method is a value measured by a nitrogen gas adsorption one-point BET method, and a micromeritics automatic surface area and porosimetry analyzer Tristar II3020 (produced by SHIMADZU CORPORATION) can be used as a measuring instrument.

The negative electrode active material of one embodiment of the present invention contains both graphite particles and silicon particles, achieving a lithium-ion secondary battery with high discharge capacity. Furthermore, since the average particle diameter of graphite particles is different from the average particle diameter of silicon particles, when these particles are mixed and used for a negative electrode, the carried amount of the negative electrode active material can be increased. In this specification, the carried amount refers to the weight of a negative electrode active material per unit surface area of a negative electrode current collector. The carried amount of a negative electrode active material can be obtained in accordance with the capacity of a positive electrode. When the carried amount is small, output characteristics of the lithium-ion secondary battery can be increased but the discharge capacity is decreased. Thus, the carried amount of a negative electrode active material is preferably larger than or equal to 1.5 mg/cm².

In the negative electrode active material layer of one embodiment of the present invention, the weight ratio of graphite particles is preferably higher than the weight ratio of silicon particles; for example, the weight ratio of graphite particles is preferably greater than or equal to 5 times and less than or equal to 15 times the weight ratio of silicon particles. In other words, the silicon weight ratio in the total weight of the powder materials forming the negative electrode active material is higher than or equal to 7.5 wt % and lower than or equal to 37.5 wt %.

When the negative electrode active material layer is formed, a conductive material may be added.

In a lithium-ion secondary battery, a negative electrode active material layer can be formed on one surface or both surfaces of the negative electrode current collector. The negative electrode active material layer is completed through applying slurry onto the negative electrode current collector, drying, and the like.

Note that in this specification, the weight ratio of the raw materials may be regarded as the compounding ratio of the raw materials mixed when the slurry is formed. That is, the weight ratio of the negative electrode active material is the compounding ratio (wt %) of the negative electrode active material with respect to the total weight of the negative electrode active material and the binder in the slurry or the total weight of the negative electrode active material, the binder, and the conductive material. The weight ratio and the compounding ratio can be understood by replacing the negative electrode active material with the binder.

The weight ratio of the binder is preferably lower than the weight ratio of graphite particles. In addition, in order to obtain an effect as the binder, the weight ratio of the binder is preferably higher than 5 wt %.

### <Formation Method of Negative Electrode Active Material Layer>

Here, a method for forming the negative electrode active material layer is described. The slurry of the negative electrode of one embodiment of the present invention is preferably formed by mixing graphite particles, silicon particles, and a binder including a carboxy group, adding a solvent thereto, and mixing them. In the slurry of one embodiment of the present invention, the graphite particles, the silicon particles, and the binder including a carboxy group can be mixed at the same time, which is preferable because the process can be shortened. Furthermore, in the formation of the slurry, the graphite particles, the silicon particles, the binder including a carboxy group, and the solvent can be mixed at the same time. Moreover, in the formation of the slurry, the conductive material can also be mixed at the same time. Although a specific example of the conductive material will be described later, acetylene black (hereinafter referred to as AB) is preferably used.

The slurry obtained in this manner is applied to one surface or both surfaces of the negative electrode current collector, followed by drying and pressing, so that the negative electrode active material layer can be formed. With the use of the negative electrode active material layer of one embodiment of the present invention, a lithium-ion secondary battery with excellent cycle performance can be provided.

Note that the silicon particles are preferably prevented from being oxidized. For example, in the formation of the slurry, mixing treatment is preferably performed such that the silicon particles are not oxidized.

The contents of this embodiment can be freely combined with the contents of the other embodiments.

### Embodiment 2

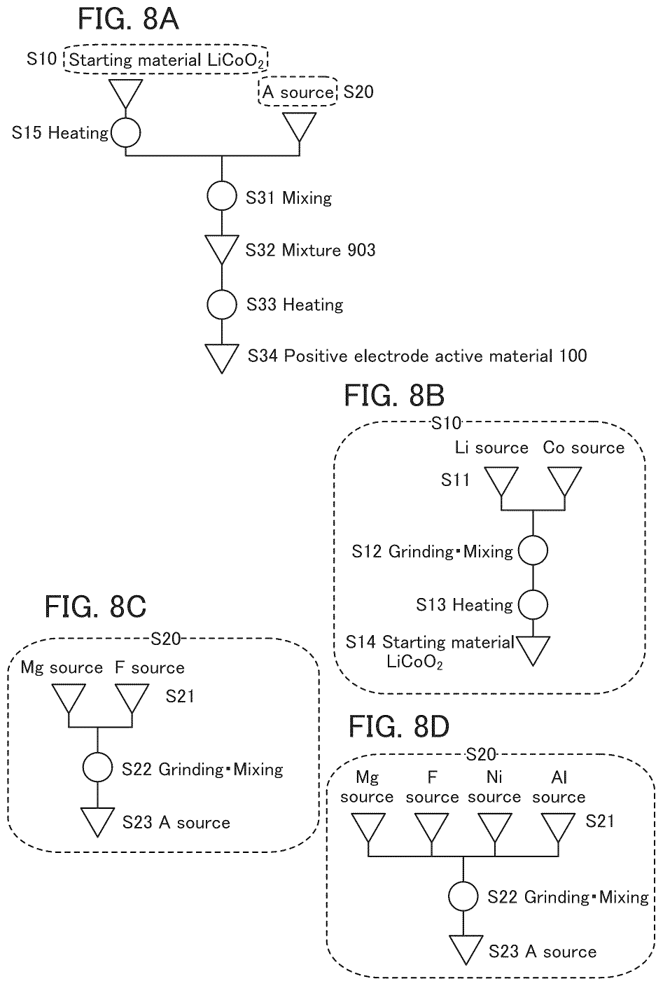

In this embodiment, a method for forming a positive electrode active material applicable to a lithium-ion secondary battery having excellent discharge characteristics even in a low-temperature environment is described with reference to FIG. 8 to FIG. 10.

### Example 1 of Method for Forming Positive Electrode Active Material

An example of a method for forming the positive electrode active material that can be used as one embodiment of the present invention (Example 1 of method for forming positive electrode active material) will be described with reference to FIG. 8A to FIG. 8D. Note that in <Example 1 of method for forming positive electrode active material>, the additive elements described as the additive elements X, Y, and Z in Embodiment 1 are collectively referred to as an additive element A.

First, lithium cobalt oxide is prepared as a starting material in Step S10. The particle diameter (strictly, median diameter (D50)) of the lithium cobalt oxide that is a starting material can be less than or equal to 12 μm (preferably less than or equal to 10 μm, further preferably less than or equal to 8 μm). As the lithium cobalt oxide with a median diameter (D50) of less than or equal to 12 μm, known or official (in short, commercially available) lithium cobalt oxide or lithium cobalt oxide formed through Step S11 to Step S14 shown FIG. 8B may be used. As a typical example of the commercially available lithium cobalt oxide with a median diameter (D50) of less than or equal to 12 μm, lithium cobalt oxide produced by NIPPON CHEMICAL INDUSTRIAL CO., LTD. (product name: CELLSEED C-5H) can be given. The lithium cobalt oxide produced by NIPPON CHEMICAL INDUSTRIAL CO., LTD. (product name: CELLSEED C-5H) has a median diameter (D50) of approximately 7 μm. A method for forming lithium cobalt oxide with a median diameter (D50) of less than or equal to 12 μm through Step S11 to Step S14 is described below.

### <Step S11>

In Step S11 shown in FIG. 8B, a lithium source (Li source) and a cobalt source (Co source) are prepared as materials for lithium and a transition metal which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

As the cobalt source, a cobalt-containing compound is preferably used, and for example, tricobalt tetraoxide, cobalt hydroxide, or the like can be used. The cobalt source preferably has a high purity and is preferably a material having a purity of higher than or equal to 3N (99.9%), further preferably higher than or equal to 4N (99.99%), still further preferably higher than or equal to 4N5 (99.995%), yet further preferably higher than or equal to 5N (99.999%), for example. Impurities of the positive electrode active material can be controlled by using such a high-purity material. As a result, a secondary battery with an increased capacity and increased reliability can be obtained.

### <Step S12>

Next, in Step S12 shown in FIG. 8B, the lithium source and the cobalt source are ground and mixed to form a mixed material. The grinding and mixing can be performed by a dry method or a wet method. To obtain lithium cobalt oxide with a median diameter (D50) of less than or equal to 10 μm as a starting material, the grinding and mixing by a wet method are preferred because a material can be crushed into a smaller size. When the grinding and mixing are performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used.

In this embodiment, dehydrated acetone with a purity higher than or equal to 99.5% is used. It is preferable that the lithium source and the transition metal source be mixed into dehydrated acetone whose moisture content is less than or equal to 10 ppm and which has a purity of higher than or equal to 99.5% in the grinding and mixing. With the use of dehydrated acetone with the above-described purity, impurities that might be mixed can be reduced.

### <Step S13>

Next, the materials mixed in the above manner are heated in Step S13 shown in FIG. 8B. The heating temperature is preferably higher than or equal to 800° C. and lower than or equal to 1100° C., further preferably higher than or equal to 900° C. and lower than or equal to 1000° C., still further preferably approximately 950° C. and lower than or equal to 1000° C. An excessively low temperature might lead to insufficient decomposition and melting of the lithium source and the transition metal source. An excessively high temperature might lead to a defect due to evaporation of lithium from the lithium source and/or excessive reduction of cobalt, for example. An oxygen vacancy or the like might be induced by a change of trivalent cobalt into divalent cobalt, for example.

When the heating time is too short, lithium cobalt oxide is not synthesized, but when the heating time is too long, the productivity is lowered. Accordingly, the heating time is preferably longer than or equal to 1 hour and shorter than or equal to 100 hours, further preferably longer than or equal to 2 hours and shorter than or equal to 20 hours, still further preferably longer than or equal to 2 hours and shorter than or equal to 10 hours.

A temperature rising rate is preferably higher than or equal to 80° C./h and lower than or equal to 250° C./h, although depending on the end-point temperature of the heating. For example, in the case of heating at 1000° C. for 10 hours, the temperature rising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. In a method, a dry air is continuously introduced into a reaction chamber. The flow rate of a dry air in this case is preferably 10 L/min. A method of continuously introducing oxygen into a reaction chamber to make oxygen flow therein is referred to as flowing.

In the case where the heating atmosphere is an oxygen-containing atmosphere, flowing is not necessarily performed. For example, the following method may be employed: the pressure in the reaction chamber is reduced, then the reaction chamber is filled with oxygen, and the oxygen is prevented from entering or exiting from the reaction chamber. Such a method is referred to as purging. For example, the pressure in the reaction chamber may be reduced to −970 hPa, and then, the reaction chamber may be filled with oxygen until the pressure becomes 50 hPa. Cooling after the heating can be performed by natural cooling, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

This heating step may be performed with a rotary kiln or a roller hearth kiln. Heating with stirring can be performed in either case of a sequential rotary kiln or a batch-type rotary kiln.

A container used at the time of the heating is preferably a crucible made of aluminum oxide or a saggar made of aluminum oxide. The crucible made of aluminum oxide has a material property that hardly allows the entry of impurities. In this embodiment, a saggar made of aluminum oxide with a purity of 99.9% is used. Note that the heating is preferably performed with the crucible or the saggar covered with a lid, in which case volatilization of a material can be prevented.

After the heating, the heated material is crushed as needed and may be made to pass through a sieve. Note that heating conditions equivalent to those in Step S13 can be employed in a later-described heating step other than Step S13.

### <Step S14>

Through the above steps, lithium cobalt oxide (LiCoO₂) can be synthesized in Step S14 in FIG. 8B. The lithium cobalt oxide (LiCoO₂) shown in Step S14 is an oxide containing a plurality of kinds of metal elements in its structure and thus can be referred to as a composite oxide. A “composite oxide” in this specification and the like refers to an oxide containing a plurality of kinds of metal elements in its structure. Note that the lithium cobalt oxide (LiCoO₂) shown in Step S14 may be obtained after adjusting particle size distribution by performing a crushing step and a classification step after Step S13.

Although the example is described in which the composite oxide is fabricated by a solid phase method as in Step S11 to Step S14, the composite oxide may be fabricated by a coprecipitation method. Alternatively, the composite oxide may be formed by a hydrothermal method.

Through Step S11 to Step S14, lithium cobalt oxide that is a starting material for a positive electrode active material applicable to a lithium-ion secondary battery having excellent discharge characteristics even in a low-temperature environment can be obtained. Specifically, as the lithium cobalt oxide that is a starting material, lithium cobalt oxide with a median diameter (D50) of less than or equal to 10 μm can be obtained.

### <Step S15>

Next, in Step S15 shown in FIG. 8A, the lithium cobalt oxide that is a starting material is heated. The heating in Step S15 is the first heating performed on the lithium cobalt oxide and thus is sometimes referred to as initial heating in this specification and the like. The heating is performed before Step S31 described below, and thus is sometimes referred to as preheating or pretreatment.

First, by the initial heating, a lithium compound or the like unintentionally remaining on a surface of lithium cobalt oxide is extracted. In addition, an effect of increasing the crystallinity of the inner portion can be expected. Although the lithium source and/or the cobalt source prepared in Step S11 and the like might contain impurities, impurities in the lithium cobalt oxide that is a starting material can be reduced by the initial heating. Note that the effect of increasing the crystallinity of the inner portion is, for example, an effect of reducing distortion, a shift, or the like derived from differential shrinkage or the like of the lithium cobalt oxide formed in Step S14.

Through the initial heating, an effect of smoothing the surface of the lithium cobalt oxide is obtained. Furthermore, through the initial heating, an effect of reducing a crack, a crystal defect, or the like included in the lithium cobalt oxide is obtained. In this specification and the like, a smooth surface refers to a state of having little unevenness and being rounded as a whole, and its corner portion is rounded. A smooth surface also refers to a surface to which few foreign matters are attached. Foreign matters are deemed to cause unevenness and are preferably not attached to a surface.

For the initial heating, a lithium compound source, an additive element A source, or a material functioning as a fusing agent is not necessarily separately prepared.

When the heating time in this step is too short, a sufficient effect is not obtained, but when the heating time in this step is too long, the productivity is lowered. For example, as an appropriate range of the heating time, any of the heating conditions described for Step S13 can be selected. The heating temperature in Step S15 is preferably lower than that in Step S13 so that the crystal structure of the composite oxide is maintained. The heating time in Step S15 is preferably shorter than that in Step S13 so that the crystal structure of the composite oxide is maintained. For example, the heating is preferably performed at higher than or equal to 700° C. and lower than or equal to 1000° C. (further preferably higher than or equal to 800° C. and lower than or equal to 900° C.) for longer than or equal to 1 hour and shorter than or equal to 20 hours (further preferably longer than or equal to 1 hour and shorter than or equal to 5 hours).

The heating in Step S13 might cause a temperature difference between the surface and an inner portion of the lithium cobalt oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the lithium cobalt oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the lithium cobalt oxide is relieved. Accordingly, the surface of the lithium cobalt oxide may become smooth. This is also rephrased as modification of the surface. In other words, Step S15 can reduce the differential shrinkage caused in the lithium cobalt oxide and make the surface of the composite oxide smooth.

Such differential shrinkage might cause a micro shift in the lithium cobalt oxide such as a shift in a crystal. To reduce this shift, Step S15 is preferably performed. Performing Step S15 can distribute a shift uniformly in the composite oxide (reduce the shift in a crystal or the like which is caused in the composite oxide or align crystal grains). As a result, the surface of the composite oxide becomes smooth.

Note that pre-synthesized lithium cobalt oxide with a median diameter (D50) of less than or equal to 12 μm, preferably less than or equal to 10 μm, further preferably less than or equal to 8 μm may be used in Step S10 as described above. In that case, Step S11 to Step S13 can be omitted. Step S15 performed on the pre-synthesized lithium cobalt oxide is a useful and preferable step because lithium cobalt oxide with a smooth surface can be obtained.

Note that Step S15 is not essential in one embodiment of the present invention; thus, an embodiment in which Step S15 is skipped is also included in one embodiment of the present invention.

### <Step S20>

Next, details of Step S20 of preparing the additive element A as the A source are described with reference to FIG. 8C and FIG. 8D.

### <Step S21>

Step S20 shown in FIG. 8C includes Step S21 to Step S23. In Step S21, the additive element A is prepared. As specific examples of the additive element A, one or more selected from magnesium, fluorine, nickel, aluminum, titanium, zirconium, vanadium, iron, manganese, chromium, niobium, arsenic, zinc, silicon, sulfur, phosphorus, and boron can be used. Alternatively, one or more selected from bromine and beryllium can be used. FIG. 8C shows an example of the case where a magnesium source (Mg source) and a fluorine source (F source) are prepared. Note that in Step S21, a lithium source may be separately prepared in addition to the additive element A.

When magnesium is selected as the additive element A, the additive element A source can be referred to as a magnesium source. As the magnesium source, magnesium fluoride (MgF₂), magnesium oxide (MgO), magnesium hydroxide (Mg(OH)₂), magnesium carbonate (MgCO₃), or the like can be used. Two or more of these magnesium sources may be used.

When fluorine is selected as the additive element A, the additive element A source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating step described later owing to its relatively low melting point of 848° C.

Magnesium fluoride can be used as both the fluorine source and the magnesium source. Lithium fluoride can also be used as the lithium source. Another example of the lithium source that can be used in Step S21 is lithium carbonate.

The fluorine source may be a gas; for example, fluorine (F₂), carbon fluoride, sulfur fluoride, oxygen fluoride (OF₂, O₂F₂, O₃F₂, O₄F₂, O₅F₂, O₆F₂, and O₂F), or the like may be used and mixed in the atmosphere in a heating step described later. Two or more of these fluorine sources may be used.

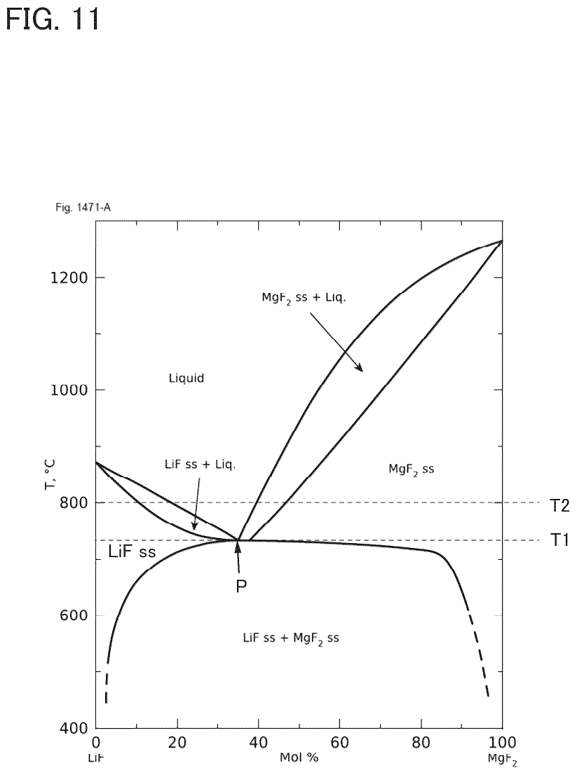

In this embodiment, lithium fluoride (LiF) is prepared as the fluorine source, and magnesium fluoride (MgF₂) is prepared as the fluorine source and the magnesium source. As will be described later, when a fluorine compound (sometimes also referred to as a fluoride) such as lithium fluoride has a lower melting point than another additive element A source, the fluorine compound or the like can serve as a fusing agent (also referred to as a flux) for lowering the melting point of the another additive element A source. In a fluorine compound containing LiF and MgF₂, the eutectic point P of LiF and MgF₂ is around 742° C. (T1) as shown in FIG. 11 (which is cited from FIG. 5 of Non-Patent Document 1 and retouched); thus, the heating temperature in the heating step (Step S33 or the like to be described later) following the mixing of the additive element is preferably set higher than or equal to 742° C.

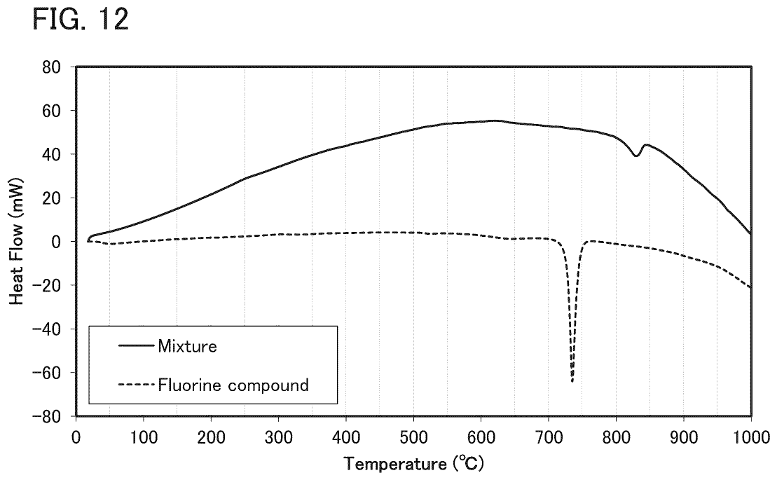

Here, the differential scanning calorimetry measurement (DSC measurement) of a fluorine compound and a mixture is described with reference to FIG. 12. The mixture in FIG. 12 is obtained by mixing lithium cobalt oxide as the lithium oxide and LiF and MgF₂ as the fluorine compound. The mixing is performed to satisfy LiCoO₂:LiF:MgF₂=100:0.33:1 (molar ratio). The fluorine compound in FIG. 12 is a mixture of LiF and MgF₂. Specifically, the mixture is obtained by performing mixing at LiF:MgF₂=1:3 (molar ratio).

As shown in FIG. 12, the endothermic peak of the fluorine compound is observed around 735° C. In addition, the endothermic peak of the mixture is observed around 830° C. Thus, the temperature of the heating (e.g., Step S33 to be described later) following the mixing of the additive element is preferably higher than or equal to 742° C., further preferably higher than or equal to 830° C. Alternatively, 800° C. (T2 in FIG. 11) or higher between these temperatures may be employed.

When lithium fluoride and magnesium fluoride are mixed such that LiF:MgF₂ is approximately 65:35 (molar ratio), the effect of lowering the melting point is maximized. When the proportion of lithium fluoride is too high, cycle performance might be degraded because of an excessive amount of lithium. Therefore, the molar ratio of lithium fluoride to magnesium fluoride is preferably LiF:MgF₂=x:1 (0≤x≤1.9), further preferably LiF:MgF₂=x:1 (0.1≤x≤0.5), still further preferably LiF:MgF₂=x:1 (x=0.33 or the neighborhood thereof). Note that in this specification and the like, the expression “an approximate value of a given value” means greater than 0.9 times and less than 1.1 times the given value, unless otherwise specified.

### <Step S22>

Next, in Step S22 shown in FIG. 8C, the magnesium source and the fluorine source are ground and mixed. Any of the conditions for the grinding and the mixing that are described for Step S12 can be selected to perform this step.

### <Step S23>

Next, in Step S23 shown in FIG. 8C, the materials ground and mixed in the above step are collected to give the additive element A source (A source). Note that the additive element A source in Step S23 contains a plurality of starting materials and can also be referred to as a mixture.

As for the particle diameter of the mixture, the median diameter (D50) is preferably greater than or equal to 100 nm and less than or equal to 10 μm, further preferably greater than or equal to 300 nm and less than or equal to 5 μm. Also when one kind of material is used as the additive element A source, the median diameter (D50) is preferably greater than or equal to 100 nm and less than or equal to 10 μm, further preferably greater than or equal to 300 nm and less than or equal to 5 μm.

A mixture pulverized in Step S22 (which may contain only one kind of the additive element) is easily attached to the surface of lithium cobalt oxide uniformly when mixed with the lithium cobalt oxide in a later step. The mixture is preferably attached uniformly to the surface of the lithium cobalt oxide, in which case the additive element is easily distributed or dispersed uniformly in the surface portion 100a of the composite oxide after heating.

### <Step S21>

A process different from that in FIG. 8C is described with reference to FIG. 8D. Step S20 shown in FIG. 8D includes Step S21 to Step S23.

In Step S21 shown in FIG. 8D, four kinds of additive element A sources to be added to the lithium cobalt oxide are prepared. In other words, FIG. 8D is different from FIG. 8C in the kinds of the additive element A sources. A lithium source may be separately prepared in addition to the additive element A sources.

As the four kinds of additive element A sources, a magnesium source (Mg source), a fluorine source (F source), a nickel source (Ni source), and an aluminum source (Al source) are prepared. The magnesium source and the fluorine source can be selected from the compounds and the like described with reference to FIG. 8C. As the nickel source, nickel oxide, nickel hydroxide, or the like can be used. As an aluminum source, aluminum oxide, aluminum hydroxide, or the like can be used.

### <Step S22> and <Step S23>

Next, Step S22 and Step S23 shown in FIG. 8D are similar to Step S22 and Step S23 shown in FIG. 8C.

### <Step S31>

Next, in Step S31 shown in FIG. 8A, the lithium cobalt oxide that has been subjected to Step S15 (initial heating) and the additive element A source (Mg source) are mixed. Here, the atomic ratio of cobalt Co in the lithium cobalt oxide that has been subjected to Step S15 to magnesium Mg contained in the additive element A is preferably Co:Mg=100:y (0.1≤y≤6), further preferably Co:Mg=100:y (0.3≤y≤3). When the additive element A is added to the lithium cobalt oxide that has been subjected to the initial heating, the additive element A can be uniformly added. Thus, the initial heating (Step S15) is preferably performed not after the addition of the additive element A but before the addition of the additive element A.

When nickel is selected as the additive element A, the mixing in Step S31 is preferably performed such that the number of nickel atoms contained in the nickel source is greater than or equal to 0.05% and less than or equal to 4% of the number of cobalt atoms contained in the lithium cobalt oxide that has been subjected to Step S15. When aluminum is selected as the additive element A, the mixing in Step S31 is preferably performed such that the number of aluminum atoms contained in the aluminum source is greater than or equal to 0.05% and less than or equal to 4% of the number of cobalt atoms contained in the lithium cobalt oxide that has been subjected to Step S15.

The condition of the mixing in Step S31 is preferably milder than that of the grinding and mixing in Step S12 not to damage the lithium cobalt oxide shape. For example, a condition with a smaller number of rotations or a shorter time than that of the mixing in Step S12 is preferable. Moreover, a dry method is regarded as a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 in FIG. 8A, the materials mixed in the above manner are collected, whereby the mixture 903 is obtained. At the time of the collection, the materials may be crushed as needed and made to pass through a sieve.

### <Step S33>

Then, in Step S33 shown in FIG. 8A, the mixture 903 is heated. The heating in Step S33 is preferably performed at higher than or equal to 800° C. and lower than or equal to 1100° C., further preferably higher than or equal to 800° C. and lower than or equal to 950° C., still further preferably higher than or equal to 850° C. and lower than or equal to 900° C. The heating time in Step S33 is longer than or equal to 1 hour and shorter than or equal to 100 hours and is preferably longer than or equal to 1 hour and shorter than or equal to 10 hours. The lower limit of the heating temperature in Step S33 needs to be higher than or equal to the temperature at which a reaction between the lithium cobalt oxide and the additive element A source proceeds. The temperature at which the reaction proceeds is the temperature at which interdiffusion of the elements included in lithium cobalt oxide and the additive element A source occurs, and may be lower than the melting temperatures of these materials. In the case where an oxide is described as an example, solid phase diffusion occurs at the temperature of 0.757 times the melting temperature Tₘ (Tammann temperature T_{d}); thus, the heating temperature in Step S33 is higher than or equal to 500° C.

Note that the reaction more easily proceeds at a temperature higher than or equal to the temperature at which one or more selected from the materials contained in the mixture 903 are melted. For example, in the case where LiF and MgF₂ are included in the additive element A source, the lower limit of the heating temperature in Step S33 is preferably higher than or equal to 742° C. because the eutectic point of LiF and MgF₂ is around 742° C. as described above.

The mixture 903 obtained by mixing at LiCoO₂:LiF:MgF₂=100:0.33:1 (molar ratio) exhibits an endothermic peak at around 830° C. in differential scanning calorimetry measurement (DSC measurement) as described above. Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of the lithium cobalt oxide (1130° C.). At around the decomposition temperature, a slight amount of lithium cobalt oxide might be decomposed. Thus, the upper limit of the heating temperature is preferably lower than or equal to 1000° C., further preferably lower than or equal to 950° C., still further preferably lower than or equal to 900° C.

In addition, at the time of heating the mixture 903, the partial pressure of fluorine or a fluoride originating from the fluorine source or the like is preferably controlled to be within an appropriate range.

In the fabrication method described in this embodiment, some of the materials, e.g., LiF as the fluorine source, function as a fusing agent in some cases. Owing to this function, the heating temperature can be lower than the decomposition temperature of the lithium cobalt oxide, e.g., a temperature higher than or equal to 742° C. and lower than or equal to 950° C., which allows distribution of the additive element such as magnesium in the surface portion and formation of the positive electrode active material having favorable characteristics.

Since LiF in a gas phase has a specific gravity less than that of oxygen, heating might volatilize or sublimate LiF and in that case, LiF in the mixture 903 decreases. In this case, the function of a fusing agent deteriorates. Therefore, heating is preferably performed while volatilization or sublimation of LiF is inhibited.

In view of this, the mixture 903 is preferably heated in an atmosphere containing LiF, i.e., the mixture 903 is preferably heated in a state where the partial pressure of LiF in a heating furnace is high. Such heating can inhibit volatilization or sublimation of LiF in the mixture 903.

The heating in this step is preferably performed such that the mixtures 903 are not adhered to each other. Adhesion of the mixtures 903 during the heating might decrease the area of contact with oxygen in the atmosphere and inhibit a path of diffusion of the added element (e.g., fluorine), thereby hindering distribution of the added element (e.g., magnesium and fluorine) in the surface portion.

Uniform distribution of the additive element (e.g., fluorine) in the surface portion leads to a smooth positive electrode active material with little unevenness. Thus, it is preferable that the mixtures 903 not be adhered to each other in order to allow the surface obtained through the heating in Step S15 to be kept smooth or to be smoother in this step.

In the case of using a roller hearth kiln for the heating, the mixture 903 can be heated in an atmosphere containing LiF with the container containing the mixture 903 covered with a lid, for example.

### <Step S34>

Next, the heated material is collected in Step S34 shown in FIG. 8A to obtain the positive electrode active material 100. Here, the collected positive electrode active material 100 may be crushed as need or is preferably made to pass through a sieve. Through the above process, the positive electrode active material 100 (composite oxide) with a median diameter (D50) of less than or equal to 12 μm (preferably less than or equal to 10 μm, further preferably less than or equal to 8 μm) can be formed. Note that the positive electrode active material 100 contains the additive element A.

### Example 2 of Method for Forming Positive Electrode Active Material

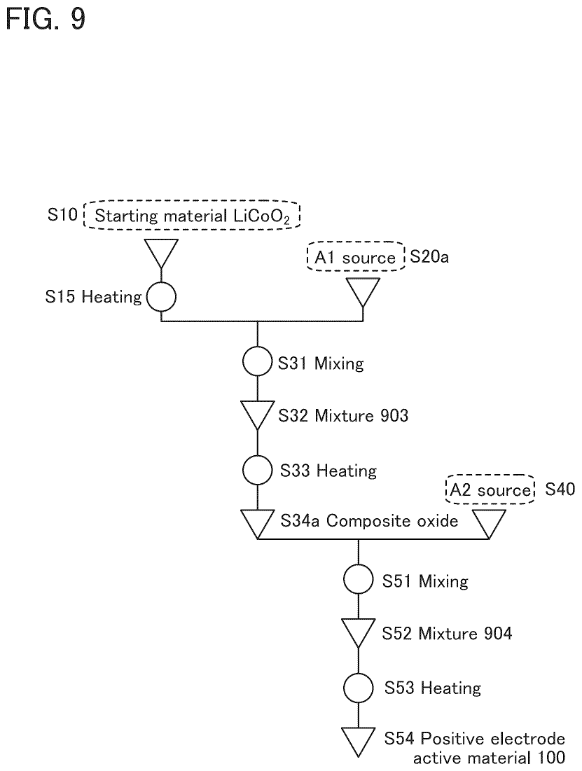

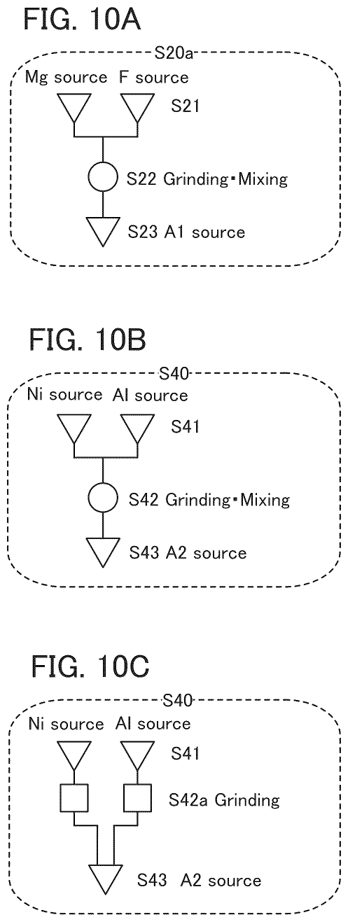

Another example of a method for forming the positive electrode active material that can be used as one embodiment of the present invention (Example 2 of method for forming positive electrode active material) is described with reference to FIG. 9 and FIG. 10. Example 2 of method for forming positive electrode active material is different from Example 1 of method for forming positive electrode active material described above in the number of times of adding the additive element and a mixing method, and for the description except for the above, the description of Example 1 of method for forming positive electrode active material can be referred to. Note that in <Example 2 of method for forming positive electrode active material>, the additive element X described in Embodiment 1 is referred to as an additive element A1. In addition, the additive element Y and the additive element Z described in Embodiment 1 are collectively referred to as an additive element A2.

Step S10 to Step S15 in FIG. 9 are performed as in FIG. 8A to prepare lithium cobalt oxide that has been subjected to the initial heating. Note that Step S15 is not essential in one embodiment of the present invention; thus, an embodiment in which Step S15 is skipped is also included in one embodiment of the present invention.

### <Step S20a>

Next, as shown in Step S20a, a first additive element A1 source (A1 source) is prepared. Step S20a is described in detail with reference to FIG. 10A.

### <Step S21>

In Step S21 shown in FIG. 10A, the first additive element A1 source (A1 source) is prepared. The A1 source can be selected from the additive elements A described for Step S21 shown in FIG. 8C to be used. For example, one or more selected from magnesium, fluorine, and calcium can be used as the additive element A1. FIG. 10A shows an example of the case where a magnesium source (Mg source) and a fluorine source (F source) are used as the additive element A1.

Step S21 to Step S23 shown in FIG. 10A can be performed under the same conditions as those of Step S21 to Step S23 shown in FIG. 8C. As a result, the additive element A1 source (A1 source) can be obtained in Step S23.

Steps S31 to S33 shown in FIG. 9 can be performed under the same conditions as those of Steps S31 to S33 shown in FIG. 8A.

### <Step S34a>

Next, the material heated in Step S33 is collected to obtain lithium cobalt oxide containing the additive element A1. Here, the composite oxide is called a second composite oxide to be distinguished from the lithium cobalt oxide that has been subjected to Step S15 (first composite oxide).

### <Step S40>

In Step S40 shown in FIG. 9, a second additive element A2 source (42 source) is prepared.

Step S40 is described with reference to FIG. 10B and FIG. 10C.

### <Step S41>

In Step S40 shown in FIG. 10B, the second additive element A2 source (A2 source) is prepared. The A2 source can be selected from the additive elements A described for Step S20 shown in FIG. 8C to be used. For example, one or more selected from nickel, titanium, boron, zirconium, and aluminum can be suitably used as the additive element A2. FIG. 10B shows an example of the case where a nickel source and an aluminum source are used as the additive element A2.

Step S41 to Step S43 shown in FIG. 10B can be performed under the conditions similar to those of Step S21 to Step S23 shown in FIG. 8C. As a result, the additive element A2 source (A2 source) can be obtained in Step S43.

FIG. 10C showing Step S41 to Step S43 is a variation example of FIG. 10B. A nickel source (Ni source) and an aluminum source (Al source) are prepared in Step S41 shown in FIG. 10C and are separately ground in Step S42a. Accordingly, a plurality of the second additive element A2 sources (42 sources) are prepared in Step S43. As described above, Step S40 in FIG. 10C is different from Step S40 in FIG. 10B in that the additive element sources are separately ground in Step S42a.

### <Step S51 to Step S53>

Next, Step S51 to Step S53 shown in FIG. 9 can be performed under the conditions similar to those in Step S31 to Step S34 shown in FIG. 8A. The heating in Step S53 is preferably performed at a lower temperature and/or for a shorter time than the heating in Step S33 shown in FIG. 9. Specifically, the heating temperature is preferably higher than or equal to 800° C. and lower than or equal to 950° C., further preferably at higher than or equal to 820° C. and lower than or equal to 870° C., still further preferably at 850° C.±10° C. The heating time is preferably longer than or equal to 0.5 hours and shorter than or equal to 8 hours, further preferably longer than or equal to 1 hour and shorter than or equal to 5 hours.

When nickel is selected as the additive element A2, the mixing in Step S51 is preferably performed such that the number of nickel atoms contained in the nickel source is greater than or equal to 0.05% and less than or equal to 4% of the number of cobalt atoms contained in the lithium cobalt oxide that has been subjected to Step S15. When aluminum is selected as the additive element A2, the mixing in Step S51 is preferably performed such that the number of aluminum atoms contained in the aluminum source is greater than or equal to 0.05% and less than or equal to 4% of the number of cobalt atoms contained in the lithium cobalt oxide that has been subjected to Step S15.

### <Step S54>

Next, the heated material is collected in Step S54 shown in FIG. 9 to obtain the positive electrode active material 100. The collected material may be crushed as needed. Through the above process, the positive electrode active material 100 (composite oxide) with a median diameter (D50) of less than or equal to 12 μm (preferably less than or equal to 10 μm, further preferably less than or equal to 8 μm) can be formed. Alternatively, the positive electrode active material 100 applicable to a lithium-ion secondary battery having excellent discharge characteristics even in a low-temperature environment can be formed. Note that the positive electrode active material 100 contains the additive element A1 and the additive element A2 .

In the example 2 of a formation method described above, as shown in FIG. 9 and FIG. 10, introduction of the additive element to the lithium cobalt oxide is divided into introduction of the first additive element A1 and that of the second additive element A2. When the elements are separately introduced, the additive elements can have different profiles. For example, the first additive element can have a profile such that the concentration is higher in the surface portion than in the inner portion, and the second additive element can have a profile such that the concentration is higher in the inner portion than in the surface portion. The positive electrode active material 100 formed through the steps in FIG. 8A and FIG. 8D has an advantage of being formed at low cost since a plurality of kinds of additive element A sources are added at the same time. Meanwhile, although the formation cost of the positive electrode active material 100 formed through FIG. 9 and FIG. 10 is relatively high since a plurality of kinds of additive element A sources are added in a plurality of steps, a profile of each of the additive element A sources in the depth direction can be more accurately controlled, which is preferable.

The contents of this embodiment can be freely combined with the contents of the other embodiments.

### Embodiment 3

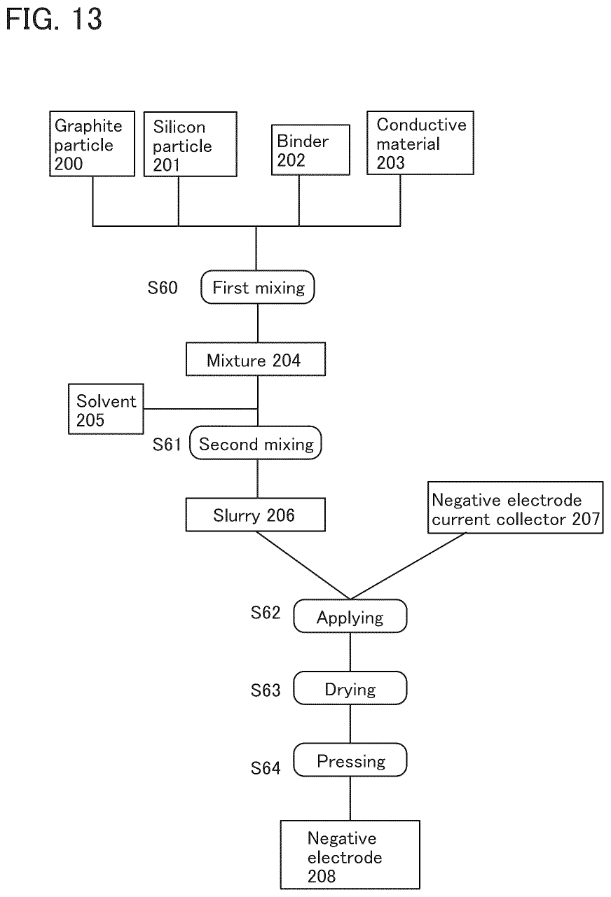

In this embodiment, an example of a formation flow of a negative electrode active material layer used for a lithium-ion secondary battery is described with reference to FIG. 13.

First, a graphite particle 200, a silicon particle 201, a binder 202, and a conductive material 203 are prepared. As the binder, a polymer including a carboxy group is used.

### <Step S60>

The above-described raw materials are weighed, and first mixing in Step S60 in FIG. 13 is performed. Specifically, the weight ratio of the silicon particle 201 in the total weight of powders mixed in the first mixing is greater than or equal to 7.5 wt % and less than or equal to 37.5 wt %, and the weight ratio of the binder 202 in the total weight is greater than or equal to 10 wt % and less than or equal to 50 wt %. Furthermore, the weight ratio of the conductive material 203 in the total weight is greater than or equal to 0 wt % and less than or equal to 20 wt %. Note that AB is preferably used as the conductive material 203 that satisfies the above weight ratio.

For example, the silicon particle 201, the graphite particle 200, the binder 202, and the conductive material 203 are weighed such that the weight ratio is 3:5:1:1. Alternatively, for example, the conductive material is not used and the silicon particle 201, the graphite particle 200, and the binder 202 are weighed such that the weight ratio is 3:5:1. The graphite particle 200, the silicon particle 201, and the binder 202 may be weighed such that the weight ratio is 9:1:1.

### <Mixing of Mixture 204 and Solvent 205>

In one embodiment of the present invention, since all the raw materials are powders in Step S60, mixing is performed before the solvent is added, whereby a mixture 204 is obtained. When the powders are mixed with each other, they can be uniformly mixed. After that, a solvent 205 is preferably added. Deionized water is preferably used as the solvent 205.

### <Step S61>

After the solvent 205 is added, second mixing in Step S61 in FIG. 13 is performed to form a slurry 206. The second mixing may also be referred to as slurry preparation.

The slurry 206 refers to a material solution that is used to form an active material layer over the current collector, and includes at least an active material, a binder, and a solvent and may further include a conductive material. The slurry may also be referred to as a slurry for an electrode or an active material slurry.

Then, in Step S62 in FIG. 13, the slurry 206 is applied onto a negative electrode current collector 207. After that, drying is performed in Step S63 in FIG. 13. As for the drying condition, pre-drying and main drying may be performed. That is, the drying step is performed twice, and the conditions of the earlier drying step are milder. For example, drying can be performed with a drying machine at higher than or equal to 40° C. and lower than or equal to 60° C. for longer than or equal to 10 minutes and shorter than or equal to an hour, which can be pre-drying. Then, as the main drying, drying can be performed with a drying machine at higher than 60° C. and lower than or equal to 90° C. for longer than or equal to 30 minutes and shorter than or equal to 1.5 hours. Pressing may be performed at the same time as drying.

After the drying, pressing is performed in Step S64 in FIG. 13. Although a roller press machine can be used in the pressing, the temperatures of rollers positioned vertically can be higher than or equal to 100° C. and lower than or equal to 150° C. That is, heating may be performed at the same time as the pressing. The linear pressure during the pressing is preferably higher than or equal to 0.3 MPa and lower than or equal to 1 MPa. Needless to say, the lithium-ion secondary battery can operate even when the pressing is omitted.

Through the above-described steps, a negative electrode 208 in which the negative electrode active material layer is provided over the negative electrode current collector 207 can be formed.

A lithium-ion secondary battery including the negative electrode 208 obtained in this manner has high discharge capacity and shows excellent cycle performance.

### <Bonding to Separator>

In assembly of a lithium-ion secondary battery, the negative electrode 208 described in this embodiment is bonded to a separator; at this time, a solvent such as deionized water is preferably dripped onto the negative electrode 208 or the separator so that the adhesiveness of the binder, specifically the adhesiveness of PGA, is exhibited at the bonding surface.

### <Semi-Solid-State Battery>

The negative electrode 208 described in this embodiment is expected to be also applied to a semi-solid-state battery. For example, when a mixed solvent used for the electrolyte solution is gelled with a gelling agent or the like, a semi-solid-state battery including the binder of one embodiment of the present invention, specifically PGA, can be obtained.

The contents of this embodiment can be freely combined with the contents of the other embodiments.

### Embodiment 4

In this embodiment, components included in a lithium-ion secondary battery are described.

### [Positive Electrode]

A positive electrode includes a positive electrode active material layer and a positive electrode current collector. The positive electrode active material layer includes a positive electrode active material and may further include at least one of a conductive material and a binder. As the positive electrode active material, any of the positive electrode active materials described in Embodiment 1 can be used.

### <Positive Electrode Current Collector>

Metal foil can be used as the positive electrode current collector, for example. The positive electrode can be formed by applying slurry onto the metal foil and drying the slurry. Note that pressing may be performed after drying. The positive electrode is a component obtained by forming an active material layer over the positive electrode current collector 21.

As the current collector, a material that has high conductivity, such as a metal like stainless steel, gold, platinum, aluminum, or titanium, or an alloy thereof, can be used. It is preferable that a material used for the positive electrode current collector not be eluted at the potential of the positive electrode. Alternatively, it is possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer includes a negative electrode active material and may further include a conductive material and a binder.

### <Negative Electrode Active Material>

As the negative electrode active material, for example, an alloy-based material or a carbon material can be used.

As the negative electrode active material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon, and especially, silicon has a high theoretical capacity per weight of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium and a compound containing the element, for example, are referred to as alloy-based materials in some cases.

In this specification and the like, “SiO” refers, for example, to silicon monoxide. SiO can alternatively be expressed as SiOₓ. Here, it is preferable that x be 1 or have an approximate value of 1. For example, x is preferably greater than or equal to 0.2 and less than or equal to 1.5, or preferably greater than or equal to 0.3 and less than or equal to 1.2.

As the carbon material, graphite, graphitizing carbon (soft carbon), non-graphitizing carbon (hard carbon), carbon fiber (carbon nanotube), graphene, carbon black, or the like is used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of lithium metal (higher than or equal to 0.05 V and lower than or equal to 0.3 V vs. Li/Li⁺ when lithium ions are inserted into graphite (while a lithium-graphite intercalation compound is formed). For this reason, a lithium-ion secondary battery using graphite can have a high operating voltage. In addition, graphite is preferred because of its advantages such as a relatively high capacity per unit volume, relatively small volume expansion, low cost, and a higher level of safety than that of lithium metal.

As the negative electrode active material, an oxide such as titanium dioxide (TiO₂), lithium titanium oxide (Li₄TisO₁₂), a lithium-graphite intercalation compound (LixC₆), niobium pentoxide (Nb₂O₅), tungsten dioxide (WO₂), or molybdenum dioxide (MoO₂) can be used.

Alternatively, as the negative electrode active material, Li₃₋ₓMₓN (M=Co, Ni, or Cu) with a Li₃N structure, which is a nitride of lithium and a transition metal, can be used. For example, Li_{2.6}Co_{0.4}N is preferable because of its high discharge capacity (900 mAh/g and 1890 mAh/cm³ per weight).

A nitride of lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the nitride of lithium and a transition metal can be used as the negative electrode active material by extracting the lithium ions contained in the positive electrode active material in advance.

A material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

### <Negative Electrode Current Collector>

For the negative electrode current collector, copper or the like can be used in addition to a material similar to that of the positive electrode current collector. Note that a metal that is alloyed with lithium ions, such as aluminum, cannot be used for the negative electrode current collector.

### <Binder (Binding Agent)>

The positive electrode and the negative electrode each include a binder. The binder having a unique effect and being used for the negative electrode is as described in Embodiments 1 to 3. Needless to say, the binder having a unique effect may be used for the positive electrode.

For a binder other than the binders described in Embodiments 1 to 3, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

Alternatively, for the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

In addition to the binder, a thickener is preferably used in some cases. For the thickener, for example, a water-soluble polymer is preferably used. As the water-soluble polymer, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used.

Note that the above-described binder may be a comparative example of the binder having a unique effect described in Embodiments 1 to 3.

In the case where the binder covers the active material surface or the binder in contact with the surface forms a film, the film is expected to be able to serve as a passivation film to inhibit the decomposition of the electrolyte solution. Here, the “passivation film” refers to a film without electrical conductivity or a film with extremely low electrical conductivity, and can inhibit the decomposition of the electrolyte solution at a potential at which a battery reaction occurs when the passivation film is formed on the active material surface, for example. It is further desirable that the passivation film can conduct lithium ions while inhibiting electrical conduction.

### <Conductive Material>

The conductive material used for the positive electrode and the negative electrode is also referred to as a conductivity-imparting agent and a conductive material, and a carbon material is used. A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

For example, one kind or two or more kinds of carbon black such as acetylene black (AB) and furnace black, graphite such as artificial graphite and natural graphite, carbon fiber such as carbon nanofiber and carbon nanotube, graphene, and a graphene compound can be used as the conductive material.

The contact between AB and another active material or the like hardly becomes surface contact and tends to be point contact. Thus, in the case where the active material and AB are mixed, it is probable that a large amount of AB is used to reduce contact resistance; however, the discharge capacity of the secondary battery is decreased because the proportion of the active material is reduced. Moreover, AB is a material that easily aggregates, and a slurry is preferably formed using a dispersant or the like such that AB is uniformly dispersed.

In view of the above, in the negative electrode, the weight ratio of AB is preferably lower than or equal to the weight ratio of silicon particles used for the negative electrode active material. In other words, when the weight ratio is satisfied, AB can be mixed to exhibit high dispersibility, and the proportion of silicon particles is not reduced. Therefore, the discharge capacity of the secondary battery can be increased.

As the carbon fiber, carbon fiber such as mesophase pitch-based carbon fiber or isotropic pitch-based carbon fiber can be used, for example. As the carbon fiber, carbon nanofiber, carbon nanotube, or the like can also be used. Carbon nanotube can be fabricated by, for example, a vapor deposition method. As the carbon fiber, VGCF (registered trademark) may be used.

The above-described graphene includes graphene, multilayer graphene, multi graphene, and the like. The above-described graphene compound includes graphene oxide, multilayer graphene oxide, multi graphene oxide, reduced graphene oxide, reduced multilayer graphene oxide, reduced multi graphene oxide, graphene quantum dots, and the like. The graphene contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. The graphene preferably has hardness and a bent shape. The graphene compound may have a hole in a carbon ring, a ring larger than a six-membered ring, or a functional group. The graphene compound is soft and may be rounded like carbon nanofiber, for example.

Graphene or a graphene compound is capable of making surface contact with an active material or the like; thus, the amount of graphene or a graphene compound can be smaller than that of a normal conductive material. This can increase the proportion of the active material in the active material layer. Thus, discharge capacity of the secondary battery can be increased.

The contact between the carbon fiber and the active material or the like is surface contact and the major axis of the carbon fiber is longer than the minor axis thereof; thus, the carbon fiber can function as an appropriate electrical path between the isolated active materials or the like. Accordingly, the amount of the carbon fiber can be smaller than that of a normal conductive material. This can increase the proportion of the active material in the active material layer. Thus, discharge capacity of the secondary battery can be increased.

### [Electrolyte Solution]

The positive electrode and the negative electrode each include an electrolyte solution. As the electrolyte solution, any of the electrolyte solutions described in Embodiment 1 can be used.

### [Separator]

The separator is placed between the positive electrode and the negative electrode. As the separator, for example, a fiber containing cellulose such as paper; nonwoven fabric; a glass fiber; ceramics; a synthetic fiber using nylon (polyamide), vinylon (polyvinyl alcohol-based fiber), polyester, acrylic, polyolefin, or polyurethane; or the like can be used. The separator is preferably processed into a bag-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, degradation of the separator during high-voltage charging and discharging can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, heat resistance can be improved to improve the safety of the secondary battery.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Exterior Body]

For an exterior body included in the secondary battery, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

### Embodiment 5

In this embodiment, examples of a shape of a secondary battery capable of including the above-described positive electrode active material of one embodiment of the present invention will be described.

### [Coin-Type Secondary Battery]

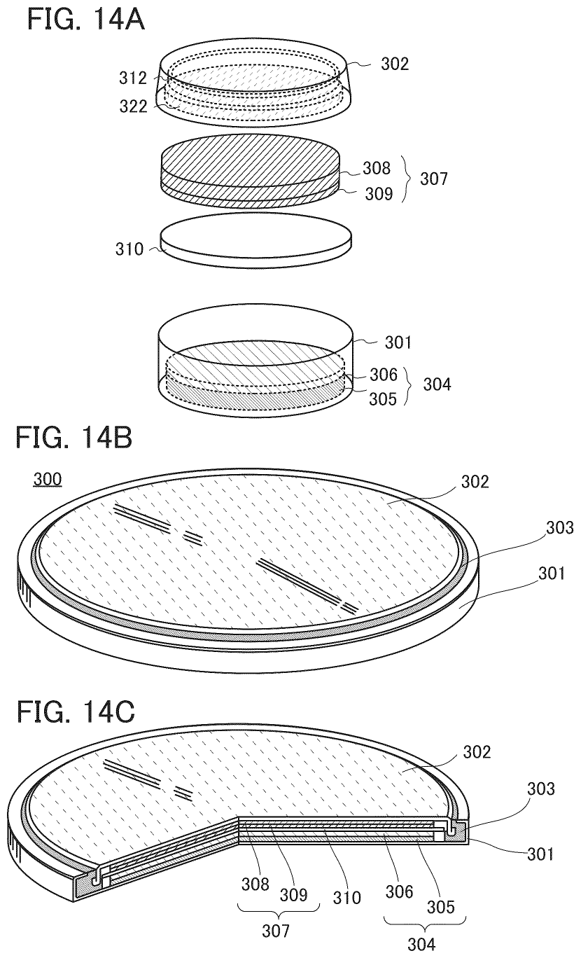

An example of a coin-type secondary battery is described. FIG. 14A is an exploded perspective view of a coin-type (single-layer flat type) secondary battery, FIG. 14B is an external view, and FIG. 14C is a cross-sectional view thereof. Coin-type secondary batteries are mainly used in small electronic devices.

Note that, for easy understanding, FIG. 14A is a schematic view illustrating overlap (a vertical relation and a positional relation) between components. Thus, FIG. 14A and FIG. 14B do not completely correspond with each other.

In FIG. 14A, a positive electrode 304, a separator 310, a negative electrode 307, a spacer 322, and a washer 312 are overlaid. They are sealed with a negative electrode can 302, a positive electrode can 301, and a gasket. Note that a gasket for sealing is not illustrated in FIG. 14A. The spacer 322 and the washer 312 are used to protect the inside or fix the position inside the cans at the time when the positive electrode can 301 and the negative electrode can 302 are bonded with pressure. For the spacer 322, stainless steel or an insulating material is used. A conductive material is used for the washer 312.

The positive electrode 304 has a stacked-layer structure in which a positive electrode active material layer 306 is formed over a positive electrode current collector 305.

FIG. 14B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution or the like. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 14C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is manufactured.

When the above-described negative electrode, positive electrode, electrolyte solution, and the like employ the structures described in the above embodiments, a coin-type secondary battery with excellent discharge capacity even in a low-temperature environment can be obtained.

### [Cylindrical Secondary Battery]

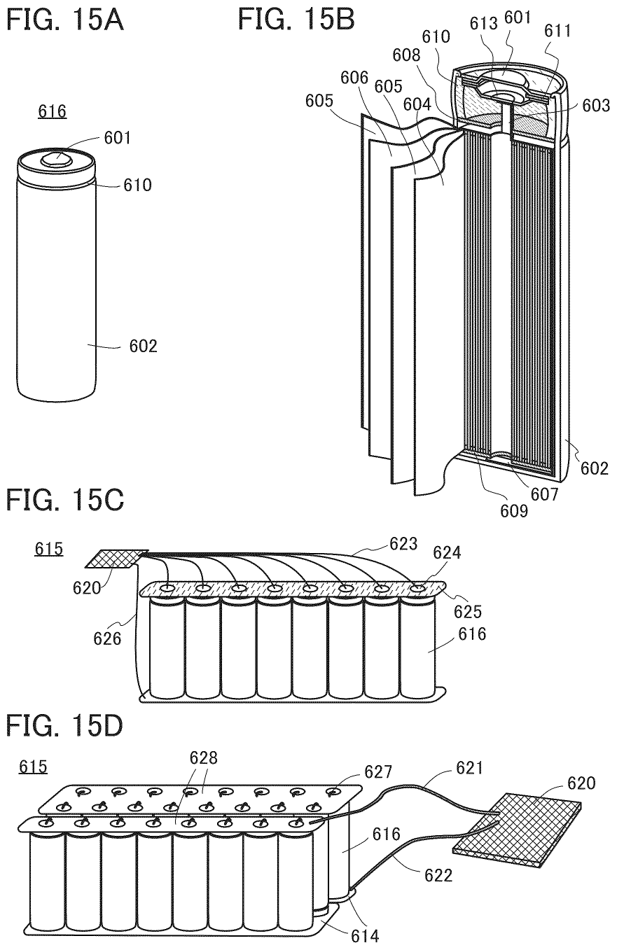

An example of a cylindrical secondary battery is described with reference to FIG. 15A. As illustrated in FIG. 15A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 15B is a diagram schematically illustrating a cross-section of the cylindrical secondary battery. The cylindrical secondary battery illustrated in FIG. 15B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a separator 605 interposed therebetween is provided. Although not illustrated, the battery element is wound around a central axis. One end of the battery can 602 is closed and the other end thereof is opened. For the battery can 602, a metal having corrosion resistance to an electrolyte solution, such as nickel, aluminum, or titanium, an alloy of such a metal, and an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is interposed between a pair of insulating plates 608 and 609 that face each other. The inside of the battery can 602 provided with the battery element is filled with an electrolyte solution (not shown). As the electrolyte solution, an electrolyte solution similar to that for the coin-type secondary battery can be used.

Since a positive electrode and a negative electrode that are used for a cylindrical storage battery are wound, active materials are preferably formed on both surfaces of a current collector.

When the above-described negative electrode, positive electrode, electrolyte solution, and the like employ the structures described in the above embodiments, a cylindrical secondary battery with excellent discharge capacity even in a low-temperature environment can be obtained.

A positive electrode terminal (positive electrode current collecting lead) 603 is connected to the positive electrode 604, and a negative electrode terminal (negative electrode current collecting lead) 607 is connected to the negative electrode 606. The positive electrode terminal 603 can be formed using a metal material such as aluminum. The negative electrode terminal 607 can be formed using a metal material such as copper. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC (Positive Temperature Coefficient) element 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 15C illustrates an example of a power storage system 615. The power storage system 615 includes a plurality of the secondary batteries 616. The positive electrodes of the secondary batteries are in contact with and electrically connected to conductors 624 isolated by an insulator 625. The conductors 624 are electrically connected to a control circuit 620 through wirings 623. The negative electrodes of the secondary batteries are electrically connected to the control circuit 620 through a wiring 626. As the control circuit 620, a charging and discharging control circuit for performing charging, discharging, and the like or a protection circuit for preventing overcharging and/or overdischarging can be used.

FIG. 15D illustrates an example of the power storage system 615. The power storage system 615 includes the plurality of secondary batteries 616, and the plurality of secondary batteries 616 are interposed between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 15D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### [Other Structure Examples of Secondary Battery]

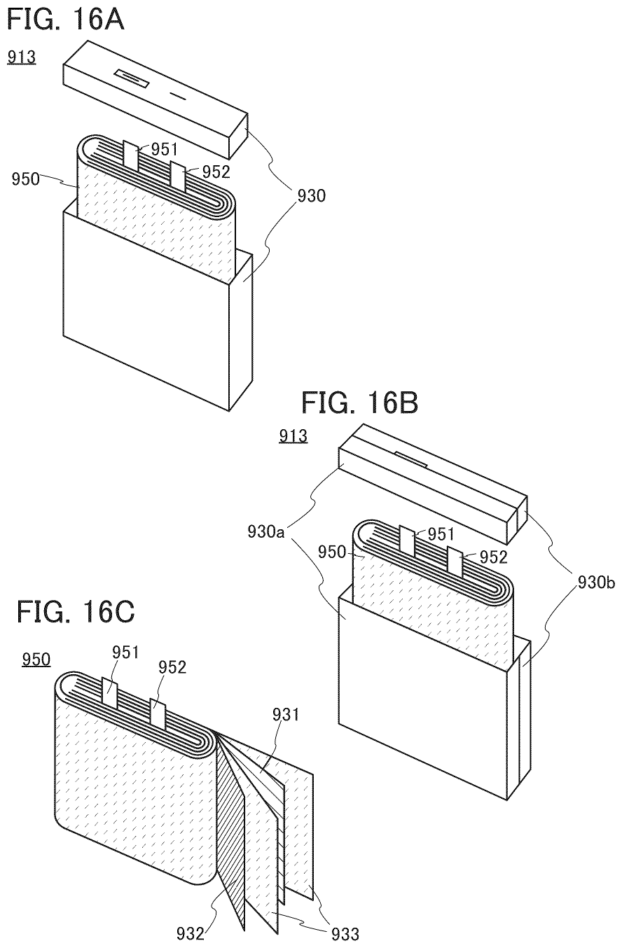

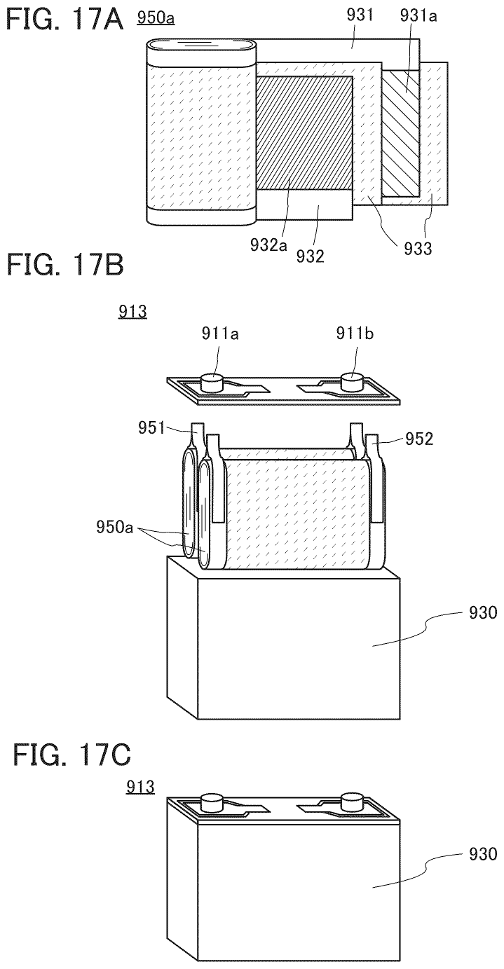

Structure examples of secondary batteries are described with reference to FIG. 16 and FIG. 17.

The secondary battery 913 illustrated in FIG. 16A includes a wound body 950 provided with the terminal 951 and the terminal 952 inside a housing 930. The wound body 950 is immersed in an electrolyte solution inside the housing 930. The terminal 952 is in contact with the housing 930. The use of an insulating material or the like inhibits contact between the terminal 951 and the housing 930. Note that in FIG. 16A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) can be used or a resin material can be used in addition to the metal material, in consideration of the gas permeability. A resin material may be used for a seal portion of the housing 930.

Note that as illustrated in FIG. 16B, the housing 930 illustrated in FIG. 16A may be formed using a plurality of materials. For example, in the secondary battery 913 illustrated in FIG. 16B, a housing 930a and a housing 930b are attached to each other, and the wound body 950 is provided in a region surrounded by the housing 930a and the housing 930b.

For the housing 930a, a metal material (e.g., aluminum) can be used or an organic resin can be used in addition to the metal material, in consideration of the gas permeability. For the housing 930b, a metal material (e.g., aluminum) can be used or an organic resin can be used in addition to the metal material, in consideration of the gas permeability.

FIG. 16C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

As illustrated in FIG. 17, the secondary battery 913 may include a wound body 950a. The wound body 950a illustrated in FIG. 17A includes the negative electrode 931, the positive electrode 932, and the separators 933. The negative electrode 931 includes a negative electrode active material layer 931a. The positive electrode 932 includes a positive electrode active material layer 932a.

When the above-described negative electrode, positive electrode, electrolyte solution, and the like employ the structures described in the above embodiments, a secondary battery with excellent discharge capacity even in a low-temperature environment can be obtained.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 17B, the negative electrode 931 is electrically connected to the terminal 951 by ultrasonic bonding, welding, or pressure bonding. The terminal 951 is electrically connected to a terminal 911a. The positive electrode 932 is electrically connected to the terminal 952 by ultrasonic bonding, welding, or pressure bonding. The terminal 952 is electrically connected to a terminal 911b.

As illustrated in FIG. 17C, the wound body 950a and an electrolyte solution are covered with the housing 930, whereby the secondary battery 913 is completed. The housing 930 is preferably provided with a safety valve, an overcurrent protection element, and the like. The safety valve is a valve to be released by a predetermined internal pressure of the housing 930 in order to prevent the battery from exploding.

As illustrated in FIG. 17B, the secondary battery 913 may include a plurality of wound bodies 950a. The use of the plurality of wound bodies 950a enables the secondary battery 913 to have higher discharge capacity. The description of the secondary battery 913 illustrated in FIG. 16A to FIG. 16C can be referred to for the other components of the secondary battery 913 illustrated in FIG. 17A and FIG. 17B.

### <Laminated Secondary Battery>

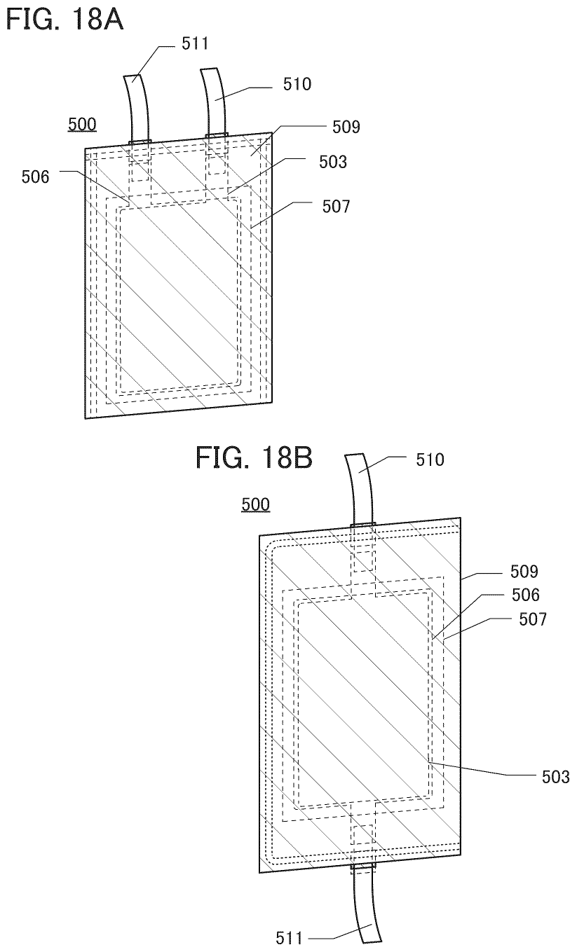

Next, examples of the appearance of a laminated secondary battery are illustrated in FIG. 18A and FIG. 18B. FIG. 18A and FIG. 18B each include a positive electrode 503, a negative electrode 506, a separator 507, an exterior body 509, a positive electrode lead electrode 510, and a negative electrode lead electrode 511.

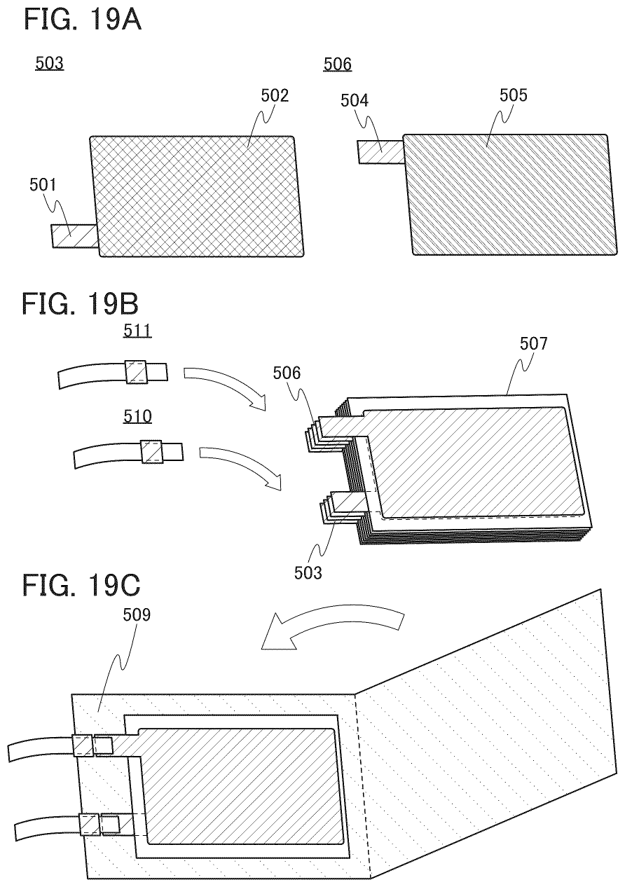

FIG. 19A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas or the shapes of the tab regions included in the positive electrode and the negative electrode are not limited to the examples illustrated in FIG. 19A.

When the above-described negative electrode, positive electrode, electrolyte solution, and the like employ the structures described in the above embodiments, a laminated secondary battery with excellent discharge capacity even in a low-temperature environment can be obtained.

### <Method for Fabricating Laminated Secondary Battery>

An example of a method for fabricating the laminated secondary battery whose external view is shown in FIG. 18A will be described with reference to FIG. 19B and FIG. 19C.

First, the negative electrode 506, the separator 507, and the positive electrode 503 are stacked. FIG. 19B illustrates the negative electrodes 506, the separators 507, and the positive electrodes 503 that are stacked. Here, an example in which five negative electrodes and four positive electrodes are used is illustrated. The component can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding is performed by ultrasonic welding, for example. In a similar manner, the tab regions of the negative electrodes 506 are bonded to each other, and the negative electrode lead electrode 511 is bonded to the tab region of the negative electrode on the outermost surface.

After that, the negative electrodes 506, the separators 507, and the positive electrodes 503 are placed over the exterior body 509.

Subsequently, the exterior body 509 is folded along a portion shown by a dashed line, as illustrated in FIG. 19C. Then, the outer edges of the exterior body 509 are bonded to each other. The bonding is performed by thermocompression bonding, for example. At this time, an unbonded region (hereinafter referred to as an inlet) is provided for part (or one side) of the exterior body 509 so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is bonded. In this manner, the laminated secondary battery 500 can be fabricated.

### Embodiment 6

In this embodiment, examples of vehicles each including the secondary battery of one embodiment of the present invention will be described.

A secondary battery can be used in vehicles, typically automobiles. Examples of the automobiles include next-generation clean energy vehicles such as hybrid vehicles (HVs), electric vehicles (EVs), and plug-in hybrid vehicles (also referred to as PHEVs or PHVs), and the secondary battery can be used as one of the power sources provided for the automobiles. The vehicle is not limited to an automobile. Examples of vehicles include a train, a monorail train, a ship, a submarine (a deep-submergence vehicle and an unmanned submarine), a flying object (a helicopter, an unmanned aircraft (a drone), an airplane, a rocket, and artificial satellite), an electric bicycle, and an electric motorcycle, and the secondary battery of one embodiment of the present invention can be used for the vehicles.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 only needs high output and high capacity is not so much needed; the capacity of the second battery 1311 is lower than that of the first batteries 1301a and 1301b.

The internal structure of the first battery 1301a may be the wound structure illustrated in FIG. 16C or FIG. 17A or the stacked-layer structure illustrated in FIG. 18A or FIG. 18B. Alternatively, an all-solid-state battery in Embodiment 6 may be used as the first battery 1301a. The use of the all-solid-state battery in Embodiment 6 as the first battery 1301a can achieve high capacity, improvement in safety, and reduction in size and weight.

Although this embodiment describes an example where the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

In order to cut off electric power from the plurality of secondary batteries, the secondary batteries in the vehicle include a service plug or a circuit breaker that can cut off high voltage without the use of equipment. The first battery 1301a is provided with such a service plug or a circuit breaker.

Electric power from the first batteries 1301a and 1301b is mainly used to rotate the motor 1304 and is supplied to in-vehicle parts for 42 V (such as an electric power steering 1307, a heater 1308, and a defogger 1309) through a DCDC circuit 1306. Even in the case where there is a rear motor 1317 for rear wheels, the first battery 1301a is used to rotate the rear motor 1317.

The second battery 1311 supplies electric power to in-vehicle parts for 14 V (such as a stereo 1313, a power window 1314, and lamps 1315) through a DCDC circuit 1310.

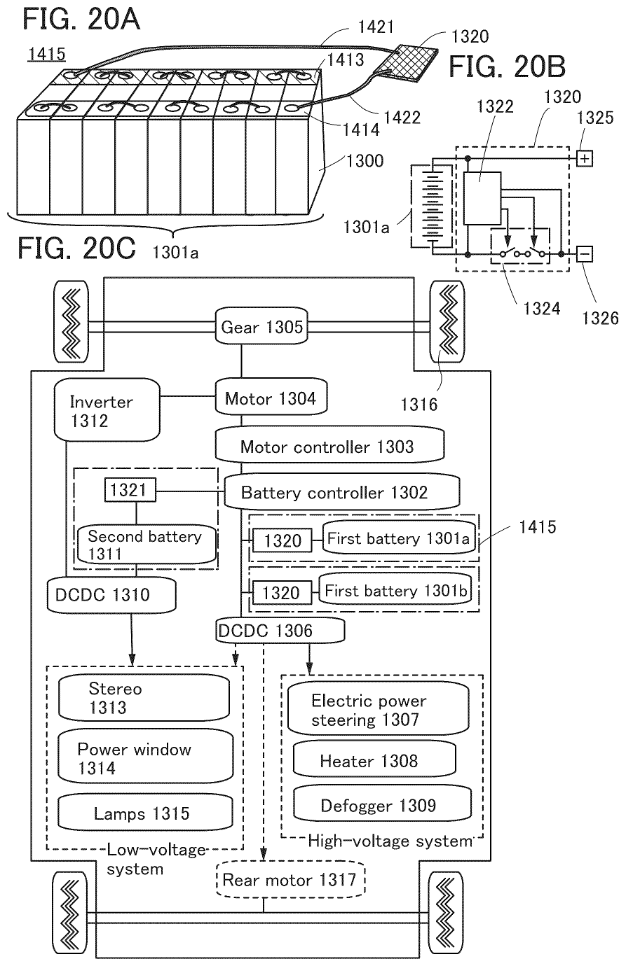

Next, the first battery 1301a is described with reference to FIG. 20A.

FIG. 20A illustrates an example where nine rectangular secondary batteries 1300 form one battery pack 1415. The nine rectangular secondary batteries 1300 are connected in series; one electrode of each battery is fixed by a fixing portion 1413 made of an insulator, and the other electrode thereof is fixed by a fixing portion 1414 made of an insulator. Although this embodiment describes an example where the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portion 1413, the fixing portion 1414, a battery container box, and the like. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor is referred to as a BTOS (Battery operating system or Battery oxide semiconductor) in some cases.

A metal oxide functioning as an oxide semiconductor is preferably used. For example, as the metal oxide, a metal oxide such as an In-M-Zn oxide (the element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is preferably used. In particular, the In-M-Zn oxide that can be used as the metal oxide is preferably a CAAC-OS (C-Axis Aligned Crystal Oxide Semiconductor) or a CAC-OS (Cloud-Aligned Composite Oxide Semiconductor). Alternatively, an In—Ga oxide or an In—Zn oxide may be used as the metal oxide. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement.

Note that the “CAC-OS” has a composition in which materials are separated into first regions and second regions to form a mosaic pattern, and the first regions are distributed in the film (this composition is hereinafter also referred to as a cloud-like composition). That is, the CAC-OS is a composite metal oxide having a composition in which the first regions and the second regions are mixed. Note that a clear boundary between the first region and the second region is not easily observed in some cases.

For example, energy dispersive X-ray spectroscopy (EDX) is used to obtain EDX mapping, and according to the EDX mapping, the CAC-OS in the In—Ga—Zn oxide can be found to have a structure in which the region containing In as its main component (the first region) and the region containing Ga as its main component (the second region) are unevenly distributed and mixed.

In the case where the CAC-OS is used for a transistor, a switching function (On/Off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Accordingly, when the CAC-OS is used for a transistor, high on-state current (Ion), high field-effect mobility (μ), and excellent switching operation can be achieved.

An oxide semiconductor has various structures with different properties. Two or more kinds among an amorphous oxide semiconductor, a polycrystalline oxide semiconductor, an a-like OS, a CAC-OS, an nc-OS, and a CAAC-OS may be included in an oxide semiconductor of one embodiment of the present invention.

The control circuit portion 1320 preferably includes a transistor using an oxide semiconductor because it can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C., which is wider than that of a single crystal Si transistor, and thus shows a smaller change in characteristics than the single crystal Si transistor when the secondary battery is in an overheated state. The off-state current of the transistor using an oxide semiconductor is lower than or equal to the lower measurement limit even at 150° C. independently of the temperature; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the safety. When the control circuit portion is used in combination with a secondary battery including a positive electrode using the positive electrode active material 100 obtained in Embodiments 1, 2, and the like, the synergy on safety can be obtained. The secondary battery including a positive electrode using the positive electrode active material 100 obtained in Embodiments 1, 2, and the like and the control circuit portion 1320 can contribute greatly to elimination of accidents due to secondary batteries, such as fires.

The control circuit portion 1320 that includes a memory circuit including a transistor using an oxide semiconductor can also function as an automatic control device for the secondary battery to resolve ten items of causes of instability, such as a micro-short circuit. Examples of functions of resolving the ten items of causes of instability include prevention of overcharging, prevention of overcurrent, control of overheating during charging, cell balance of an assembled battery, prevention of overdischarging, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the secondary battery can be extremely small in size.

A “micro-short circuit” refers to a minute short circuit caused in a secondary battery and refers not to a state where the positive electrode and the negative electrode of a secondary battery are short-circuited so that charging and discharging are impossible, but to a phenomenon in which a slight short-circuit current flows through a minute short-circuit portion. Since a large voltage change is caused even when a micro-short circuit occurs in a relatively short time in a minute area, the abnormal voltage value might adversely affect estimation to be performed subsequently.

One of the causes of a micro-short circuit is as follows: charging and discharging performed a plurality of times cause an non-uniform distribution of positive electrode active materials, which leads to local concentration of current in part of the positive electrode and part of the negative electrode, whereby part of a separator stops functioning or a by-product is generated by a side reaction, which is thought to generate a micro short-circuit.

It can be said that the control circuit portion 1320 not only detects a micro-short circuit but also senses terminal voltage of the secondary battery and controls the charge and discharge state of the secondary battery. For example, to prevent overcharging, an output transistor of a charge circuit and an interruption switch can be turned off substantially at the same time.

FIG. 20B illustrates an example of a block diagram of the battery pack 1415 illustrated in FIG. 20A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and imposes the upper limit of current from the outside, the upper limit of output current to the outside, and the like. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarging and/or overcharging. For example, when the control circuit 1322 detects a voltage that is likely to cause overcharging, current is interrupted by turning off the switch in the switch portion 1324.

Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of n-channel transistors or p-channel transistors. The switch portion 1324 is not limited to a switch including a Si transistor using single crystal silicon; the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOx (gallium oxide, where x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system). Lead storage batteries are usually used for the second battery 1311 due to cost advantage. Lead storage batteries have disadvantages compared with lithium-ion secondary batteries in that they have a larger amount of self-discharging and are more likely to deteriorate due to a phenomenon called sulfation. There is an advantage that the second battery 1311 can be maintenance-free when a lithium-ion secondary battery is used; however, in the case of long-term use, for example three years or more, anomaly that is difficult to determine at the time of manufacturing might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

In this embodiment, the use of the lithium-ion secondary battery of one embodiment of the present invention as both the first battery 1301a and the second battery 1311 enables excellent discharge characteristics even in a low-temperature environment. Note that as the second battery 1311, a lead storage battery, an all-solid-state battery, or an electric double layer capacitor may be used.

Regenerative energy generated by rolling of tires 1316 is transmitted to the motor 1304 through a gear 1305, and is stored in the second battery 1311 from a motor controller 1303 or a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are desirably capable of fast charging. The battery controller 1302 can set the charge voltage, charge current, and the like of the first batteries 1301a and 1301b. The battery controller 1302 can set charge conditions in accordance with charge performance of a secondary battery used, so that fast charging can be performed.

Although not illustrated, when the electric vehicle is connected to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or a connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charge stations and the like have a 100 V outlet, a 200 V outlet, or a three-phase 200V outlet with 50 KW, for example. Furthermore, charging can be performed with electric power supplied from external charge equipment by a contactless power feeding method or the like.

For fast charging, secondary batteries that can withstand high-voltage charging have been desired to perform charging in a short time.

Moreover, it is possible to achieve a secondary battery in which graphene is used as a conductive material, an electrode layer is formed thick to increase the carried amount while suppressing a reduction in capacity, and the electrical characteristics are significantly improved in synergy with maintenance of high capacity. This secondary battery is particularly effectively used in a vehicle; it is possible to provide a vehicle that has a long cruising range, specifically one charge mileage of 500 km or greater, without increasing the proportion of the weight of the secondary battery to the weight of the entire vehicle.

Next, examples where the secondary battery of one embodiment of the present invention is mounted on a vehicle, typically a transport vehicle, are described.

Mounting the secondary battery illustrated in any one of FIG. 15D, FIG. 17C, and FIG. 20A on vehicles can provide next-generation clean energy vehicles such as hybrid vehicles (HVs), electric vehicles (EVs), and plug-in hybrid vehicles (PHVs). The secondary battery can also be incorporated in agricultural machines, motorized bicycles including motor-assisted bicycles, motorcycles, electric wheelchairs, electric carts, boats and ships, submarines, aircraft, rockets, artificial satellites, space probes, planetary probes, or spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

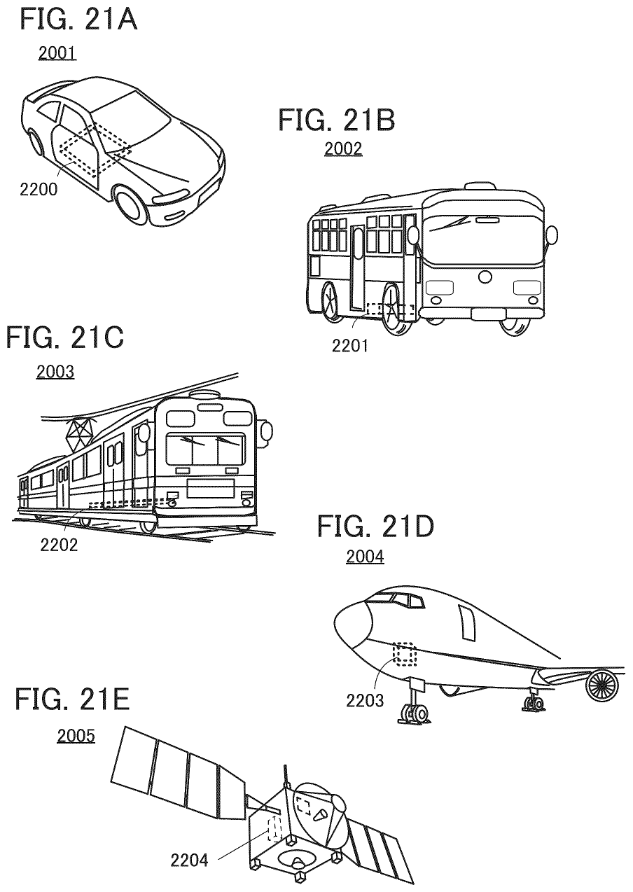

FIG. 21A to FIG. 21D illustrate examples of transport vehicles using one embodiment of the present invention. An automobile 2001 illustrated in FIG. 21A is an electric vehicle that runs using an electric motor as a driving power source. Alternatively, the automobile 2001 is a hybrid vehicle that enables appropriate selection of an electric motor or an engine as a driving power source. In the case where the secondary battery is mounted on the vehicle, an example of the secondary battery described in Embodiment 4 is provided at one position or several positions. The automobile 2001 illustrated in FIG. 21A includes a battery pack 2200, and the battery pack includes a secondary battery module in which a plurality of secondary batteries are connected to each other. The use of the lithium-ion secondary battery of one embodiment of the present invention as the secondary battery enables excellent discharge characteristics even in a low-temperature environment. Moreover, the battery pack preferably includes a charge control device that is electrically connected to the secondary battery module.

The automobile 2001 can be charged when the secondary battery included in the automobile 2001 is supplied with electric power from external charge equipment by a plug-in system, a contactless power feeding system, or the like. In charging, a given method such as CHAdeMO (registered trademark) or Combined Charging System can be employed as a charge method, the standard of a connector, or the like as appropriate. A charge apparatus may be a charge station provided in a commerce facility or a household power supply. For example, with use of the plug-in system, the power storage device mounted on the automobile 2001 can be charged by being supplied with electric power from the outside. Charging can be performed by converting AC electric power into DC electric power through a converter such as an ACDC converter.

Although not illustrated, the vehicle may include a power receiving device so that it can be charged by being supplied with electric power from an above-ground power transmitting device in a contactless manner. For the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 21B illustrates a large transporter 2002 having a motor controlled by electricity as an example of a transport vehicle. A secondary battery module of the transporter 2002 has a cell unit of four secondary batteries with a nominal voltage of 3.0 V or higher and 5.0 V or lower, and 48 cells are connected in series to have 170 V as the maximum voltage. A battery pack 2201 has the same function as that in FIG. 21A except, for example, the number of secondary batteries configuring the secondary battery module; thus, the description is omitted. The use of the lithium-ion secondary battery of one embodiment of the present invention as the secondary battery in FIG. 21B enables excellent discharge characteristics even in a low-temperature environment.

FIG. 21C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and the maximum voltage is 600 V, for example. Thus, the secondary batteries are required to have a small variation in the characteristics. By employing the positive electrode active material 100 described in Embodiments 1, 2, and the like for the positive electrode, a secondary battery having stable battery characteristics can be manufactured and mass production at low cost is possible in light of the yield. A battery pack 2202 has the same function as that in FIG. 21A except, for example, the number of secondary batteries configuring the secondary battery module; thus, the description is omitted. The use of the lithium-ion secondary battery of one embodiment of the present invention as the secondary battery in FIG. 21C enables excellent discharge characteristics even in a low-temperature environment.

FIG. 21D illustrates an aircraft 2004 having a combustion engine as an example. The aircraft 2004 illustrated in FIG. 21D is regarded as a kind of transport vehicles because it has wheels for takeoff and landing, and includes a battery pack 2203 that includes a charging control device and a secondary battery module configured by connecting a plurality of secondary batteries. The use of the lithium-ion secondary battery of one embodiment of the present invention as the secondary battery in FIG. 21D enables excellent discharge characteristics even in a low-temperature environment.

The secondary battery module of the aircraft 2004 has eight 4 V secondary batteries connected in series, and the maximum voltage is 32 V, for example. The battery pack 2203 has the same function as that in FIG. 21A except for, for example, the number of secondary batteries configuring the secondary battery module; thus, the description is omitted.

FIG. 21E illustrates an artificial satellite 2005 including a secondary battery 2204 as an example. Since the artificial satellite 2005 is used in an ultra-low-temperature cosmic space, the secondary battery 2204 having excellent low temperature resistance of one embodiment of the present invention is preferably provided. It is further preferable that the secondary battery 2204 be mounted inside the artificial satellite 2005 while being covered with a heat-retaining member. The use of the lithium-ion secondary battery of one embodiment of the present invention as the secondary battery in FIG. 21E enables excellent discharge characteristics even in a low-temperature environment.

### Embodiment 7

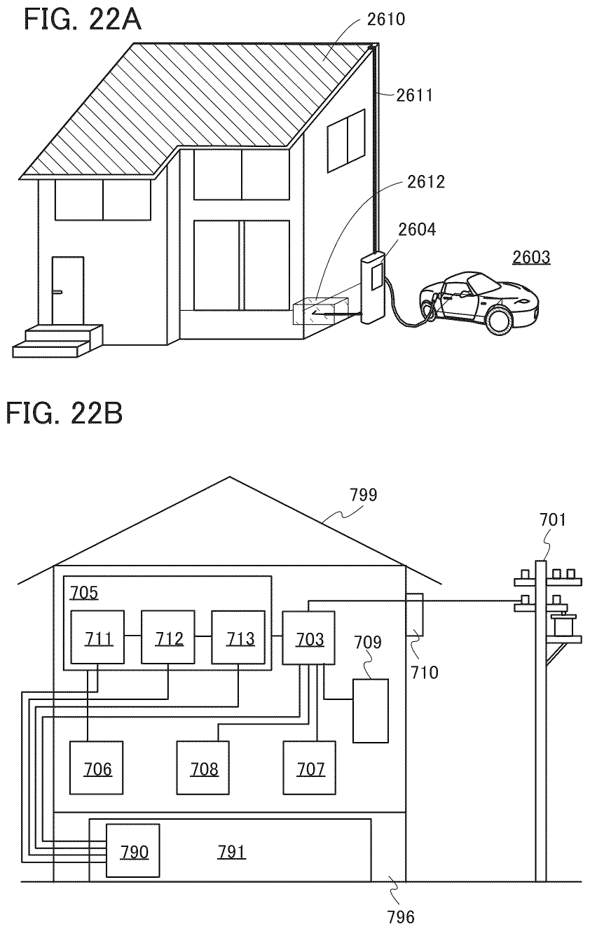

In this embodiment, examples where the secondary battery of one embodiment of the present invention is mounted on a building will be described with reference to FIG. 22A and FIG. 22B.

A house illustrated in FIG. 22A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to ground-based charge equipment 2604. The power storage device 2612 can be charged with electric power generated by the solar panel 2610. A secondary battery included in a vehicle 2603 can be charged with the electric power stored in the power storage device 2612 through the charge equipment 2604. The power storage device 2612 is preferably provided in an underfloor space. When the power storage device 2612 is provided in the underfloor space, the space on the floor can be effectively used. Alternatively, the power storage device 2612 may be provided on the floor. The use of the lithium-ion secondary battery of one embodiment of the present invention for the power storage device in FIG. 22A enables excellent discharge characteristics even in a low-temperature environment.

The electric power stored in the power storage device 2612 can also be supplied to other electronic devices in the house. Thus, with use of the power storage device 2612 of one embodiment of the present invention as an uninterruptible power source, electronic devices can be used even when electric power cannot be supplied from a commercial power source due to power failure or the like.

FIG. 22B illustrates an example of a power storage device of one embodiment of the present invention. As illustrated in FIG. 22B, a power storage device 791 of one embodiment of the present invention is provided in an underfloor space of a building 799. The power storage device 791 may be provided with a control circuit, in which case safety can be improved.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electronic device such as a TV or a personal computer. The power storage load 708 is, for example, an electronic device such as a microwave oven, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. An electronic device such as a TV or a personal computer can also show it through the router 709.

Furthermore, it can be checked with a portable electronic terminal such as a smartphone or a tablet through the router 709. The indicator 706, the electronic device, the portable electronic terminal, or the like can also show, for example, the demand for electric power depending on a time period (or per hour) that is predicted by the predicting portion 712.

### Embodiment 8

In this embodiment, examples where the lithium-ion secondary battery of one embodiment of the present invention is mounted on a motorcycle and a bicycle will be described as examples of mounting a secondary battery in a vehicle.

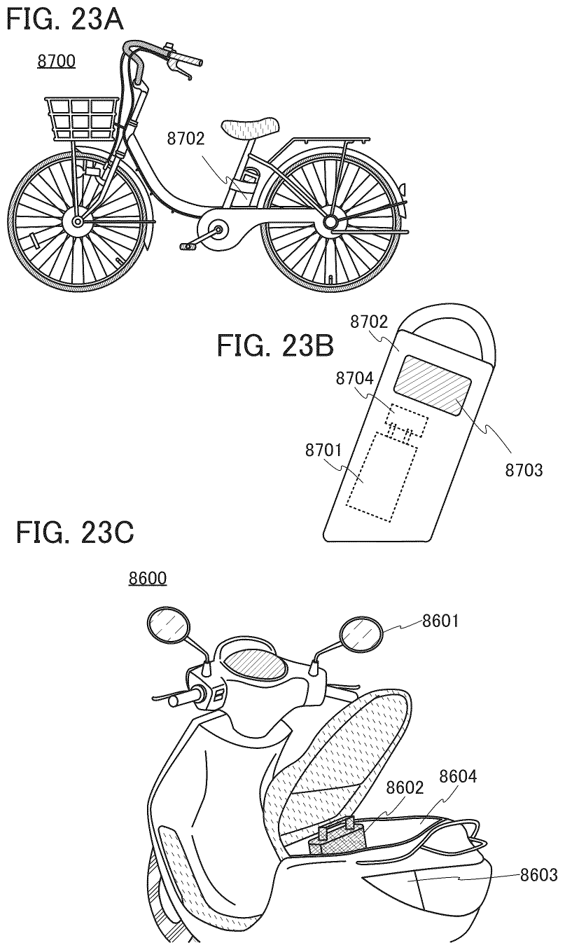

FIG. 23A illustrates an example of an electric bicycle using the power storage device of one embodiment of the present invention. The use of the lithium-ion secondary battery of one embodiment of the present invention for the electric bicycle 8700 illustrated in FIG. 23A enables excellent discharge characteristics even in a low-temperature environment. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 23B illustrates the state where the power storage device 8702 is detached from the bicycle. The use of the lithium-ion secondary battery of one embodiment of the present invention for the power storage device 8702 enables excellent discharge characteristics even in a low-temperature environment. Furthermore, the remaining battery capacity and the like of the power storage device 8702 can be displayed on the display portion 8703. The power storage device 8702 includes a control circuit 8704 capable of charge control or anomaly detection for the secondary battery. The control circuit 8704 is electrically connected to a positive electrode and a negative electrode of the storage battery 8701.

FIG. 23C illustrates an example of a motorcycle using the power storage device of one embodiment of the present invention. A motor scooter 8600 illustrated in FIG. 23C includes a power storage device 8602, side mirrors 8601, and indicator lights 8603. The power storage device 8602 can supply electricity to the indicator lights 8603. The use of the lithium-ion secondary battery of one embodiment of the present invention for the power storage device 8602 enables excellent discharge characteristics even in a low-temperature environment.

In the motor scooter 8600 illustrated in FIG. 23C, the power storage device 8602 can be stored in an under-seat storage unit 8604. The power storage device 8602 can be stored in the under-seat storage unit 8604 even when the under-seat storage unit 8604 is small. The use of the lithium-ion secondary battery of one embodiment of the present invention for the power storage device 8602 enables excellent discharge characteristics even in a low-temperature environment.

### Embodiment 9

In this embodiment, examples of electronic devices each including the secondary battery of one embodiment of the present invention are described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

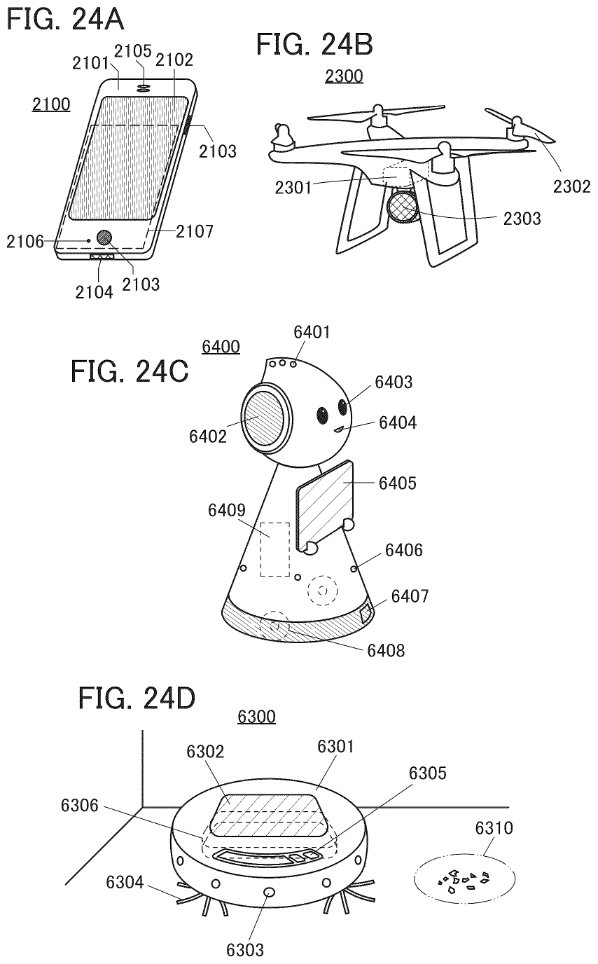

FIG. 24A illustrates an example of a mobile phone. A mobile phone 2100 includes a housing 2101 in which a display portion 2102 is incorporated, operation buttons 2103, an external connection port 2104, a speaker 2105, a microphone 2106, and the like. The mobile phone 2100 includes a secondary battery 2107. The use of the lithium-ion secondary battery of one embodiment of the present invention as the secondary battery 2107 enables excellent discharge characteristics even in a low-temperature environment.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication conformable to a communication standard. For example, mutual communication with a headset capable of wireless communication enables hands-free calling.

Moreover, the mobile phone 2100 includes the external connection port 2104, and data can be directly transmitted to and received from another information terminal via a connector. In addition, charging can be performed via the external connection port 2104. Note that the charge operation may be performed by wireless power feeding without using the external connection port 2104.

The mobile phone 2100 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted. FIG. 24B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. The use of the lithium-ion secondary battery of one embodiment of the present invention as a secondary battery included in the unmanned aircraft 2300 enables excellent discharge characteristics even in a low-temperature environment.

FIG. 24C illustrates an example of a robot. A robot 6400 illustrated in FIG. 24C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. The use of the lithium-ion secondary battery of one embodiment of the present invention as the secondary battery 6409 included in the robot 6400 enables excellent discharge characteristics even in a low-temperature environment.

FIG. 24D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

The cleaning robot 6300 can determine whether there is an obstacle such as a wall, furniture, or a step by analyzing images taken by the cameras 6303. In the case where the cleaning robot 6300 detects an object, such as a wire, that is likely to be caught by the brush 6304 by image analysis, the rotation of the brush 6304 can be stopped. The use of the lithium-ion secondary battery of one embodiment of the present invention as the secondary battery 6306 included in the cleaning robot 6300 enables excellent discharge characteristics even in a low-temperature environment. The cleaning robot 6300 further includes a semiconductor device or an electronic component.

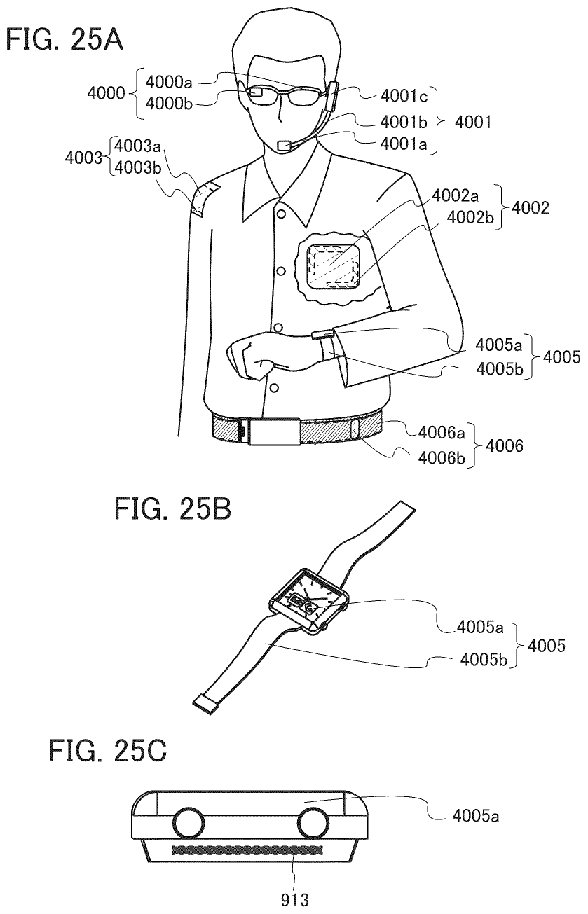

FIG. 25A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 25A, in which case excellent discharge characteristics even in a low-temperature environment can be achieved. The glasses-type device 4000 includes a frame 4000a and a display portion 4000b. The secondary battery is provided in a temple portion of the frame 4000a having a curved shape, whereby the glasses-type device 4000 can be light in weight, can have a well-balanced weight, and can be used continuously for a long time. A secondary battery including a positive electrode using the positive electrode active material 100 obtained in Embodiments 1, 2, and the like has high energy density and achieves a structure that accommodates space saving due to a reduction in size of the housing.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b or the earphone portion 4001c. A secondary battery including a positive electrode using the positive electrode active material 100 obtained in Embodiments 1, 2, and the like has high energy density and achieves a structure that accommodates space saving due to a reduction in size of the housing.

The secondary battery of one embodiment of the present invention can be provided in a device 4002 that can be attached directly to a body. A secondary battery 4002b can be provided in a thin housing 4002a of the device 4002. A secondary battery including a positive electrode using the positive electrode active material 100 obtained in Embodiments 1, 2, and the like has high energy density and achieves a structure that accommodates space saving due to a reduction in size of the housing.

The secondary battery of one embodiment of the present invention can be provided in a device 4003 that can be attached to clothes. A secondary battery 4003b can be provided in a thin housing 4003a of the device 4003. A secondary battery including a positive electrode using the positive electrode active material 100 obtained in Embodiments 1, 2, and the like has high energy density and achieves a structure that accommodates space saving due to a reduction in size of the housing.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. A secondary battery including a positive electrode using the positive electrode active material 100 obtained in Embodiments 1, 2, and the like has high energy density and achieves a structure that accommodates space saving due to a reduction in size of the housing.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. A secondary battery including a positive electrode using the positive electrode active material 100 obtained in Embodiments 1, 2, and the like has high energy density and achieves a structure that accommodates space saving due to a reduction in size of the housing. The display portion 4005a can display various kinds of information such as time and reception information of an e-mail or an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 25B is a perspective view of the watch-type device 4005 that is detached from an arm.

FIG. 25C is a side view. FIG. 25C illustrates a state where the secondary battery 913 is incorporated in the inner region. The use of the lithium-ion secondary electricity of one embodiment of the present invention as the secondary battery 913 enables excellent discharge characteristics even in a low-temperature environment.

### Example 1

In this example, a test battery including a positive electrode active material of one embodiment of the present invention, a negative electrode active material, and the like was fabricated and charge and discharge cycle tests were performed.

### <Formation of Positive Electrode Active Material>

A formation process of the positive electrode active materials used in this example is described with reference to the fabrication methods shown in FIG. 9 and FIG. 10.

As LiCoO₂ in Step S14 in FIG. 9, commercially available lithium cobalt oxide (CELLSEED C-5H produced by NIPPON CHEMICAL INDUSTRIAL CO., LTD.) containing cobalt as the transition metal M and not containing any additive element was prepared and sieved with an automatic sieving machine. The median diameter (D50) of CELLSEED C-5H obtained by measuring the particle size distribution with a laser diffraction particle size analyzer SALD-2200 was 7.0 μm. As the initial heating in Step S15, heating was performed on the lithium cobalt oxide put in a saggar covered with a lid, in a roller hearth kiln simulator furnace (produced by NORITAKE CO., LIMITED) as a baking furnace at 850° C. for two hours. Air (compressed air which was sufficiently dried) was made to flow at 10 L/min in the furnace. The flow rate, specifically, the width of an opening of an outlet, was adjusted such that a differential pressure gauge read 5 Pa, whereby the inside of the furnace was under positive pressure. After the initial heating, cooling in the furnace was performed at a rate of 200° C./h, with the air keeping on flowing until the temperature reached 200° C.

In this example, Mg and F were separately added as additive elements in accordance with Step S20a shown in FIG. 10A. First, LiF was prepared as the F source and MgF₂ was prepared as the Mg source, in accordance with Step S21 shown in FIG. 10A. LiF and MgF₂ were weighed such that the molar ratio of LiF to MgF₂ was 1:3, and were mixed in dehydrated acetone at a rotation speed of 500 rpm for 20 hours. The mixture was made to pass through a sieve with an aperture size of 300 μm, whereby an additive element source (A1 source) with a uniform particle diameter was formed.

Next, in Step S31 shown in FIG. 9, the A1 source and the lithium cobalt oxide were weighed such that magnesium of the A1 source was 1 mol % of cobalt of the lithium cobalt oxide, and the A1 source and the lithium cobalt oxide that had been subjected to the initial heating were stirred with picobond (produced by HOSOKAWA MICRON CORPORATION) at a rotation speed of 3000 rpm for 10 minutes, whereby the mixture 903 was obtained (Step S32). Nobilta was used as a rotor of the picobond. Before subsequent Step S33, the mixture 903 was sieved with an automatic sieving machine.

Next, in Step S33, the mixture 903 was heated. The heating conditions were 850° C. and 10 hours. During the heating, the mixture 903 was in a saggar covered with a lid. During the heating performed at the above heating temperature, the saggar was in a roller hearth kiln simulator furnace (produced by NORITAKE CO., LIMITED). Oxygen was made to flow at 10 L/min in the furnace (O₂ flow). The flow rate, specifically, the width of an opening of an outlet, was adjusted such that a differential pressure gauge read 5 Pa, whereby the inside of the furnace was under positive pressure. After the initial heating, cooling in the furnace was performed at a rate of 200° C./h, with the oxygen keeping on flowing until the temperature reached 200° C. In this manner, a composite oxide containing Mg and F was obtained (Step S34a).

Then, in Step S40, a composite oxide and an additive element source (A2 source) were prepared. First, nickel hydroxide subjected to a grinding step was prepared as a nickel source and aluminum hydroxide subjected to a grinding step was prepared as an aluminum source in accordance with Step S41 shown in FIG. 10C, and those were used as the additive element source (the A2 source). As the grinding step, the nickel hydroxide and the aluminum hydroxide were mixed in dehydrated acetone at a rotating speed of 500 rpm for 20 hours. After that, the mixture was made to pass through a sieve with an aperture size of 300 μm.

The A2 source was weighed such that nickel of the nickel hydroxide was 0.5 mol % of cobalt and aluminum of the aluminum hydroxide was 0.5 mol % of cobalt, and the nickel hydroxide, the aluminum hydroxide, and the composite oxide containing Mg and F were stirred with picobond (produced by HOSOKAWA MICRON CORPORATION) at a rotation speed of 3000 rpm for 10 minutes, whereby a mixture 904 was obtained (Step S52). Nobilta was used as a rotor of the picobond. Before subsequent Step S53, the mixture 904 was sieved with an automatic sieving machine.

Next, in Step S53, the mixture 904 was heated. The heating conditions were 850° C. and 2 hours. During the heating, the mixture 904 was in a saggar covered with a lid. During the heating performed at the above heating temperature, the saggar was in a roller hearth kiln simulator furnace (produced by NORITAKE CO., LIMITED). Oxygen was made to flow at 10 L/min in the furnace (O2 flow). The flow rate, specifically, the width of an opening of an outlet, was adjusted such that a differential pressure gauge read 5 Pa, whereby the inside of the furnace was under positive pressure. After the heating, cooling in the furnace was performed at a rate of 200° C./h, with the oxygen keeping on flowing until the temperature reached 200° C.

In this manner, lithium cobalt oxide containing Mg, F, Ni, and Al was obtained (Step S54). The lithium cobalt oxide obtained in this manner was used as the positive electrode active material of the sample. The median diameter (D50) of the positive electrode active material is greater than or equal to 1 μm and less than or equal to 12 μm.

### <Fabrication of Positive Electrode>

The lithium cobalt oxide, acetylene black (AB), and poly(vinylidene fluoride) (PVDF) were prepared as the positive electrode active material, a conductive material, and a binding agent, respectively. The PVDF prepared was one dissolved in N-methyl-2-pyrrolidone (NMP) at a weight ratio of 5%. A slurry was formed by mixing the positive electrode active material, AB, and PVDF at the positive electrode active material: AB:PVDF=95:3:2 (weight ratio), and the slurry was applied to a positive electrode current collector of aluminum. As a solvent of the slurry, NMP was used. After the slurry was applied to the positive electrode current collector, the solvent was volatilized.

After that, pressing treatment was performed with a roller press machine to increase the density of the positive electrode active material layer over the positive electrode current collector. The pressing treatment was performed with a linear pressure of 210 kN/m. Note that the temperature of each of an upper roll and a lower roll of the roller press machine was 120° C.

Through the above process, the positive electrode of each sample was obtained. The carried amount of the positive electrode active material was adjusted to be greater than or equal to mg/cm² and less than or equal to 11 mg/cm².

### <Fabrication of Negative Electrode>

Negative electrode used in this example is described with reference to the fabrication 10 method shown in FIG. 13.

In accordance with FIG. 13, as the graphite particles in this example, graphite (Formula BT 1520T produced by Superior Graphite Co.) having an average particle diameter of 20 μm was prepared. This graphite is obtained by coating spherical natural graphite with low crystalline carbon.

In accordance with FIG. 13, as the silicon particles in this example, silicon particles (product number 633097 produced by Sigma-Aldrich Co. LLC) having a specific surface area of 12.7715 m²/g by a BET method and an average particle diameter of 100 nm were prepared. A 100-nm silicon particle is referred to as a nanosilicon particle.

### <Sample 1 and Sample 2>

In accordance with FIG. 13, polyglutamic acid (produced by Nippon Poly-Glu Co., Ltd., referred to as PGA) or polyacrylic acid (20CLPAH produced by FUJIFILM Waco Chemical Co., Ltd., referred to as PAA) was used as a binder in this example. In this example, a full cell using PGA is referred to as Sample 1 and a full cell using PAA (having a cross-linking degree of 20 CL) is referred to as Sample 2 in order to change the condition of the binder.

In accordance with FIG. 13, acetylene black (AB) was prepared as the conductive material in this example.

In accordance with Step S60 in FIG. 13, for Sample 1, the mixture 204 was formed by mixing the graphite particle, the silicon particle, AB, and PGA at the graphite particle: the silicon particle: AB:PGA=72:8:6:14 (weight ratio). For Sample 2, the mixture 204 was formed by mixing the graphite particle, the silicon particle, AB, and PAA at the graphite particle: the silicon particle: AB:PAA=72:8:6:14 (weight ratio). In Step S60, the materials are preferably mixed in a powder state. The carried amount of the negative electrode active material was adjusted to be greater than or equal to 3.8 mg/cm² and less than or equal to 4.2 mg/cm².

In accordance with FIG. 13, deionized water was prepared as the solvent.

In accordance with Step S61 in FIG. 13, deionized water was added to the mixture 204 for Sample 1 and mixing was performed to give the slurry 206. Furthermore, deionized water was added to the mixture 204 for Sample 2 and mixing was performed to give the slurry 206.

### COMPARATIVE EXAMPLE

In a negative electrode that is a comparative example of this example, a graphite particle was used as a negative electrode active material, carbon fiber (VGCF (registered trademark) produced by SHOWA DENKO K.K.) was used as a conductive material, and CMC and SBR were used as binders. Mixing was performed such that the mixing ratio was the graphite particle: VGCF:CMC:SBR=97:1:1:1 (weight ratio). The conditions of the negative electrodes of Sample 1, Sample 2, and the comparative example are shown in the following table.

TABLE 2

| | Negative electrode | | Conductive | | | Weight |
|---|---|---|---|---|---|---|
| | active material | | material | Binder | | ratio |
| Sample 1 | Graphite | Silicon | AB | PGA | | 72:8:6:14 |
| | particle | particle | | | | |
| Sample 2 | Graphite | Silicon | AB | PAA | | 72:8:6:14 |
| | particle | particle | | | | |
| Compar- | Graphite particle | | VGCF | CMC | SBR | 97:1:1:1 |
| ative | | | | | | |
| example | | | | | | |

In accordance with FIG. 13, a copper foil was prepared as the negative electrode current collector, and the slurry was applied to the copper foil in accordance with Step S62.

Drying was performed in accordance with Step S63 in FIG. 13 and pressing was performed in accordance with Step S64, whereby the negative electrode 208 was obtained. As the drying, first drying (pre-drying) and second drying (main drying) were performed, and in the pre-drying, the copper foil to which the slurry was applied was sandwiched between hot plates heated to 50° C., and kept for 30 minutes. After that, in the main drying, the copper foil to which the slurry was applied was set in a circulation dryer at 80° C. and kept for 45 minutes. A roller press machine was used for the pressing, and the comparative example was pressed with a roll heated to 120° C. at a linear pressure of 0.5 MPa. Note that Sample 1 and Sample 2 were not pressed.

### <SEM Observation of Samples 1 and 2>

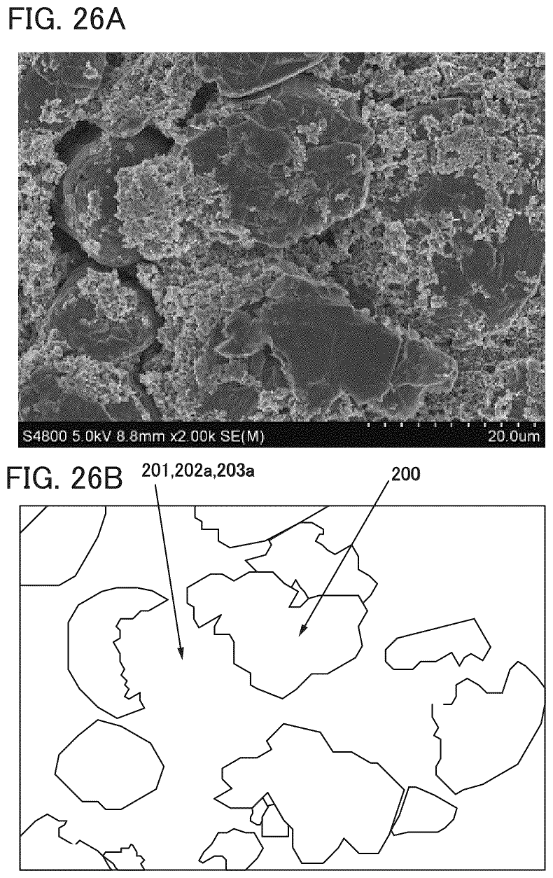

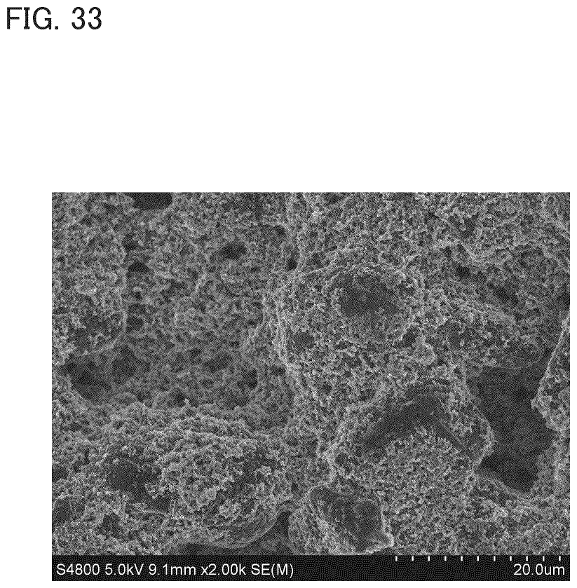

Sample 1 was dried in accordance with Step S63 and subjected to SEM observation. S4800 produced by Hitachi High-Technologies Corporation was used as the SEM. The accelerating voltage was 5 kV, and an image with a magnification of 2000 times was obtained. FIG. 26A is a SEM image of the top surface of Sample 1, and FIG. 26B is a schematic view of the SEM image. FIG. 26B illustrates the graphite particles 200 surrounded by solid lines. FIG. 33 is a SEM image of the top surface of Sample 2.

As shown in FIG. 26A and FIG. 26B, when seen from above, part of the graphite particle 200 is exposed to the binder 202 containing polyglutamic acid. That is, the graphite particle 200 including a region not covered with a binder 202a containing polyglutamic acid probably ensures a region where lithium can be inserted and extracted. The binder 202a containing polyglutamic acid is positioned between the graphite particles 200, and the polyglutamic acid enables binding between the graphite particles, for example.

Furthermore, silicon particles 201 can be observed in a region where the binder 202a containing polyglutamic acid is positioned, and a state where the silicon particles 201 are aggregated can also be observed. In addition, an AB 203a, which is a conductive material, can be observed in the region where the binder 202a containing polyglutamic acid is positioned, and a state where the ABs 203a are aggregated can also be observed.

There is a concern that the silicon particle slips due to expansion and contraction in charging and discharging; however, since the silicon particle 201 is surrounded by the binder 202a containing polyglutamic acid in Sample 1, slipping is probably inhibited even when charging and discharging are repeated. Furthermore, the binder 202a containing polyglutamic acid surrounds the silicon particle 201 to be positioned close to the AB 203a, and thus a conductive path is probably ensured easily.

As described above, the negative electrode preferably includes a region where the graphite particle 200 is not covered with the binder and a region where the silicon particles 201 are aggregated and covered with the binder. Furthermore, in the negative electrode, the conductive material is preferably positioned in the vicinity of the silicon particle 201, and the conductive material is preferably covered with the binder. Note that in the case where the conductive material is in a carbon fiber form, the conductive material is not necessarily covered with the binder.

### <Electrolyte Solution>

Next, an electrolyte solution was prepared. As the electrolyte solution, an electrolyte solution obtained by dissolving lithium hexafluorophosphate (LiPF₆) at 1 mol/L in a mixed solvent containing FEC (fluoroethylene carbonate) and MTFP (methyl 3,3,3-trifluoropropionate) at FEC: MTFP=20:80 (volume ratio) was prepared. Note that no additive agent was used.

### <Separator>

Next, a separator was prepared. As the separator, a porous polypropylene film (PP) was used.

### <Assembly of Test Battery>

The positive electrode fabricated in the above manner, the negative electrode fabricated in the above manner, and the separator were held in a battery can, and the electrolyte solution prepared in the above manner was dripped, whereby the test battery was fabricated. The test battery in this example is referred to as a full cell in some cases. As described above, the assembled test batteries differ in conditions such as the binder of the negative electrode; thus, the test battery including Sample 1 is referred to as Full cell 1, the test battery including Sample 2 is referred to as Full cell 2, and the test battery including the comparative example is referred to as Comparative cell.

### <Charge and Discharge Cycle Test 1>

Next, charge and discharge cycle test was performed on each of Full cell 1, Full cell 2, and Comparative cell. First, initial charging and discharging were performed at 25° C., a charge and discharge cycle test was performed at −40° C., and the temperature was returned to 25° C. again to continue the charge and discharge cycle test. The temperatures of 25° C. and −40° C. are temperatures of the thermostatic bath where the test batteries were placed. The charge and discharge cycle test refers to a test where charging and discharging are performed at a predetermined temperature, and repeated charging and discharging are referred to as cycles in some cases. Note that the initial charging and discharging are sometimes referred to as aging or conditioning and correspond to the first cycle for the test battery. The measurement conditions of the charge and discharge cycle test in this example, where the rate conditions are different depending on the temperature, are listed in the following table.

TABLE 3

| Temperature [° C.] | C rate | Cycle number |
|---|---|---|
| 25 | 0.1 | 1 |
| 25 | 0.2 | 3 (2nd to 4th cycles) |
| −40 | 0.05 | 10 (5th to 14th cycles) |
| 25 | 0.2 | 3 (15th to 17th cycles) |

Here, rates of the charge and discharge cycle test conditions are described. The rate in discharging is referred to as a discharge rate and the discharge rate refers to the relative ratio of a current in discharging to the battery capacity and is expressed in a unit C. A current corresponding to 1 C in a battery with a rated capacity X (Ah) is X (A). The case where discharging is performed with a current of 2X (A) is rephrased as follows: discharging is performed at 2 C. The case where discharging is performed at a current of X/2 (A) is rephrased as follows: discharging is performed at 0.5 C. The rate in charging is referred to as a charge rate and similarly, for the charge rate, the case where charging is performed at a current of 2X (A) is rephrased as follows: charging is performed at 2 C, and the case where charging is performed at a current of X/2 (A) is rephrased as follows: charging is performed at 0.5 C. The charge rate and the discharge rate are collectively referred to as a C rate in some cases. Note that 1 C was set to 200 mA/g (per weight of the positive electrode active material) in the conditions of the charge and discharge cycle test in this example.

Conditions other than the C rate in the above charge and discharge cycle test are as follows: in charging, constant current charging (CC charging) was performed on the test battery up to the upper limit voltage of 4.5 V, and then constant voltage charging (CV charging) was performed until the C rate decreased to 1/10 (note that ⅕ at −40° C.). In discharging, constant current discharging (CC discharging) was performed up to the lower limit voltage of 2.5 V. A break period longer than or equal to 5 minutes and shorter than or equal to 15 minutes may be provided between charging and discharging.

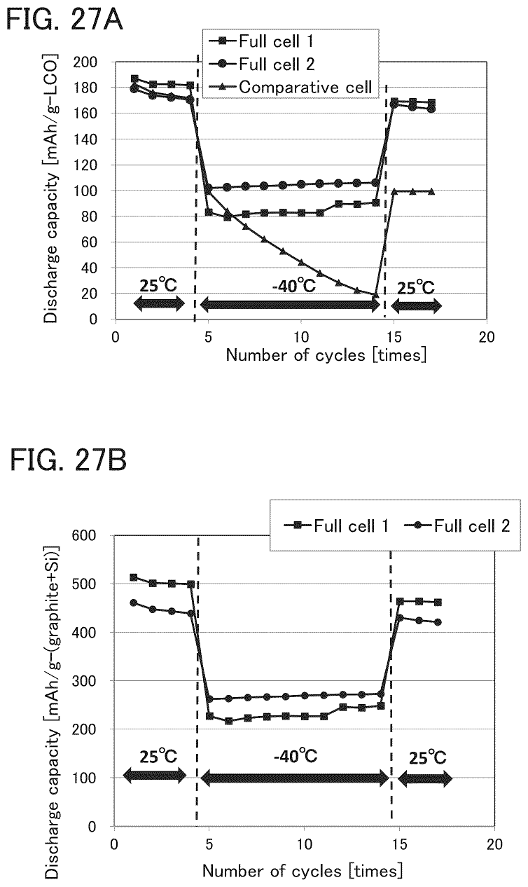

FIG. 27A and FIG. 27B show discharge capacity as the results of the charge and discharge cycle tests. FIG. 27A shows discharge capacity per weight of the lithium cobalt oxide, which is the positive electrode active material, and FIG. 27B shows discharge capacity per total weight of the graphite particles and the silicon particles, which is the mass of the negative electrode active material. Thus, FIG. 27B does not show the comparative example.

The following table shows discharge capacity X (discharge capacity in the 14th cycle in FIG. 27A) at lower than or equal to −40° C., discharge capacity Y (discharge capacity in the 15th cycle in FIG. 27A) at 25° C., and values corresponding to the discharge capacity X/the discharge capacity Y×100 of the test batteries shown in FIG. 27A. The discharge capacity X/the discharge capacity Y×100 of each of Full cell 1 and Full cell 2 is higher than or equal to 50%, preferably higher than or equal to 60%, showing better discharge characteristics in a lower temperature environment than Comparative cell.

TABLE 4

| | Discharge | Discharge | (Discharge capacity X)/ |
|---|---|---|---|
| | capacity X | capacity Y | (Discharge capacity Y) × |
| | −40° C. | 25° C. | 100 |
| Full cell 1 | 90.5 | 169.0 | 53.5 |
| Full cell 2 | 105.8 | 166.8 | 63.4 |
| Comparative cell | 18.9 | 99.0 | 19.1 |

The following table shows the discharge capacity X (discharge capacity in the 14th cycle in FIG. 27B) at lower than or equal to −40° C., the discharge capacity Y (discharge capacity in the 15th cycle in FIG. 27B) at 25° C., and values corresponding to the discharge capacity X/the discharge capacity Y×100 of the test batteries shown in FIG. 27B. The discharge capacity X/the discharge capacity Y×100 of each of Full cell 1 and Full cell 2 is higher than or equal to 50%, preferably higher than or equal to 60%, showing good discharge characteristics in a lower temperature environment.

TABLE 5

| | Discharge | Discharge | (Discharge capacity X)/ |
|---|---|---|---|
| | capacity X | capacity Y | (Discharge capacity Y) × |
| | −40° C. | 25° C. | 100 |
| Full cell 1 | 248.3 | 463.8 | 53.5 |
| Full cell 2 | 272.5 | 430 | 63.4 |

FIG. 27A and Table 4 show that Full cell 1 and Full cell 2 have more favorable cycle performance at low temperature and higher discharge capacity than Comparative cell. FIG. 27B and Table 5 show that Full cell 1 and Full cell 2 have favorable cycle performance at low temperature and high discharge capacity. It is thus found that the negative electrode active material in which the graphite particles and the silicon particles are mixed is preferably used at a low temperature such as −40° C., and a binder containing PGA or PAA is further preferably used. In addition to the above, this example also suggests that the binder containing PAA has better low-temperature characteristics than the binder containing PGA.

For charging and discharging at low temperature, lithium cobalt oxide containing at least Mg is preferably used as the positive electrode active material. At low temperature, a mixed solvent of a fluorinated cyclic carbonate and a fluorinated chain carbonate is preferably used as the electrolyte solution.

### <Comparison of Charge and Discharge Characteristics Using Different Separators and Different Cross-Linking Degrees of PAA>

Next, test batteries containing PAA (having a cross-linking degree of 10 CL) instead of PAA (having a cross-linking degree of 20 CL) of Full cell 2 and including different separators were prepared, and subjected to charge and discharge cycle tests. A test cell using PP for the separator is referred to as Full cell 2_PP, a test cell using glass fiber (GFC) for the separator is referred to as Full cell 2_G, a test cell using one layer of polyimide is referred to as Full cell 2_PI1, a test cell using two layers of polyimide is referred to as Full cell 2_PI2, and a test cell using three layers of polyimide is referred to as Full cell 2_PI3. The above-described conditions of the full cells are shown in the following table.

TABLE 6

| | | Negative electrode | | Conductive | | Weight |
|---|---|---|---|---|---|---|
| | Separator | active material | | material | Binder | ratio |
| Full cell 2_PP | PP | Graphite | Silicon | AB | PAA | 72:8:6:14 |
| Full cell 2_G | GFC | particles | particles | | | |
| Full cell 2_PI1 | PI (1 layer) | | | | | |
| Full cell 2_PI2 | PI (2 layers) | | | | | |
| Full cell 2_PI3 | PI (3 layers) | | | | | |

### <Charge and Discharge Cycle Test 2>

Charge and discharge cycle test was performed on each of Full cell 2_PP, Full cell 2_G, Full cell 2_PI1, Full cell 2_PI2, and Full cell 2_PI3. All of the conditions of the charge and discharge cycle test were the same as those of the charge and discharge cycle test 1, including the rate condition and the like.

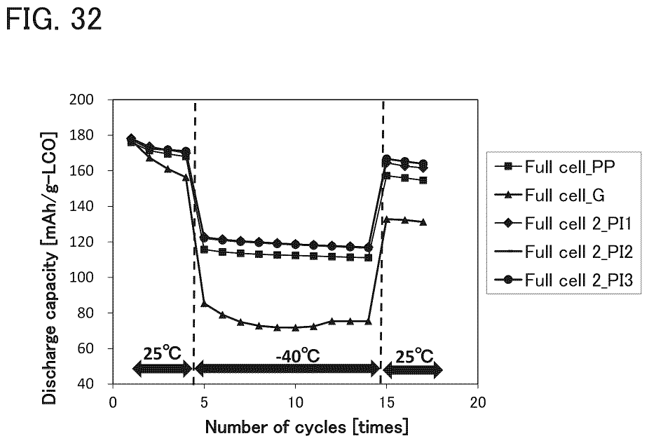

FIG. 32 shows discharge capacity as the results of the charge and discharge cycle tests. The discharge capacity in FIG. 32 is per weight of the lithium cobalt oxide, which is the positive electrode active material.

The following table shows the discharge capacity X (discharge capacity in the 14th cycle in (FIG. 32) at lower than or equal to −40° C. and the discharge capacity Y (discharge capacity in the 15th cycle in FIG. 32) at 25° C. of the test batteries shown in FIG. 32 and values corresponding to the discharge capacity X/the discharge capacity Y×100. In all the full cells except for Full cell 2_G, the discharge capacity X/the discharge capacity Y×100 is higher than or equal to 50%, preferably higher than or equal to 60%, showing better discharge characteristics in a low-temperature environment than Comparative cell. It is found that polyimide or polypropylene is preferably used for the separator in a low-temperature environment.

TABLE 7

| | Discharge | Discharge | (Discharge capacity X)/ |
|---|---|---|---|
| | capacity X | capacity Y | (Discharge capacity Y) × |
| | −40° C. | 25° C. | 100 |
| Full cell 2_PP | 111.1 | 157.3 | 70.6 |
| Full cell 2_G | 63.6 | 130.7 | 48.7 |
| Full cell 2_PI1 | 117.0 | 164.5 | 71.1 |
| Full cell 2_PI2 | 116.3 | 164.5 | 70.7 |
| Full cell 2_PI3 | 116.7 | 166.72 | 70.0 |

### Example 2

In this example, XPS analysis, XRD analysis in a high-voltage charged state, and STEM-EDX analysis were performed on lithium cobalt oxide containing Mg, F, Ni, and Al.

### <Formation Method of LCO1>

This example explains that lithium cobalt oxide 1 with a median diameter (D50) of less than or equal to 12 μm can be obtained on the basis of the description in Embodiment 1, FIG. 9, FIG. 10, and the like.

As lithium cobalt oxide (LiCoO₂) that was a starting material shown in Step S10 in FIG. 9, commercially available lithium cobalt oxide not containing any additive element (CELLSEED C-5H produced by NIPPON CHEMICAL INDUSTRIAL CO., LTD.) was prepared. Hereinafter, in this specification and the like, the lithium cobalt oxide is simply referred to as “C-5H”. The median diameter (D50) of C-5H is approximately 7.0 μm, which satisfies the condition where the median diameter (D50) is less than or equal to 10 μm.

Next, the heating in Step S15 was performed on C-5H, which was put in a saggar (container) covered with a lid, in a muffle furnace at 850° C. for 2 hours. After the muffle furnace was filled with an oxygen atmosphere, no flowing was performed (O2 purging). Note that C-5H was put in the saggar so that the powder had a height (also referred to as bulk) of less than or equal to 10 mm and was flat in the saggar.

Next, in accordance with Step S20a shown in FIG. 10A, the additive element A1 source was formed. First, lithium fluoride (LiF) was prepared as the F source, and magnesium fluoride (MgF₂) was prepared as the Mg source. LiF and MgF₂ were weighed such that LiF:MgF₂ was 1:3 (molar ratio). Then, LiF and MgF₂ were mixed in dehydrated acetone and the mixture was stirred at a rotating speed of 500 rpm for 20 hours. In the mixing, a ball mill was used and a grinding medium was zirconium oxide balls. In a 45-mL-capacity container of the mixing ball mill, the additive element A1 source weighing approximately 9 g in total was put together with 20 mL of dehydrated acetone and 22 g of zirconium oxide balls (1 mmϕ) and mixed. Then, the mixture was made to pass through a sieve with an aperture of 300 μm, whereby the additive element A1 source was obtained.

Next, in accordance with Step S31 shown in FIG. 9, the lithium cobalt oxide (lithium cobalt oxide subjected to the initial heating) obtained by the heating in Step S15 and the additive element A1 source obtained in Step S20a were mixed. Specifically, the materials were weighed so that the number of magnesium atoms was 1 atom % of the number of cobalt atoms in the lithium cobalt oxide, and then the lithium cobalt oxide subjected to the initial heating and the additive element A1 source were mixed by a dry method. At this time, stirring was performed at a rotating speed of 150 rpm for 1 hour. After that, the mixture was made to pass through a sieve with an aperture of 300 μm, whereby the mixture 903 was obtained (Step S32).

Next, in Step S33, the mixture 903 was heated. The heating conditions were 900° C. and 5 hours. During the heating, the mixture 903 was in a saggar covered with a lid. The saggar was filled with an atmosphere containing oxygen and entry and exit of the oxygen were blocked (purged). By the heating, a composite oxide containing Mg and F (lithium cobalt oxide containing Mg and F) was obtained (Step S34a).

Next, in accordance with Step S40 shown in FIG. 10C, the additive element A2 source was formed. First, nickel hydroxide (Ni(OH)₂) was prepared as the Ni source, and aluminum hydroxide (Al(OH)₃) was prepared as the Al source. Next, the nickel hydroxide and the aluminum hydroxide were separately stirred in dehydrated acetone at a rotating speed of 500 rpm for 20 hours. In the mixing, a ball mill was used and a grinding medium was zirconium oxide balls. In different 45-mL-capacity containers of the mixing balls, the nickel hydroxide and the aluminum hydroxide each weighing approximately 10 g were put together with 20 mL of dehydrated acetone and 22 g of zirconium oxide balls (1 mmd) and stirred in the containers. Then, each of the nickel hydroxide and the aluminum hydroxide was made to pass through a sieve with an aperture of 300 μm, whereby the additive element A2 source was obtained.

Next, in Step S51, the composite oxide containing Mg and F and the additive element A2 source were mixed by a dry method. Specifically, the mixing was performed by 1-hour stirring at a rotating speed of 150 rpm. The mixture ratio was set so that each of the nickel hydroxide and the aluminum hydroxide contained in the additive element A2 source was 0.5 atom % with respect to the number of cobalt atoms contained in the lithium cobalt oxide. In the mixing, a ball mill was used and a grinding medium was zirconium oxide balls. In a 45-mL-capacity container of the mixing ball mill, the Ni source, the Al source, and the composite oxide (lithium cobalt oxide containing Mg and F) obtained in Step S34 weighing approximately 7.5 g in total were put together with 22 g of zirconium oxide balls (1 mm$) and mixed. Finally, the mixture was made to pass through a sieve with an aperture of 300 μm, whereby the mixture 904 was obtained (Step S52).

Next, in Step S53, the mixture 904 was heated. The heating conditions were 850° C. and 2 hours. During the heating, the mixture 904 was in a saggar covered with a lid and heated in a muffle furnace. After the muffle furnace was filled with an oxygen atmosphere, no flowing was performed (O₂ purging). By the heating, lithium cobalt oxide containing Mg, F, Ni, and Al (composite oxide) was obtained (Step S54). In this manner, the lithium cobalt oxide 1 (referred to as LCO1) was obtained.

### <Formation Method of LCO2>

Lithium cobalt oxide 2 (referred to as LCO2) was formed under conditions different from those of LCO1. In the formation method of LCO2, the heating conditions at the time of heating the mixture 903 in Step S33 were 900° C. and 20 hours, and the heating conditions at the time of heating the mixture 904 in Step S53 were 850° C. and 10 hours. LCO2 was formed in the same manner as LCO1 except for the above heating temperatures. In this manner, LCO2 was obtained.

### <XRD Analysis in High-Voltage Charged State>

An experiment was performed to examine the crystal structure of LCO1 in a high-voltage charged state.

First, a half cell including LCO1 was assembled. LCO1, acetylene black (AB), and poly(vinylidene fluoride) (PVDF) were prepared as a positive electrode active material, a conductive material, and a binder, respectively. The PVDF prepared in advance was one dissolved in N-methyl-2-pyrrolidone (NMP) at a weight ratio of 5%. A slurry was formed by performing mixing at the positive electrode active material: AB:PVDF=95:3:2 (weight ratio), and the slurry was applied to a positive electrode current collector of aluminum. As a solvent of the slurry, NMP was used.

Next, after the application of the slurry on the positive electrode current collector, the solvent was volatilized, whereby a positive electrode active material layer was formed over the positive electrode current collector.

After that, pressing treatment was performed with a roller press machine to increase the density of the positive electrode active material layer over the positive electrode current collector. The pressing treatment was performed with a linear pressure of 210 kN/m. Note that the temperature of each of an upper roll and a lower roll of the roller press machine was 120° C.

As an electrolyte solution used for the half cell, a solution which is obtained by adding vinylene carbonate (VC) at 2 wt % as an additive agent to a mixture of ethylene carbonate (EC) and diethyl carbonate (DEC) at EC:DEC=3:7 (volume ratio) was used. As an electrolyte (lithium salt) contained in the electrolyte solution, 1 mol/L lithium hexafluorophosphate (LiPF₆) was used.

As a separator, a polypropylene porous film was used. For a negative electrode (counter electrode), a lithium metal was used.

### <Charge and Discharge Test on Half Cell>

Charging and discharging were performed on the half cells. As charging, constant current charging was performed at 0.2 C up to 4.50 V, and then constant voltage charging was performed until the current value reached 0.05 C. As discharging, constant current discharging was performed at 0.2 C up to 3.0 V. Note that as in Example 1, 1 C was set to 200 mA/g (per weight of the positive electrode active material).

Next, charging for obtaining a high-voltage charged state was performed. As charging, constant current charging was performed at 0.2 C up to 4.60 V, and then constant voltage charging was performed until the current value reached 0.02 C.

The half cell was disassembled within one hour after termination of the above charging. In order that the positive electrode including LCO1 might be taken out while being kept in a high-voltage charged state, the disassembly was performed carefully using an insulating tool so as not to cause a short circuit. Note that for the disassembly, an argon-filled glove box in which the dew point and the oxygen concentration were controlled was used. Note that the dew point of the glove box is preferably lower than or equal to −70° C., and the oxygen concentration is preferably lower than or equal to 5 ppm. Since the crystal structure of the positive electrode active material might change due to self-discharging after a long time has passed from the above charging, disassembly and analysis are preferably performed as early as possible. The half cell is disassembled preferably within 15 minutes, further preferably within 5 minutes after being brought into a high-voltage charged state.

The above-described LCO1 obtained by disassembling the half cell was set on an XRD measurement stage that can be hermetically sealed in the glove box, whereby LCO1 on the XRD measurement stage hermetically sealed together with argon was obtained.

After that, XRD measurement was started within 15 minutes. The XRD apparatus and conditions are as follows.
XRD apparatus: D8 ADVANCE produced by Bruker AXS
X-ray source: CuKα₁ radiation
Output: 40 kV, 40 mA
Angle of divergence: Div. Slit, 0.5° Detector: LynxEye
Scanning method: 2θ/θ continuous scanning
Measurement range (2θ): from 15° to 75°
Step width (2θ): 0.01° counting time: 1 second/step
Rotation of sample stage: 15 rpm

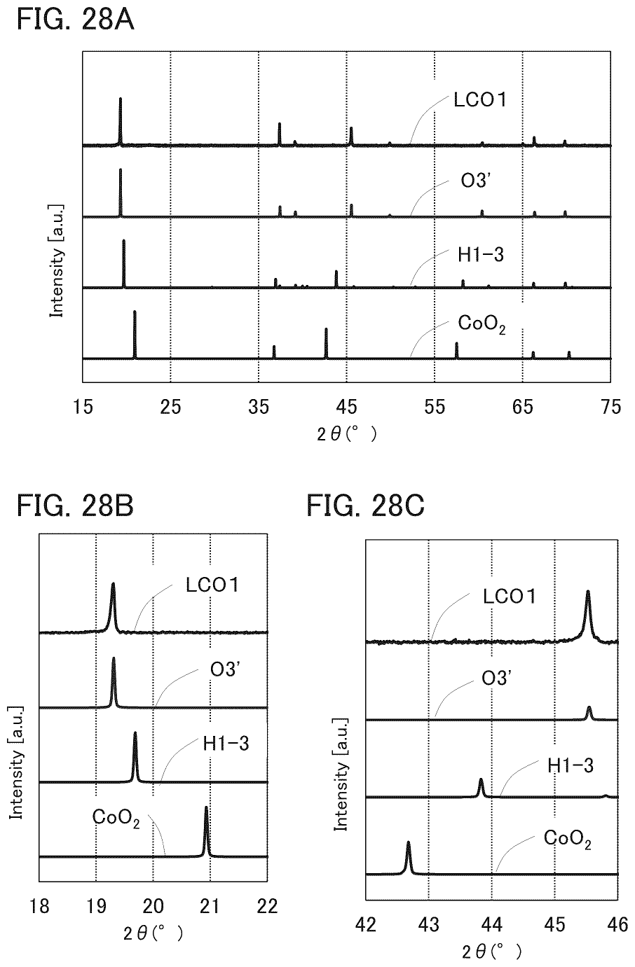

FIG. 28A to FIG. 28C show the XRD measurement data of LCO1 in a high-voltage charged state obtained in the above manner. FIG. 28A to FIG. 28C also show a reference profile (O3′) of the O3′ structure, a reference profile (H1-3) of the H1-3 structure, and a reference profile (CoO₂) of CoO₂.

FIG. 28A shows the range where 2θ is greater than or equal to 15° and less than or equal to 75° C. in the XRD measurement. FIG. 28B and FIG. 28C each show an enlarged part of FIG. 28A with a partly different magnification rate of the vertical axis of the measurement data of LCO1.

The XRD analysis results in FIG. 28A to FIG. 28C show that Sample 1 in a 4.6-V high-voltage charged state has a diffraction peak at 2θ=19.30° within the range of 2θ=19.25±0.12° (greater than or equal to 19.13° and less than or equal to) 19.37° and a diffraction peak at 2θ=45.52° within the range of 2θ=45.47±0.10° (greater than or equal to 45.37° and less than or equal to) 45.57°. That is, it is confirmed that the O3′ structure is included.

### <XPS Analysis>

Next, XPS analysis was performed on LCO1 and LCO2.

The XPS measurement conditions are shown below.
Measurement apparatus: Quantera II produced by PHI, Inc.
X-ray source: monochromatic Al Kα (1486.6 eV)
Detection area: 100 μmoϕ
Detection depth: approximately 4 to 5 nm (extraction angle) 45°
Measurement spectrum: wide scanning, narrow scanning of each detected element

The above XPS measurement results were analyzed, whereby the XPS analysis results shown in Table 8 were obtained. Table 8 shows the number of atoms (%) of each element in each sample when the total number of atoms of Li, Co, Ni, Al, O, Mg, F, C, Ca, Na, S, Cl, and Ti is 100%. Note that the total amount shown in Table 8 is sometimes 100.1% or 99.9% because the values after the analysis are rounded off to be shown in the table; however, the total number of atoms is 100.0% in the XPS analysis.

TABLE 8

| | Li | Co | Ni | Al | O | Mg | F |
|---|---|---|---|---|---|---|---|
| LCO1 | 9.3 | 13.1 | 1.3 | 0.5 | 44.2 | 14.3 | 10.4 |
| LCO2 | 11.1 | 18.7 | 0.9 | 0 | 54 | 7.4 | 0.4 |
| | C | Ca | Na | S | Cl | Ti | Total |
| LCO1 | 3.2 | 0.5 | 1.9 | 1 | 0.4 | 0 | 100.0 |
| LCO2 | 5.3 | 1.3 | 0.6 | 0 | 0 | 0.2 | 100.1 |

In LCO1 and LCO2, large amounts of Mg and Ni are detected and small amounts of Li and Co are detected. This result probably suggests that the surface portion 100a described in Embodiment 2 is formed in LCO1 and LCO2.

When LCO1 and LCO2 are compared, larger amounts of Ni, Mg, and F are detected and smaller amounts of Li and Co are detected in LCO1.

The difference between the formation conditions of LCO1 and LCO2 is that the heating time after mixing the A1 source and the heating time after mixing the A2 source are each longer than that of LCO2. Here, regarding F in Table 8, the number of F atoms is much larger in LCO1 than in LCO2. In other words, the number of F atoms detected at the surface of LCO2 is much smaller than the number of F atoms detected at the surface of LCO1. This is probably because Ni and Mg diffused from the surface portion to the inner portion of the positive electrode active material.

When the number of Ni atoms with respect to the number of Co atoms (Ni/Co), the number of Mg atoms with respect to the number of Co atoms (Mg/Co), and the number of F atoms with respect to the number of Co atoms (F/Co) were calculated on the basis of the XPS analysis results shown in Table 8, the results shown in Table 9 were obtained.

TABLE 9

| | Ni/Co | Mg/Co | F/Co |
|---|---|---|---|
| LCO1 | 0.099 | 1.092 | 0.794 |
| LCO2 | 0.048 | 0.396 | 0.021 |

In LCO1, the number of Ni atoms with respect to the number of Co atoms (Ni/Co) was 0.099, the number of Mg atoms with respect to the number of Co atoms (Mg/Co) was 1.092, and the number of F atoms with respect to the number of Co atoms (F/Co) was 0.794. In LCO2, the number of Ni atoms with respect to the number of Co atoms (Ni/Co) was 0.048, the number of Mg atoms with respect to the number of Co atoms (Mg/Co) was 0.396, and the number of F atoms with respect to the number of Co atoms (F/Co) was 0.021.

That is, in the XPS analysis of LCO1, the number of Ni atoms with respect to the number of Co atoms (Ni/Co) was greater than or equal to 0.090, the number of Mg atoms with respect to the number of Co atoms (Mg/Co) was greater than or equal to 1.000, and the number of F atoms with respect to the number of Co atoms (F/Co) was greater than or equal to 0.700. Note that in the case where the amount of each of Ni, Mg, and F is excessive, for example, more than approximately twice the above-described amount detected in LCO1, the rechargeable and dischargeable capacity of the positive electrode active material is probably reduced.

From the above results, in the XPS analysis of lithium cobalt oxide with a median diameter (D50) of less than or equal to 12 μm (preferably less than or equal to 10.5 μm, further preferably less than or equal to 8 μm), it can be said that the number of Ni atoms with respect to the number of Co atoms (Ni/Co) is preferably greater than or equal to 0.05, further preferably greater than or equal to 0.06, still further preferably greater than or equal to 0.07, yet still further preferably greater than or equal to 0.08, yet still further preferably greater than or equal to 0.09. It can also be said that Ni/Co is preferably less than or equal to 0.200, further preferably less than or equal to 0.150, still further preferably less than or equal to 0.140, yet still further preferably less than or equal to 0.130, yet still further preferably less than or equal to 0.120, yet still further preferably less than or equal to 0.110.

In the XPS analysis of lithium cobalt oxide with a median diameter (D50) of less than or equal to 12 μm (preferably less than or equal to 10.5 μm, further preferably less than or equal to 8 μm), it can be said that the number of Mg atoms with respect to the number of Co atoms (Mg/Co) is preferably greater than or equal to 0.400, further preferably greater than or equal to 0.500, still further preferably greater than or equal to 0.600, yet still further preferably greater than or equal to 0.700, yet still further preferably greater than or equal to 0.800, yet still further preferably greater than or equal to 0.900, yet still further preferably greater than or equal to 1.000. It can also be said that Mg/Co is preferably less than or equal to 2.000, further preferably less than or equal to 1.500, still further preferably less than or equal to 1.400, yet still further preferably less than or equal to 1.300, yet still further preferably less than or equal to 1.200.

In the XPS analysis of lithium cobalt oxide with a median diameter (D50) of less than or equal to 12 μm (preferably less than or equal to 10.5 μm, further preferably less than or equal to 8 um), it can be said that the number of F atoms with respect to the number of Co atoms (F/Co) is preferably greater than or equal to 0.100, further preferably greater than or equal to 0.200, still further preferably greater than or equal to 0.300, still further preferably greater than or equal to 0.400, yet still further preferably greater than or equal to 0.500, yet still further preferably greater than or equal to 0.600, yet still further preferably greater than or equal to 0.700. It can also be said that F/Co is preferably less than or equal to 1.500, further preferably less than or equal to 1.200, still further preferably less than or equal to 1.100, yet still further preferably less than or equal to 1.000, yet still further preferably less than or equal to 0.900.

It is probable that owing to the above-described characteristics, LCO1 enables high-voltage charging and excellent charge and discharge characteristics in an environment at −40° C.

### <STEM-EDX Analysis>

Next, STEM-EDX line analysis was performed on LCO1.

As pretreatment before analysis, LCO1 was sliced by an FIB method (μ-sampling method).

STEM and EDX were performed with the following apparatuses under the following conditions.

<<STEM observation>>
Scanning transmission electron microscope: HD-2700 produced by Hitachi
High-Tech Corporation
Observation condition, acceleration voltage: 200 kV
Magnification accuracy: ±3%
<<EDX>>
Analysis method: energy dispersive X-ray spectroscopy (EDX)
Scanning transmission electron microscope: HD-2700 produced by Hitachi
High-Tech Corporation
Acceleration voltage: 200 kV
Beam diameter: approximately 0.2 nmϕ
Element analysis apparatus: equipped with two (dual) Octane T Ultra W
detectors
X-ray detector: Si drift detector
Energy resolution: approximately 130 eV
X-ray extraction angle: 25°
Solid angle: 2 sr
Number of captured pixels: 512 × 400

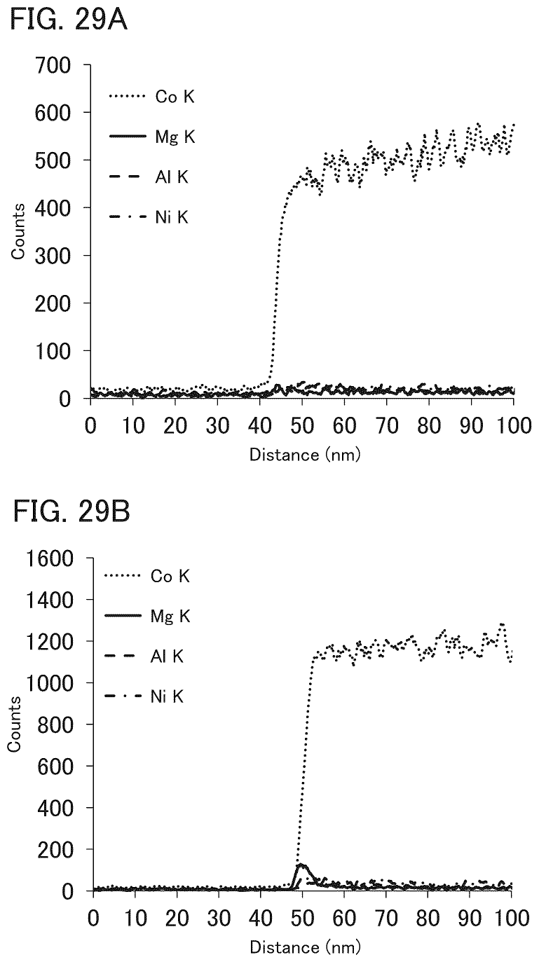

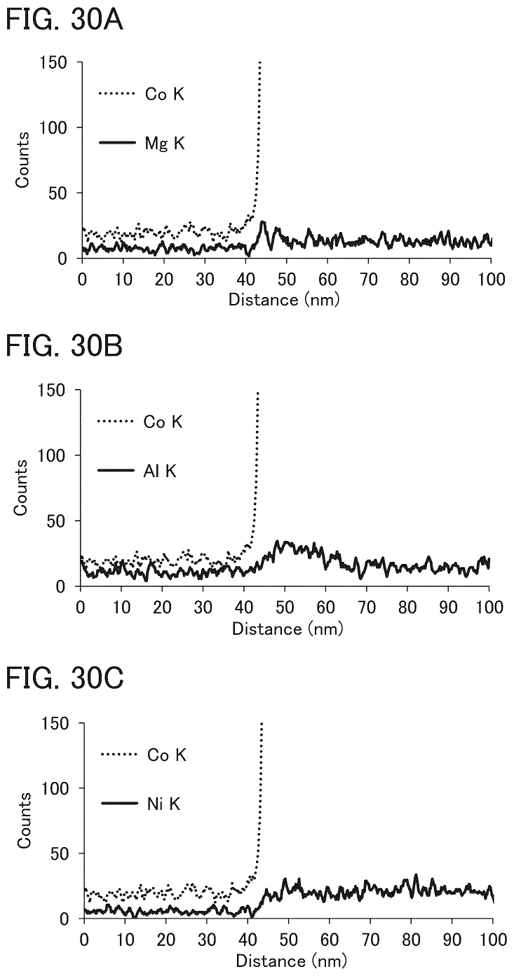

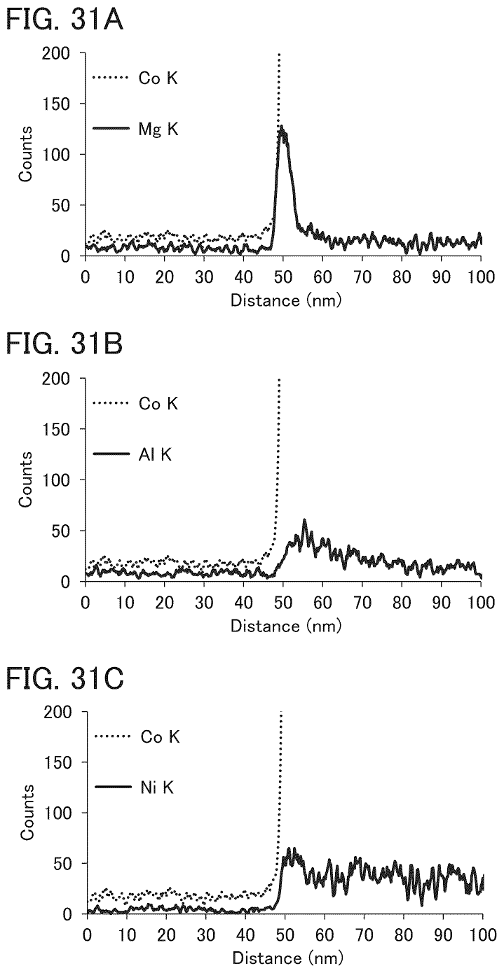

FIG. 29A, FIG. 30A, FIG. 30B, and FIG. 30C each show profiles (counts) of STEM-EDX line analysis in the basal region of LCO1. FIG. 29B, FIG. 31A, FIG. 31B, and FIG. 31C each show profiles (counts) of STEM-EDX line analysis in the edge region of LCO2. Note that data of each measurement point in the profiles shown in FIG. 29A to FIG. 31C was subjected to smoothing processing so as to be the average value of five points including four adjacent points. Note that the distance between measurement points is approximately 0.2 nm; thus, the above five-point average can be regarded as an average value in a region of approximately 0.8 nm.

FIG. 30A, FIG. 30B, and FIG. 30C are each an enlarged graph where the vertical axis of FIG. 29A is enlarged; FIG. 30A shows profiles (counts) of cobalt and magnesium, FIG. 30B shows profiles (counts) of cobalt and aluminum, and FIG. 30C shows profiles (counts) of cobalt and nickel. Note that no peak derived from the characteristic X-rays of nickel was observed in the energy spectrum of the basal region of LCO1. That is, nickel is substantially absent in the basal region of Sample 1. Thus, the profile of nickel shown in FIG. 30C is probably derived not from the characteristic X-rays of nickel but from the characteristic X-rays of cobalt which is close to that of nickel in the energy spectrum.

From the profile in FIG. 29A, the reference point was estimated to be a point at a distance of 44.3 nm on the x-axis. Specifically, a region avoiding the vicinity of a portion where the amount of detected cobalt begins to increase is determined to be at a distance of 10 to 20 nm in FIG. 29A. A region where the count of cobalt is stable is determined to be at a distance of 94 to 98 nm. A point of 50% of the sum of M_{AVE} and M_{BG} was calculated to be 276.8 counts from the profile of cobalt, and the surface was estimated at 44.3 nm from a calculated regression line.

Assuming that the inward direction in the particle with respect to the reference estimated as described above is the positive direction in FIG. 30A, FIG. 30B, and FIG. 30C, the peak positions of the additive elements were-0.3 nm for Mg and 3.9 nm for Al. The ratios of the detection intensities of the additive elements at the peak positions to the average detection intensity of cobalt in the region where the count of cobalt was stable were Mg/Co=0.05 and Al/Co=0.06 in the basal region. The half width of the distribution of magnesium was 2.6 nm.

FIG. 31A, FIG. 31B, and FIG. 31C are each an enlarged graph where the vertical axis of FIG. 29B is enlarged; FIG. 31A shows profiles (counts) of cobalt and magnesium, FIG. 31B shows profiles (counts) of cobalt and aluminum, and FIG. 31C shows profiles (counts) of cobalt and nickel. Note that a peak derived from the characteristic X-rays of nickel was clearly observed in the energy spectrum of the edge region of LCO1.

From the profile in FIG. 29B, the reference surface was estimated to be a point at a distance of 50.5 nm. Specifically, a region avoiding the vicinity of a portion where the amount of detected cobalt begins to increase is determined to be at a distance of 10 to 20 nm in FIG. 29B. A region where the count of cobalt is stable is determined to be at a distance of 97 to 100 nm. A point of 50% of the sum of M_{AVE} and M_{BG} was calculated to be 610.2 counts from the profile of cobalt, and the surface was estimated at 50.5 nm from a calculated regression line.

Assuming that the inward direction in the particle with respect to the reference position estimated as described above is the positive direction in FIG. 31A, FIG. 31B, and FIG. 31C, the peak positions of the additive elements were-0.9 nm for Mg, 4.9 nm for Al, and 1.9 nm for Ni. The ratios of the detection intensities of the additive elements at the peak positions to the average detection intensity of cobalt in the region where the count of cobalt was stable were Mg/Co=0.11, ALCO=0.05, and Ni/Co=0.05 in the edge region. The half width of the distribution of magnesium was 4.5 nm, and the half width of the distribution of nickel was 8.1 nm.

As described above, it is confirmed that the lithium cobalt oxide 1 includes a region where magnesium is distributed closer to the surface of the positive electrode active material than aluminum is, in both the basal region and the edge region. It is also confirmed that the edge region includes a region where magnesium and nickel are distributed closer to the surface of the positive electrode active material than aluminum is. Note that in the edge region, it is confirmed that the peak position of magnesium and the peak position of nickel are close to each other, and the distribution of magnesium includes a region overlapping with the distribution of nickel.

### REFERENCE NUMERALS

100a: surface portion, 100b: inner portion, 100: positive electrode active material, 200: graphite particle, 201: silicon particle, 202a: binder, 202: binder, 203a: AB

1. A lithium-ion secondary battery comprising:
a positive electrode;
a negative electrode; and
an electrolyte solution,
wherein the positive electrode comprises lithium cobalt oxide with a median diameter (D50) of greater than or equal to 1 μm and less than or equal to 12 μm,
wherein the lithium cobalt oxide comprises magnesium in its surface portion,
wherein the negative electrode comprises graphite particles, silicon particles, and a polymer comprising a carboxy group, and
wherein the electrolyte solution comprises a mixed solvent of a fluorinated cyclic carbonate and a fluorinated chain carbonate.

2. The lithium-ion secondary battery according to claim 1,
wherein an average particle diameter of the silicon particles is less than 1 μm.

3. The lithium-ion secondary battery according to claim 1,
wherein an average particle diameter of the graphite particles is greater than or equal to 5 μm.

4. The lithium-ion secondary battery according to claim 1,
wherein an average particle diameter of the silicon particles is less than an average particle diameter of the graphite particles.

5. The lithium-ion secondary battery according to claim 1,
wherein a weight ratio of the silicon particles is lower than a weight ratio of the graphite particles.

6. The lithium-ion secondary battery according to claim 1,
wherein the polymer comprising a carboxy group is polyglutamic acid.

7. The lithium-ion secondary battery according to claim 1,
wherein the lithium cobalt oxide has a layered rock-salt crystal structure belonging to a space group R-3m,
wherein the surface portion comprises a basal region comprising a surface parallel to a (00l) plane of the layered rock-salt crystal structure and an edge region,
wherein l represents a given integer of 1 or more, and
wherein when STEM-EDX line analysis is performed on the lithium cobalt oxide, magnesium in the edge region is detected at a higher concentration than magnesium in the basal region.

8. A lithium-ion secondary battery comprising:
a positive electrode;
a negative electrode; and
an electrolyte solution,
wherein the positive electrode comprises lithium cobalt oxide with a median diameter (D50) of greater than or equal to 1 μm and less than or equal to 12 μm,
wherein the lithium cobalt oxide comprises magnesium and nickel in its surface portion,
wherein the negative electrode comprises graphite particles, silicon particles, and a polymer comprising a carboxy group,
wherein an average particle diameter of the silicon particles is less than an average particle diameter of the graphite particles, and
wherein the electrolyte solution comprises a mixed solvent of a fluorinated cyclic carbonate and a fluorinated chain carbonate.

9. A lithium-ion secondary battery comprising:
a positive electrode;
a negative electrode; and
an electrolyte solution,
wherein the positive electrode comprises lithium cobalt oxide with a median diameter (D50) of greater than or equal to 1 μm and less than or equal to 12 μm,
wherein the lithium cobalt oxide comprises magnesium and nickel in its surface portion,
wherein the negative electrode comprises graphite particles, silicon particles, and a polymer comprising a carboxy group,
wherein an average particle diameter of the silicon particles is greater than an average particle diameter of the graphite particles,
wherein the electrolyte solution comprises fluoroethylene carbonate and methyl 3,3,3-trifluoropropionate, and with a total content of the fluoroethylene carbonate and the methyl 3,3,3-trifluoropropionate of 100 vol %, a volume ratio of the fluoroethylene carbonate to the methyl 3,3,3-trifluoropropionate is x:100−x, and
wherein x is greater than or equal to 5 and less than or equal to 30.

10. The lithium-ion secondary battery according to claim 8,
wherein the lithium cobalt oxide has a layered rock-salt crystal structure belonging to a space group R-3m,
wherein the surface portion comprises a basal region comprising a surface parallel to a (00l) plane of the crystal structure and an edge region,
wherein l represents a given integer of 1 or more, and
wherein when STEM-EDX line analysis is performed, the lithium cobalt oxide comprises a region where distribution of the magnesium and distribution of the nickel overlap with each other in the edge region.

11. The lithium-ion secondary battery according to claim 8,
wherein the lithium cobalt oxide has a layered rock-salt crystal structure belonging to a space group R-3m,
wherein the surface portion comprises a basal region comprising a surface parallel to a (00l) plane of the crystal structure and an edge region, wherein l represents a given integer of 1 or more, and
wherein when STEM-EDX line analysis is performed on the lithium cobalt oxide, the nickel is substantially absent in the basal region.

12. The lithium-ion secondary battery according to claim 9,
wherein the lithium cobalt oxide has a layered rock-salt crystal structure belonging to a space group R-3m,
wherein the surface portion comprises a basal region comprising a surface parallel to a (00l) plane of the crystal structure and an edge region,
wherein l represents a given integer of 1 or more, and
wherein when STEM-EDX line analysis is performed, the lithium cobalt oxide comprises a region where distribution of the magnesium and distribution of the nickel overlap with each other in the edge region.

13. The lithium-ion secondary battery according to claim 9,
wherein the lithium cobalt oxide has a layered rock-salt crystal structure belonging to a space group R-3m,
wherein the surface portion comprises a basal region comprising a surface parallel to a (00l) plane of the crystal structure and an edge region,
wherein l represents a given integer of 1 or more, and
wherein when STEM-EDX line analysis is performed on the lithium cobalt oxide, the nickel is substantially absent in the basal region.
